(19) United States
(12) Patent Application Publication
(10) Pub. No.: US 2006/0286395 A1
(43) Pub. Date: Dec. 21, 2006

(54) Optical film and support thereof

(75) Inventors: Narito Goto, Kanagawa (JP); Hironobu Nakao, Saitama (JP); Takayuki Sasaki, Tokyo (JP); Kiyokazu Morita, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/448,510

(22) Filed: Jun. 7, 2006

(30) Foreign Application Priority Data
Jun. 15, 2005 (JP) 2005-174770
Jul. 14, 2005 (JP) 2005-205665
Oct. 14, 2005 (JP) 2005-299961
Oct. 14, 2005 (JP) 2005-299962

(51) Int. Cl. B32B 27/08; B32B 27/36; B32B 27/32

(52) U.S. Cl. 428/480; 428/500; 428/521

(57) ABSTRACT

An object of the present invention is to provide an optical film, a light diffusion film and supports thereof exhibiting reduced film deformation in the case of the storage at high-temperature and humidity as well as excellent heat resistance, accompanied with no generation of scratches on the film surface, film peeling and curl.

This application claims priority from Japanese Patent Application No. 2005-174770 filed on Jun. 15, 2005, Japanese Patent Application No. 2005-205665 filed on Jul. 14, 2005, Japanese Patent Application No. 2005-299961 filed on Oct. 14, 2005, and Japanese Patent Application No. 2005-299962 filed on Oct. 14, 2005, which are incorporated hereinto by reference.

### TECHNICAL FIELD

The present invention relates to an optical film, a light diffusion and supports thereof, and specifically to the optical film, the light diffusion and supports thereof useful for various display members installed in liquid crystal display (LCD), organic EL display (OLED) and plasma display (PDP).

In recent years, various types of displays have come into use for a wide variety of applications such as portable equipment, personal computers (PCs), monitor and television sets. Among them, liquid crystal displays have been employed over an extensive range from the small-type products for portable equipment to the large-sized products including a monitor and television set. The liquid crystal display itself is not a luminous body, and provides character display through incoming of light given off from the backlight attached to it.

In the meantime, the backlight is required not only to apply light, but also to apply uniform and bright light on the screen as a whole. To ensure uniform application of the backlight, a sheet having optical functions such as a diffusion film and prism sheet is normally attached. To be more specific, in the backlight, a diffusion film is used to ensure uniform distribution of light on a light guide plate. To improve the brightness on the front, a prism sheet is overlapped therewith to collect light on the front. This method has been practiced (see Patent Document 1, for example).

Further, displays such as plasma display panel (PDP), liquid crystal display (LCD), electroluminescent display (ELD), cathode ray tube (CRT) and field emission display (FED), the surface of such as a display as a cellular mobile telephone and the touch panel of the home electronic appliances or the like are often used in lamination of a hard coat film in order to provide scratch resistance. To prevent scattering of glasses, the conventional glass products are also laminated with a plastic film in ever increasing numbers. However, a hard coat layer is formed on the surface to compensate for lack of hardness on the film surface. This method has been practiced extensively. The conventional hard coat film is generally manufactured as follows: An actinic energy ray polymerizable resin such as a thermosetting resin or UV curable resin are laminated directly on a plastic transparent support or through a primer layer having a thickness of about 1 μm to form a coating film having a thickness of-about 3 - 15 μm, whereby the actinic energy ray polymerizable resin is produced. However, the aforementioned conventional hard coat film has a hard coat layer of insufficient hardness and the coat film is thin; and therefore, deformation of the underlying plastic transparent support when an extremely large external force is applied. The hard coat layer is also deformed, accordingly. Satisfactory products have not been obtained in the conventional art (for example, Patent Document 2).

The front filter for plasma display is required to provide a great variety of functions including the near-infrared ray cut-off performance, heat radiation shielding performance, electromagnetic shielding performance, damage prevention performance and reflection prevention performance. Especially in the case of a plasma display panel, much electromagnetic wave and heat radiation are emitted from the screen, and the temperature on the panel surface reaches as high as 80-100° C. This may cause burns. To avoid this, the front filter of the plasma display panel has been required to cut off the electromagnetic wave and heat radiation. In addition to heat radiation, a near-infrared ray (having a wavelength of 800-1100 nm) is also emitted, and this may cause operation errors in the remote control of the home electronic appliances. There has been an intense demand for taking action to solve such a problem. To provide the aforementioned functions in addition to the performance of cutting off the infrared ray, an anti-reflection film, infrared ray absorbing film or electromagnetic shielding film is employed (for example, Patent Documents 3, 4 and 5).

[Patent Document 1] Japanese Patent O.P.I. Publication No. 2004-347780 (within what is claimed)

[Patent Document 2) Japanese Patent O.P.I. Publication No. 2005-4163 (background of the invention)

[Patent Document 3) Japanese Patent O.P.I. Publication No. 2001-194522 (within what is claimed)

[Patent Document 4] Japanese Patent O.P.I. Publication No. 2004-221564 (within what is claimed)

[Patent Document 5] Japanese Patent O.P.I. Publication No. 2005-114751 (within what is claimed)

### SUMMARY

There was a problem such that the film surface was scratched, and film peeling and curl were generated during production of the optical film or the light diffusion film, whereby haze in the film was increased, and the film quality was deteriorated. There was also another problem such that the film deformation was caused in the case of the storage at high humidity, together with a heat resistance problem. The present invention was to be performed to solve those problems.

It is an object of the present invention to provide an optical film, a light diffusion film and supports thereof exhibiting less film deformation in the case of the storage at high-temperature and humidity as well as excellent heat resistance, accompanied with no generation of scratches on the film surface, film peeling and curl.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is a schematic cross-sectional view showing the light diffusion sheet as an embodiment of the present invention,

FIG. 2 is a schematic cross-sectional view showing the light diffusion sheet different from that of FIG. 1,

FIG. 3(a) is an enlarged cross-sectional view of the first example of a light diffusion sheet material of the present invention, FIG. 3(b) is a partially enlarged cross-sectional view of FIG. 3(a),

FIG. 4 is a schematic illustration showing the diffusion of light entering a light diffusion sheet,

FIG. 5(a) is a schematic illustration showing a distribution pattern in which bead particles are dispersed on the surface of a substrate sheet, FIG. 5(a) is a schematic illustration showing another distribution pattern in which bead particles are dispersed so as to cover almost the entire surface of a substrate sheet, and

FIG. 6 is a cross-sectional view showing an example of the anti-reflection film of the present invention.

### DESCRIPTION OF THE PREFERRED EMBODIMENTS

The above object of the present invention is accomplished by the following structures.

(Structure 1) A support employed for an optical film or a light diffusion film possessing at least one subbing layer containing a polyester component or a vinyl based polymer latex, or a polyester component or a styrene-diolefin based copolymer.

(Structure 2) A support employed for an optical film or a light diffusion film possessing at least one subbing layer containing polyester modified with a vinyl based monomer.

(Structure 3) The support employed for an optical film or a light diffusion film of Structure 2, wherein the polyester is modified with at least 10% by weight of the vinyl based monomer, based on polyester.

(Structure 4) A support employed for an optical film or a light diffusion film possessing at least one subbing layer containing a polyester component or a water-soluble polymer containing a polyvinyl alcohol unit.

(Structure 5) The optical film possessing at least one subbing layer containing the polyester component or the vinyl based polymer latex, or the polyester component or the styrene-diolefin based copolymer, provided on the support, wherein the support of any one of Structures 1-4 is used for the-optical film.

(Structure 6) The light diffusion film possessing at least one subbing layer containing the polyester component or the vinyl based polymer latex, or the polyester component or the styrene-diolefin based copolymer, provided on the support, wherein the support of any one of Structures 1-4 is used for the light diffusion film.

(Structure 7) The optical film of Structure 5, wherein the optical film is a hard coat film.

(Structure 8) The optical film of Structure 5, wherein the optical film is an anti-reflection film.

(Structure 9) The optical film of Structure 5, wherein the optical film is an infrared ray absorbing film.

(Structure 10) The optical film of Structure 5, wherein the optical film is an electromagnetic shielding film.

(Structure 11) The light diffusion film of Structure 6, wherein a light diffusion agent used for a light diffusion layer is an acryl resin.

(Structure 12) The light diffusion film of Structure 11, wherein binder used for the light diffusion layer is polyol or polyester polyol.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

The preferred embodiments of the present invention will be explained below, but the present invention is not limited thereto.

(Support)

Provided as components of supports (hereinafter referred to also as supports of the present invention) which are usable in an optical film or a light diffusion film of the present invention are various types of high molecular materials, glass, wool, cotton fabric, paper, and metal such as aluminum and the like. Preferred as supports may be those which are flexible and wound up in the form of a roll.

The support of the present invention is preferably composed of a plastic film such as a cellulose acetate film, a polyester film, a polyethylene terephthalate film, a polyethylene naphthalate film, a polyamide film, polyimide film, a cellulose triacetate film or a polycarbonate film. Of these, a polyester support is preferable.

The polyester of polyester supports employed refers to one obtained by condensation polymerization of diols with dicarboxylic acids. Representative dicarboxylic acids, for example, include terephthalic acid, isophthalic acid, phthalic acid, naphthalenedicarboxylic acid, adipic acid, sebacic acid, and the like. Further, representative diols, for example, include ethylene glycol, trimethylene glycol, tetramethylene glycol, cyclohexanedimethanol, and the like. Specific examples of said diols include polyethylene terephthalate, polyethylene-p-oxybenzoate, poly-1,4-cyclohexylenediethylene terephthalate, polyethylene-2,6-naphthalene dicarboxylate, and the like. In the case of the present invention, polyethylene terephthalate and polyethylene naphthalate are particularly preferred.

The polyethylene terephthalate film exhibits excellent properties such as water resistance, durability, and chemical resistance, and the like. The polyester may be either a homopolyester or a copolyester. Listed as copolymerization components may be diol components such as diethylene glycol, neopentyl glycol, polyalkylene glycol, and the like, as well as dicarboxylic acid components such as adipic acid, sebacic acid, phthalic acid, 2,6-naphthalenedicarboxylic acid, 5-sodiumsulfoisophthalic acid and the like.

In these polyester supports, particles of calcium carbonate, non-crystalline zeolite, anatase type titanium dioxide, calcium phosphate, silica, kaolin, talc, and clay may be employed in combination. The added amount of these particles is preferably 0.0005 to 25 parts by weight with respect to 100 parts by weight of the polyester composition.

Further, other than such particles, it is possible to use, in combination, particles which are deposited through the reaction of catalyst residues with phosphorous compounds in a polyester polymerization condensation reaction system. Listed as minute deposit particles may be, for example, particles comprised of calcium, lithium, and phosphorous compounds or particles comprised of magnesium and phosphorous compounds.

The content of such particles in polyester is preferably 0.05 to 1.00 part by weight, based on 100 parts by weight of the polyester. Commonly known additives such as antioxidants, dyes and the like may be added into the polyester support.

From the viewpoint of mechanical strength as well as runnability, the thickness of polyester supports is preferably 10-250 μm, and is more preferably 15-200 μm.

In order to reduce roll-set curl, as described in Japanese Patent O.P.I. Publication No. 51-16358, after casting, a polyester support may be subjected to a thermal treatment in the temperature range of less than or equal to the glass transition temperature for 0.1 to 1,500 hours.

In order to enhance adhesion properties, if desired, polyester supports may be subjected to surface treatments known in the art such as chemical treatments (described in Japanese Patent Examined Publication Nos. 34-11031, 38-22148, 40-2276, 41-16423, and 44-5116), chemical and mechanical surface roughening treatments (described in Japanese Patent Examined Publication Nos. 47-19068 and 55-5104), corona discharge treatments (described in Japanese Patent Examined Publication No. 39-12838 and Japanese Patent O.P.I. Publication Nos. 47-19824 and 48-28067), flame treatments (Japanese Patent Examined Publication No. 40-121384 and Japanese Patent O.P.I. Publication No. 48-85126), ultraviolet radiation treatments (described in Japanese Patent Examined Publication Nos. 36-18915, 37-14493, 43-2603, 43-2604, and 52-24726), high frequency treatments (described in Japanese Patent Examined Publication No. 49-10687), and glow discharge treatments (described in Japanese Patent Examined Publication No. 37-17682), and in addition, active plasma treatments and laser treatments may be employed. As described in Japanese Patent Examined Publication No. 57-487, it is preferable that the contact angle of the support surface to water is adjusted to at most 58°. Further, polyester may be either transparent or opaque or may be tinted.

(Surface Treatment)

It is preferable that the support according to the present invention is subjected to a corona discharge treatment. The discharge amount is preferably controlled to be 5-30 W/m²·minute. It is preferable that a subbing layer according to the present invention is applied to the corona treated supports within one to two months after the corona treatment.

The support according to the present invention may be subjected to a plasma surface treatment. The plasma treatment is preferred to be at approximately atmospheric pressure is preferred. When plasma discharge is carried out, preferred as gases for the treatment are those which are capable of providing functional groups such as an amino group, a carboxyl group, a hydroxyl group, or a carbonyl group. The gases include, for example, nitrogen (N₂) gas, hydrogen (H₂) gas, oxygen (O₂) gas, carbon dioxide (CO₂) gas, ammonia (NH₃) gas, and water vapor.

Further, other than reaction gases, inert gases such as helium and argon are necessary and by maintaining the mixing ratio of inert gases at more than or equal to 60 percent, stable discharge conditions are achieved. However, when plasma is generated in a pulsed electric field, inert gases are not always necessary, while it is possible to increase the concentration of reaction gases. The frequency of the pulse electric field is preferably in the range of 1 to 100 kHz. Time applied to one pulse electric filed is preferably 1-1,000 μs, and voltage applied to the electrode is preferably in a range which results in an electric field strength of 1- 100 kV/cm.

(Subbing Layer)

Polymers other than polyesters may be used in the subbing layer, or incorporated if desired. Employed as polymers are water-soluble polymers such as gelatin and polyvinyl alcohol, as well as hydrophobic polymers such as polyethyl acrylate, vinylidene chloride, and polyurethane without particular limitations.

In the present invention, the subbing layer generally contains a polyester component and vinyl based polymer latex. The subbing layer needs not always be comprised of a single layer. When comprised of a plurality of layers, in the case of the present invention, it is also preferable that both the polyester component and the vinyl based polymer latex are contained in a plurality of layers, though either the polyester component or the vinyl based polymer latex may be allowed to be contained, and a structure in which both are incorporated in the same layer is particularly preferable.

Further, in the present invention, the subbing layer generally contains a polyester component and a styrene-diolefin based copolymer. The subbing layer needs not always be comprised of a single layer. When comprised of a plurality of layers, in the case of the present invention, it is also preferable that both the polyester component and the styrene-diolefin based copolymer are contained in a plurality of layers, though either the polyester component or the styrene-diolefin based copolymer may be allowed to be contained, and a structure in which both are incorporated in the same layer is particularly preferable.

The thickness of the subbing layer of the present invention is preferably 0.05 - 5 μm per layer, and is more preferably 0.1-3 μm.

(Polyester)

Polyester employed in the present invention is preferably a polyester copolymer which is soluble or dispersible in water. Such polyester is occasionally called water-soluble polyester in the description of the present invention.

Listed as water-soluble polyester copolymers may be hydrophilic polymers described, for example, in U.S. Pat. Nos. 4,252,885, 4,241,169, and 4,394,442; European Patent Nos. 29,620 and 78,559; Japanese Patent O.P.I. Publication No. 54-43017; and Research Disclosure 18928. Listed as water-soluble polyesters are, for example, substantially linear polymers which are prepared by allowing polybasic acids or ester forming derivatives thereof to react with polyols, or ester forming derivatives thereof, employing polymerization condensation reaction schemes.

Employed as polybasic acid components which form a basic skeleton for the aforesaid polyester copolymers may be, for example, terephthalic acid, isophthalic acid, phthalic acid, phthalic anhydride, 2,6-napthalenedicarboxylic acid, 1,4-cyclohexanedicaroboxyic acid, adipic acid, sebacic acid, trimellitic acid, pyromellitic acid and dimeric acid. Along with these components, it is possible to employ a small proportion of unsaturated polybasic acids such as maleic acid, fumaric acid, and itaconic acid as well as hydroxylcarboxylic acids such as p-hydroxybenzoic acid and p-(β-hydroxyethoxy)benzoic acid. Of the aforesaid compounds, preferred as polybasic acid components are those which have terephthalic acid and isophthalic acid as a major dicarboxylic acid component. Further, the mol ratio of terephthalic acid to isophthalic acid is preferably 30/70 to 70/30 from the viewpoint of coatability onto polyester supports, as well as water solubility. Further, it is preferable that such terephthalic acid component and isophthalic acid component are incorporated in an amount of 50 to 80% by mole, based on all the dicarboxylic acid components.

In order to provide polyester water solubility, an effective means is that components having a hydrophilic group such as a component having a sulfonic acid salt, a diethylene glycol component, a polyalkylene ether glycol component, or a polyether dicarboxylic acid component are introduced into the polyester as a copolymerization component. Specifically, in order to introduce a component having a hydrophilic group, it is preferable to use dicarboxylic acid having sulfonic acid salt as a monomer.

Particularly preferred as the aforesaid dicarboxylic acids having sulfonic acid salt are those having a group of a sulfonic acid alkali metal salt, which include, for example, alkali metal salts of 4-sulfophthalic acid, 5-sulfoisophthalic acid, sulfoterephthalic acid, 4-sulfophthalic acid, 4-sulfonaphthalene-2,7-dicarboxylic acid, and 5-(4-silfophenoxy)isophthalic acid. From the viewpoint of water solubility and water resistance, those dicarboxylic acids having a sulfonic acid salt are preferably employed in an amount of 5-20% by mole with respect to the total dicarboxylic acid components and are more preferably in the range of 6-10% by mole.

Further, it is preferable that in water-soluble polyesters in which terephthalic acid as well as isophthalic acid is employed as major dicarboxylic components, aliphatic dicarboxylic acids are employed as a copolymerization component. Listed as such aliphatic dicarboxylic acids may be, for example, 1,4-cyclohexanedicarboxyluc acid, 1,3-cylcohexanedicarboxylic acid, 1,2-cyclohexanedicarboxylyic acid, 1,3-cyclopentanedicarboxyluic acid, and 4,4′-bicylohexyldicaroxylic acid.

Further, it is possible to employ, as a copolymerization component, dicarboxylic acids other than those described above in water-soluble polyester copolymers in which terephthalic acid as well as isophthalic acid is employed as a major dicarboxylic acid component. Listed as such dicarboxylic acids are, for example, aromatic dicarboxylic acids and straight chain-aliphatic dicarboxylic acids. It is preferable that aromatic dicarboxylic acids are employed in the range of at most 30% by mole with respect to the total dicarboxylic acid components. Listed as such aromatic dicarboxylic acid components are, for example, phthalic acid, 2,5-dimethylterephthalic acid, 2,6-naphthalenedicarboxylic acid, 1,4-naphthalenedicarboxylic acid, and biphenyldicarboxylic acid. Further, it is preferable that straight-chain aliphatic dicarboxylic acids are employed in the range of at most 15% by mole with respect to the total dicarboxylic acid components. Listed as such straight-chain aliphatic dicarboxylic acids are, for example, adipic acid, pimelic acid, suberic acid, azelaic acid, and sebacic acid.

Employed as polyol components may be ethylene glycol, diethylene glycol, 1,4-butanediol, neopentyl glycol, dipropylene glycol, 1,6-hexanediol, 1,4-cyclohexanedimethanol, xylene glycol, trimethylolpropane, poly(ethylene oxide)glycol, and poly(tetramethylene oxide)glycol.

Further, preferred as glycol components of water-soluble polyester copolymers may be ethylene glycol, 1,4-butnanediol, neopentyl glycol, 1,4-cyclohexanedimethanol, diethylene glycol, triethylene glycol, and polyethylene glycol.

When water-soluble polyester copolymers are prepared employing terephthalic acid and isophthalic acid as main dicarboxylic acid components, from the viewpoint of mechanical properties as well as adhesion properties to polyester supports, it is preferable to use ethylene glycol or diethylene glycol as glycol components of water-soluble polyester in an amount of at least 40% by mole of the total glycol components.

It is possible to synthesize water-soluble polyester copolymers employing dicarboxylic acids or ester forming derivatives thereof and glycols or ester forming derivatives thereof as initial raw materials. Synthesis is carried out employing various methods which include, for example, an initial condensation product of dicarboxylic acids with glycols is prepared employing a transesterification method or a direct esterification method which subsequently is subjected to fusion polymerization.

Further, specifically, for example, an ester of dicarboxylic acid such as dicarboxylic acid dimethyl ester and glycol undergo transesterification and after removing methanol employing distillation, the pressure is gradually reduced and polymerization condensation is carried out under high vacuum. Other examples thereof include a method in which dicarboxylic acid and glycol undergo transesterification and further, after carrying out esterification by adding dicarboxylic acid, polymerization condensation is carried out under high vacuum.

Employed as transesterification catalysts and polymerization condensation catalysts may be any of the several known in the art. Employed as transesterification catalysts may be manganese acetate, calcium acetate and zinc acetate, while employed as polymerization condensation catalysts may be antimony trioxide, germanium oxide, dibutyl tin oxide, and titanium tetrabutoxide. However, polymerization methods as well as various conditions such as catalysts are not limited to the aforesaid examples.

Water-soluble polyester copolymers may be prepared as described below. While distilling methanol away, 35.4 parts by weight of dimethyl terephthalate, 33.63 parts by weight of dimethyl isophthalate, 17.92 parts by weight of dimethyl 5-sufoisophthalate sodium salt, 62 parts by weight of ethylene glycol, 0.065 part by weight of calcium acetate monohydrate, and 0.022 part by weight of manganese acetate underwent transesterification at a temperature of 170-220° C. under nitrogen gas stream, while methanol being distilled out. Thereafter, 0.04 part by weight of trimethyl phosphate, 0.04 part by weight of antimony trioxide, as a polymerization condensation catalyst and 6.8 parts by weight of 4-cyclohexanedicarboxylic acid were added and esterification was performed at a reaction temperature of 220-235° C., while the theoretical amount of water was substantially removed employing distillation. Thereafter, over approximately one hour, the pressure of the reaction system was reduced and polymerization condensation was carried out at 280° C. and 133 Pa for approximately one hour to obtain water-soluble polyester. The resulting water-soluble polyester exhibited an intrinsic viscosity of 0.33. Subsequently, the resulting copolymer was dispersed in pure water at 95° C. over 17 hours, whereby a water-soluble polyester copolymer dispersion (having a solid content of 15%) was obtained.

Further, commercially available water-soluble polyester copolymers of the present invention include FPY6762, MPS7762, WD3652, WTL6342, WNT9515, WMS5115, WD, SIZE, WNT, and WHS (all being trade names), manufactured by Eastman Chemical Co. which are usable in the present invention. Water-soluble polyesters are described, for example, in “Suiyosei Kobunshi Mizu Bunsangata Jushi Sogo Shiryo Shu (Comprehensive reference list of water-soluble polymer water-dispersible type resins)”, (Keiei Kaihatsu Center, 1981).

Further, water-soluble polyesters include VYLON 200 and 300 (manufactured by Toyo Boseki Co.), Finetex ES525, ES611, ES650, and ES675 (manufactured by Dainippon Ink Kagaku Kogyo Co.), KP-1019, KP-1027, and KP-1029 (manufactured by Matsumoto Yushi Seiyaku Co.), Plus Coat Z-446, 710, 711, 766, 770, 802, and 857 (manufactured by GOO Kagaku Kogyo Co.), and Pesresin A123D and A515GB (manufactured by Takamatsu Yushi Co.).

The molecular weight of the polyester employed in the present invention is preferably 2,000-200,000 in terms of the weight average molecular weight Mw. Further, Tg is preferably −10 to 90° C. from the aspect of film forming properties and strength.

Further, in the present invention, it is possible to preferably employ compounds which are prepared by modifying the water-soluble polyester copolymers, employing vinyl based monomers.

Modification, as described herein, means that vinyl based monomers undergo dispersion polymerization in a water-soluble polyester copolymer solution. Dispersion is obtained in such a manner that, for example, water-soluble polyester copolymers are dissolved in heated water, and vinyl based monomers are dispersed in the resulting water-soluble polyester copolymer solution, whereby emulsion polymerization or suspension polymerization is carried out. It is preferable that polymerization is carried out employing an emulsion polymerization method.

Water based dispersion is described which is prepared in such a manner that vinyl based monomers undergo dispersion polymerization in the water-soluble polyester solution of the present invention.

Listed as water-soluble polyesters which are used to prepare the aforesaid water based dispersion are, for example, substantially linear polymers which are obtained employing a polymerization condensation reaction of polybasic acids, or ester forming derivatives thereof, with polyols or ester forming derivatives thereof.

Employed as polybasic acid components of the aforesaid water-soluble polyesters may be, for example, terephthalic acid, isophthalic acid, phthalic acid, 2,6-naphthalenedicarboxylic acid, 1,4-cyclohexanedicarboxylic acid, adipic acid, sebacic acid, trimellitic acid, pyromellitic acid, and dimeric acid. Further, along with these components, it is possible to employ a small proportion of unsaturated polybasic acids such as maleic acid, fumaric acid, and itaconic acid, and hydroxycarboxylic acids such as p-hydroxybenzoic acid, and p-(β-hydroxyethoxy)benzoic acid.

Further, employed as polyol components may be ethylene glycol, diethylene glycol, 1,4-butanediol, neopentyl glycol, dipropylene glycol, 1,6-hexanediol, 1,4-cyclohexanedimethanol, xylene glycol, trimethylolpropane, poly(ethylene oxide)glycol, and poly(tetramethylene oxide)glycol.

In the present invention, the aforesaid water-soluble polyesters preferably comprise terephthalic acid and isophthalic acid as the main dicarboxylic acid components. The mol ratio of terephthalic acid/isophthalic acid is most preferably 30/70 to 70/30 in terms of coatability onto polyester supports and solubility in water. The phthalic acid component and isophthalic acid component is preferably contained in an amount of 50-80% by mole, based on the total dicarboxylic acid components.

In order to make polyester water-soluble, an effective means-is that components having a hydrophilic group such as a sulfonic acid salt containing component, a diethylene glycol component, a polyalkylene ether glycol component, and a polyether dicarboxylic acid component are introduced into polyester as copolymerization components. Preferably employed as components having a hydrophilic group are dicarboxylic acids having a sulfonic acid salt.

Specifically preferred as such dicarboxylic acids having a sulfonic acid salt are those having a sulfonic acid alkali metal salt group, which include alkali metal salts such as 4-sulfoisophthalic acid, 5-sulfoisopthalic acid, sulfophthalic acid, 4-sulfophthalic acid, 4-sulfonaphthalene-2,7-dicarboxylic acid and 5-(4-sulfophenoxy)isophthalic acid. Of these, sodium 5-sulfoisophthalate is specifically preferred. These sulfonic acid salt containing dicarboxylic acids are preferably employed in an amount ranging from 5 to 20% by mole, and more preferably 6-10% by mole, based on the total dicarboxylic acid components in view of water-solubility and water resistance.

Further, in the water-soluble polyesters of the present invention in which terephthalic acid and isophthalic acid are used as major dicarboxylic components, it is preferable to employ aliphatic dicarboxylic acids as a copolymerization component. Listed as such aliphatic dicarboxylic acids may be, for example, 1,4-cyclohexanedicarbpxylic acid, 1,3-cyclohexanedicarboxylic acid, 1,2-cyclohexanedicarboxylic acid, 1,3-cyclopentanedicarboxylic acid, and 4,4′-bicyclohexyldicarboxylic acid.

Further, in the water-soluble polyester in which terephthalic acid and isophthalic acid are employed as main dicarboxylic components, other carboxylic acid(s) may be used as a copolymerization component. Listed as such dicarboxylic acids are, for example, aromatic dicarboxylic acids and straight-chain aliphatic dicarboxylic acids. The aromatic dicarboxylic acids are preferably used in an amount of at most 30% by mole with respect to the total dicarboxylic acids components. Listed as such aromatic dicarboxylic acid components are, for example, phthalic acid, 2,5-dimethylterephthalic acid, 2,6-naphthalenedicarboxylic acid, 1,4-naphthalenedicarboxylic acid, and biphenyldicarboxylic acid. The straight-chain aliphatic dicarboxylic acids are used preferably in an amount of at most 15% by mole. Listed as such straight-chain aliphatic dicarboxylic acid components are, for example, adipic acid, pimelic acid, suberic acid, azelaic acid, and sebacic acid.

Further, listed as glycol components of the water-soluble polyesters of the present invention are, for example, ethylene glycol, 1,4-butanediol, neopentyl glycol, 1,4-cyclohexanedimethanol, diethylene glycol, triethylene glycol, and polyethylene glycol.

When the water-soluble polyester of the present invention is prepared employing terephthalic acid and isophthalic acid as major dicarboxylic components, from the viewpoint of mechanical properties and adhesion properties with polyester supports, it is preferable to employ those comprising ethylene glycol or diethylene glycol in an amount of at least 40% by mole with respect to the total glycols as glycol components of the water-soluble polyesters of the present invention.

The water-soluble polyester of the present invention can be synthesized employing dicarboxylic acids or ester forming derivatives thereof, and glycols or ester forming derivatives thereof as initial raw materials. Various methods can be employed for synthesis, and include, for example, a transesterification method or a direct esterification method, which are polyester production methods known in the art, in which an initial condensation product of dicarboxylic acid with glycol is formed and subsequently undergoes melt-polymerization. More specifically, there are a method in which, for example, dicarboxylic acid ester such as dimethyl ester of dicarboxylic acid and glycol undergo transesterification reaction and after removing methanol employing distillation, pressure is gradually reduced, whereby condensation polymerization is carried out under vacuum; a method in which dicarboxylic acid and glycol under go esterification reaction, and after removing the formed water employing distillation, pressure is gradually reduced, whereby polymerization condensation is carried out under high vacuum; and a method in which dicarboxylic acid ester and glycol undergo transesterification reaction, and further undergo esterification reaction by addition of dicarboxylic acid, and thereafter, polymerization condensation is carried out under high vacuum.

Employed as transesterification catalysts and polymerization condensation catalysts may be those known in the art. Employed as transesterification catalysts may be manganese acetate, calcium acetate, and zinc acetate, while employed as polymerization condensation catalysts may be antimony trioxide, germanium oxide, dibutyl tin oxide, and titanium tetrabutoxide. However, the various means such as polymerization methods and catalysts are not limited to the examples previously described.

In the present invention, a water based dispersion which is prepared in such a manner that vinyl based monomers undergo dispersion polymerization in an aqueous water-soluble polyester solution can be obtained as follows. For example, water-soluble polyester is dissolved in heated water, and vinyl based monomers are dispersed in the resulting aqueous water-soluble polyester solution. Subsequently, emulsion polymerization or suspension polymerization is carried out. Herein, polymerization is preferably carried out employing an emulsion polymerization.

In polymerization of vinyl based monomers, polymerization initiators are used. Listed as usable polymerization initiators-are, for example, ammonium persulfate, potassium persulfate, sodium persulfate and benzoyl peroxide. Of these, ammonium persulfate is preferred.

It is possible to carry out polymerization without using surfactants. However, in order to enhance polymerization stability, it is possible to employ surfactants as emulsifiers. In such a case, it is possible to employ either common nonionic or anionic type surfactants.

Listed as vinyl based monomers acryl based monomers such as alkyl acrylates and alkyl methacrylates (an alkyl such as a methyl group, an ethyl group, an n-propyl group, an isopropyl group, an n-butyl group, an isobutyl group, a t-butyl group, a 2-ethylhexyl group, a cyclohexyl group, a benzyl group, and a phenylethyl group); hydroxy-containing monomers such as 2-hydroxyethyl acrylate, 2-hydroxyethyl methacrylate, 2-hydroxypropyl acrylate, and 2-hydroxypropyl methacrylate; amide-containing monomers such as acrylamide, methacrylamide, N-methylmethacrylamide, N-methylacrylamide, N-methylolacrylamide, N,N-dimethylolacrylamide, N-methoxymethylacrylamide, N-methoxy methylmethacrylamide, and N-phenylacrylamide; amino-containing monomers such as N,N-diethylaminoethyl acrylate, and N,N-diethylaminoethyl methacrylate; epoxy-containing monomers such as glycidyl acrylate and glycidyl methacrylate; and a carboxyl group or its salt-containing monomers such as acrylic acid, methacrylic acid and salts thereof (such as a sodium salt, a potassium salt, or an ammonium salt). Further, listed as monomers, other than acryl based monomers, are epoxy group-containing monomers such as allyl glycidyl ether; sulfonic acid group or its salt containing monomer such as styrenesulfonic acid, vinylsulfonic acid and salts thereof (such as a sodium salt, a potassium salt, or an ammonium salt); a carboxy group or its salt containing monomers such as crotonic acid, itaconic acid, maleic acid, fumaric acid and salts thereof (such as a sodium salt, a potassium salt, and an ammonium salt); acid anhydride containing monomers such as maleic anhydride and itaconic anhydride, vinyl isocyanate, allyl isocyanate, styrene, vinyl trisalkoxysilane, alkylmaleic acid monoester, alkylfumaric acid monoester, acrylonitrile; methacrylonitrile, alkylitaconic acid monoester, vinylidene chloride, vinyl acetate, and vinyl chloride.

The employed amount of vinyl based monomers is preferably at least 10 percent by weight in terms of the weight ratio of (polyester)/(vinyl based monomer) in modification, and is more preferably 10-50% by weight.

It is possible to form the subbing layer of the present, for example, by applying a coating composition onto a support comprising an water based dispersion which is prepared by dispersion polymerizing vinyl based monomers in the aforesaid aqueous water-soluble polyester solution.

If desired, the subbing layer of the present invention may be blended with polymers other than vinyl monomer modified polyester. Without particular limitations, employed as polymers are water-soluble polymers such as gelatin and polyvinyl alcohol and hydrophobic polymers such as vinyl based polymer latex, poly ethyl acrylate, vinylidene chloride, and polyurethane.

Polymer latex, as described in the present invention, refers to polymer components in a dispersion in which the water-insoluble hydrophobic polymer is dispersed in water or a water-soluble dispersion medium in the form of particles. Dispersion states may be any of the following states: the polymer is emulsified in a dispersion medium in a dispersed state; the polymer is formed employing emulsion polymerization; the polymer is subjected to micelle dispersion; or the polymer has a partial hydrophilic structure in the molecule and the molecular chain itself is subjected to molecular dispersion.

Polymer latexes according to the present invention are described for example in “Gosei Jushi Emulsion (Synthetic Resin Emulsion)”, edited by Taira Okuda and Hiroshi Inagaki, published by Kobunshi Kankokai (1978); “Gosei Latex no Oyo (Application of Synthetic Latexes)”, edited by Takaaki Sugimura, Yasuo Kataoka, Soichi Suzuki, and Keiji Kasahara, published by Kobunshi Kankokai (1993); and Soichi Muroi, “Gosei Latex no Kagaku (Chemistry of Synthetic Latexes)”, published by Kobunshi Kankokai (1970).

The average diameter of dispersed particles in polymer latexes is preferably in the range of 1 to 50,000 nm, and is more preferably in the range of 5 to 1,000. nm. Dispersed particles may have either a wide particle size distribution or a particle size distribution showing monodispersion.

The vinyl based polymer latexes according to the present invention may include so-called core/shell type polymer latexes other than the common polymer latexes having a uniform structure. In such a case, it is occasionally preferable to regulate the glass transition temperature so that the glass transition temperature of the core is different from the shell.

The minimum film forming temperature (MFT) of the vinyl based polymer latexes according to the present invention is preferably −30 to 90° C., and is more preferably 0 to 70° C. Film forming aids may be added to control the minimum film forming temperature. Film forming aids, which are also called plasticizers, are organic compounds (customarily organic solvents capable of lowering the minimum film forming temperature of the latexes), which are described, for example, in Soichi Muroi, “Gosei Latex no Kagaku (Chemistry of Synthetic Latexes)”, published by Kobunshi Kankokai (1970), which has previously been cited.

The used amount of vinyl based monomers is preferably in the range of 99/1 to 5/99 in terms of ratio by weight of (hydrophilic polymer)/(vinyl based monomers constituting vinyl based polymer latex).

Vinyl based polymer latexes usable in the present invention can be prepared employing any of the several emulsion polymerization methods. For example, using water as a dispersing medium, with 10-50% by weight of monomers with respect to water, 0.05-5% by weight of polymerization initiators with respect to monomers and 0.1-20% by weight of dispersing agents with respect to monomers, polymerization is carried out at a temperature of 30-100° C. (and preferably 60-90° C.) for a period of 3-8 hrs., while stirring. In the preparation, conditions such as amounts of monomers and polymerization initiators, reaction temperature and reaction time can be varied.

Employed as polymerization initiators may be water-soluble peroxides (for example, potassium persulfate and ammonium persulfate), water-soluble azo compounds (for example, 2,2′-azobis(2-aminodipropane)hydrochloride), and their combination along with reducing agents such as Fe²⁺ salts or sodium hydrogen sulfite, i.e., redox type polymerization initiators. Employed as dispersing agents are water-soluble polymers. Further, it is possible to use any of the several anionic surfactants, nonionic surfactants, cationic surfactants and amphoteric surfactants.

The number average particle diameter of the vinyl based polymer latexes is preferably 0.005-2.0 μm, and is more preferably 0.01-0.8 μm.

As the vinyl based latexes, acryl based polymer latexes are preferred. Acryl based latexes, as described herein, refer to polymer latexes which comprise acryl based monomers such as methacrylic acid and acrylic acid, and esters or salts thereof, acrylamide or methacrylamide in an amount of at least 50% by mole, based on the total polymer components.

The acryl based polymer latexes may be produced employing individual acryl based monomers or acryl based monomers together with other monomers (hereinafter referred to as co-monomers) which are copolymerizable with the acryl based monomers. Listed as acryl based monomers are, for example, acrylic acid; methacrylic acid; acrylic acid esters such as alkyl acrylate (for example, methyl acrylate, ethyl acrylate, n-propyl acrylate, isopropyl acrylate, n-butyl acrylate, isobutyl acrylate, t-butyl acrylate, 2-ethylhexyl acrylate, cyclohexyl acrylate, phenyl acrylate, benzyl acrylate, and phenylethyl acrylate); hydroxy-containing alkyl acrylate (for example, 2-hydroxyethylacrylate, 2-hydroxypropyl acrylate); methacrylic acid esters such as alkyl methacrylate (for example, methyl methacrylate, ethyl methacrylate, n-propyl methacrylate, isopropyl methacrylate, n-butyl methacrylate, isobutyl methacrylate, t-butyl methacrylate, 2-ethylhexyl methacrylate, cyclohexyl methacrylate, phenyl methacrylate, benzyl methacrylate, and phenylethyl methacrylate); hydroxy-containing alkyl methacrylate (for example, 2-hydroxyethyl methacrylate, 2-hydroxypropyl methacrylate); acrylamide; substituted acrylamide such as N-methylacrylamide, N-methoxymethyl acrylamide; methacrylamide; substituted methacrylamide such as N-methylmethacylamide, N-methylol methacylamide, N,N-dimethylol methacrylamide, and n-methoxymethyl methacrylamide; amino-substituted alkyl methacrylate such as N,N-diethylaminomethacrylate; epoxy group-containing acrylate such as glycidyl acrylate; epoxy group-containing methacrylate such as glycidyl methacrylate; and acrylate salts such as sodium salt and potassium salt and ammonium salt. The aforesaid monomers may be employed singly or in combination with at least two types.

Listed as co-monomers are styrene and derivatives thereof; unsaturated carboxylic acids (for example, itaconic acid, maleic acid, and fumaric acid); unsaturated carboxylic acid esters (for example, methyl itaconate, dimethyl itaconate, methyl maleate, dimethyl maleate, methyl fumarate, and dimethyl fumarate); unsaturated dicarboxylate salts (for example, sodium salt, potassium salt, and ammonium salt); sulfonic acid or its salt-containing monomers comprising a sulfonic acid or salts thereof (for example, styrenesulfonic acid, vinylsulfonic acid, and salts thereof (for example, sodium salt, potassium salt, and ammonium salt); acid anhydrides such as maleic anhydride and itaconic anhydride; vinyl isocyanates; allyl isocyanates; vinyl methyl ethers; vinyl ethyl ethers; and vinyl acetates. The aforesaid monomers may be employed singly or in combination with at least two types.

[Polyvinyl Alcohol (PVA)]

Listed as polymers comprising polyvinyl alcohol units may be polyvinyl alcohols derivatives such as ethylene copolymerization polyvinyl alcohol and polyvinyl alcohol modified materials which are prepared by dissolving partially butylated polyvinyl alcohol in water.

The degree of polymerization of polyvinyl alcohol is preferably at least 100. Further, listed as copolymerization components of vinyl acetate based polymers prior to saponification of polymers having vinyl alcohol units may be polymers having monomer units, such as vinyl compounds, such as ethylene and propylene; acrylic acid esters (such as t-butyl acrylate, phenyl acrylate, and 2-naphthyl acrylate); methacrylic acid esters (such as methyl methacrylate, ethyl methacrylate, 2-hydroxyethyl methacrylate, benzyl methacrylate, 2-hydroxypropyl methacrylate, phenyl methacrylate, cyclohexyl methacrylate, cresyl methacrylate, 4-chlorobenzyl methacrylate, and ethylene glycol dimethacrylate); acrylamides (such as acrylamide, methylacrylamide, ethylacrylamide, propylacrylamide, butylacrylamide, tert-butylacrylamide, cyclohexylacrylamide, benzylacrylamide, hydroxymethylacrylamide, methoxyethylacrylamide, dimethylaminoethylacrylamide, phenylacrylamide, dimethylacrylamide, diethylacrylamide, β-cyanoethylacrylamide, and diacetoneacryl amide); methacrylamides (such as methacrylamide, methylmethacrylamide, ethylmethacrylamide, propylmethacrylamide, butylmethacrylamide, tert-butylmethacrylamide, cyclohexylmethacrylamide, benzylmethacrylamide, hydroxymethylmethacrylamide, methoxyethylmethacrylamide, dimethylaminoethylmethacrylamide, phenylmethacrylamide, dimethylmethacrylamide, diethylmethacrylamide, and β-cyanoethylmethacrylamide); styrenes (such as styrene, methylstyrene, dimethylstyrene, trimethylenestyrene, ethylstyrene, isopropylstyrene, chlorostyrene, methoxystyrene, acetoxystyrene, chlorostyrene, dichlorostyrene, bromostyrene, and vinylbenzoic acid methyl ester); divinylbenzene, acrylonitrile, methacrylonitrile, N-vinylpyrrolidone, N-vinyloxazolidone, vinylidene chloride, and phenyl vinyl ketone. Of these, ethylene copolymerization polyvinyl alcohol is preferred.

Commercially available polyvinyl alcohols and modified polyvinyl alcohols may generally be employed. Listed as representative commercially available polyvinyl alcohols are PVA-203, PVA-204, PVA-205, PVA-210, PVA-217, PVA-220, PVA-224, PVA-228, PVA-235, PVA-403, PVA-405, and PVA-420, manufactured by Kuraray Co., Gosenol GL-03, GL-05, AL-02, and NK-05, manufactured by Nihon Gosei Kagaku Co., and Denka Poval K-02 and B03, manufactured by Denki Kagaku Kogyo Co. Listed as representative commercially available modified polyvinyl alcohols are MP-202 and MP-203, manufactured by Kuraray Co.

[Styrene-Diolefin Based Copolymer]

A subbing layer containing a hydrophobic polymer including a styrene-diolefin based copolymer:

As a styrene-diolefin based copolymer, a rubber-like material is preferable. A diolefin monomer may be a monomer having two double bonds within a molecule, or be a monomer having a cyclic structure in the aliphatic unsaturated hydrocarbon. Specifically, examples of conjugate dienes include butadiene, isoprene and chloroprene, and examples of nonconjugate dienes include compounds described in paragraph [0107] of Japanese Patent O.P.I. Publication No. 2003-315960 such as 1,4-pentadiene, 1,4-hexadiene and 3-vinyl-1,5-hexadiene. Of these diolefin monomers, butadiene, isoprene and chloroprene are preferably usable as the conjugate diene, and butadiene is more preferably usable. Styrene as another monomer to form a copolymer means styrene or a styrene derivative, provided can be compounds described in paragraph [0107] of Japanese Patent O.P.I. Publication No. 2003-315960 such as methylstyrene, dimethylstyrene and ethylstyrene. The content of diolefin monomer in a copolymer of the present invention is preferably 10-60% by weight, based on the total copolymer, and more preferably 15-40% by weight. The content of styrenes is 40-70% by weight, based on the total copolymer. The 3^{rd} component may be incorporated to the copolymer employed in the present invention. As a polymerization method thereof, usable is a method described in Japanese Patent O.P.I. Publication No. 2003-315960. Examples of copolymers usable in the present invention include styrene-butadiene, styrene-isoprene, styrene-chloroprene, methylmethacrylate-butadiene and acrylonitrile-butadiene. Of these, styrene-butadiene based latex is particularly preferable.

[Inorganic Fillers]

Listed as inorganic fillers which may be added to the subbing layer according to the present invention are, for example, oxides, hydroxides, carbonates, sulfates, silicates, nitrides, carbons, various metals, and alloys, described in “Filler Katsuyo Jiten (Filler Application Handbook)”, by Filler Kenkyu Kai, First Edition, First Printing.

Specifically listed are inorganic fillers such as carbon black, graphite, carbon fibers, carbon barun, various metals, calcium hydroxide, magnesium hydroxide, aluminum hydroxide, TiO₂, BaSO₄, calcium sulfate, satin spar, ZnS, MgCO₃, CaCO₃, zinc carbonate, barium carbonate, dosonite, hydrotalsite, ZnO, CaO, WS₂, MOS₂, MgO, SnO₂, Al₂O₃, α-Fe₂O₃, α-FeCOOH, SiC, CeO₂, BN, SiN, MoC, BC, WC, titanium carbide, corundum, artificial diamond, garnet, silica, toriboli, diatomaceous earth, dolomite, calcium silicate (worastnite and sonotorite), talc, clay, mica, montnorillonite, bentonite, activated clay, cepiorite, imogorite, ceisarite, glass fibers, glass beads, silica based barun, aluminum nitride, boron nitride, and silicon nitride, and colloidal silica.

The particle shape is not particularly specified and fiber, needle, tabular, and granular particles are employed. Further, the particle diameter is preferably about 0.005-10 μm in terms of an equivalent sphere.

Further, these inorganic fillers may be employed in combination of several types or along with organic fillers such as polyethylene resin particles, fluorine resin particles, guanamine resin particles, acrylic resin particles, silicone resin particles, and melamine resin particles.

[Others]

It is possible to add surfactants such as anionic surfactants, cationic surfactants, and nonionic surfactants to the aforesaid subbing layer forming coating composition in a necessary amount.

Preferred as such surfactants are those capable of adjusting the surface tension of a water based coating composition to at most 500 μN/cm² and of enhancing wettability of polyester film. Examples include polyoxyethylene alkylpenyl ethers, polyoxyethylene-aliphatic acid esters, sorbitan fatty acid esters, glycerin fatty acid esters, fatty acid metal soaps, alkyl sulfates, alkyl sulfonates, alkyl sulfosuccinates, quaternary ammonium chlorides, and alkylamine hydrochlorides.

If desired, plasticizers, crosslinking agents, and dyes may be incorporated in the subbing layer according to the present invention.

If desired, swelling agents, matting agents, cross-over dyes, antihalation dyes, pigments, antifoggants, and antiseptics may be incorporated in the subbing layer coating composition according to the present invention. Employed as swelling agents are, for example, phenol, resorcinol, cresol, and chlorophenol. The added amount may be 1-10 g per liter of the subbing layer coating composition of the present invention. Preferred as matting agents are silica having a particle diameter of 0.1-10 μm, polystyrene spheres, and methyl methacrylate spheres.

In the present invention, it is preferable that matting agents are incorporated in the subbing layer to improve high speed conveyance properties. Employed as matting agents are particles having an average diameter of 0.1-8 μm, and preferably about 0.2-5 μm, comprised of styrene, polymethyl acrylate, and silica. The used amount of matting agents is preferably 1-200 mg per m² of heat-developing recording materials, and is more preferably 2-100 mg.

The dry thickness of the subbing layer according to the present invention is preferably 0.01-10 μm, and is more preferably 0.03-3 μm.

Further, it is possible to add other additives such as antistatic agents, UV absorbents, pigments, organic fillers, inorganic fillers, lubricants, blocking minimizing agents, and stabilizers to the primer layer forming coating compositions.

Employed as crosslinking agents are compounds, known in the art, such as epoxy, isocyanates, and melamine. Further, active halogen crosslinking agents are preferred which are described in Japanese Patent O.P.I. Publication No. 51-114120.

Employed as dyes may be antihalation dyes and tone controlling dyes.

The subbing layer of the present invention may be formed by coating either a water based or an organic solvent based coating composition, and subsequently drying the resulting coating. However, from the viewpoint of cost and environmental protection, more preferred is the water based coating in which the water based coating composition is coated. “Water based coating composition”, as described herein, refers to a coating composition in which the proportion of water in the coating composition is at least 30% by weight of the solvents (dispersion medium) of the entire coating composition, and is preferably at least 50% by weight. Listed as specific solvent compositions other than water are solvent mixtures described below:
Water/methanol=85/15, water/methanol=70/30, water/methanol/dimethylformamide (DMF)=80/15/5, water/isopropyl alcohol=60/40 (wherein numerals show a weight ratio)

Only one subbing layer comprising a polyester of the present invention may be provided or at least two subbing layers comprising the same may be provided.

In the optical film or light diffusion film of the present invention, a subbing layer comprising no polyester may be provided in addition to the aforesaid subbing layer comprising the polyester. Employed as binders used in such subbing layers may be, for example, gelatin. If desired, the aforesaid crosslinking agents, matting agents, dyes, fillers, and surfactants may be added to such subbing layers. The thickness of such subbing layers is preferably 0.02-30 μm per layer, and is more preferably 0.08-30 μm.

It is possible to form a subbing layer according to the present invention while coating employing any of the several well known methods and subsequently drying it. Listed as usable coating methods are, for example, a dip coating method, an air knife coating method, a curtain coating method, a roller coating method, a wire bar coating method, and a gravure coating method, and an extrusion coating method employing a hopper, described in U.S. Pat. No. 2,681,294. Further, if desired, it is possible to preferably use a method in which at least two layers are simultaneously coated, described in U.S. Pat. Nos. 2,761,791, 3,508,947, 2,941,893, and 3,526,528 and Yuji Harazaki, “Coating Engineering” page 253 (1973, published by Asakura Shoten).

The coating thickness of the coating composition employed for the subbing layer according to the present invention is preferably 3 to 100 μm, and is more preferably 5 to 20 μm. Drying conditions after coating the coating composition employed for the subbing layer of the present invention are 25 to 200° C. for about 0.5 second to about one minute. It is preferable that the subbing layer of the present invention is subjected to a thermal treatment after coating and drying. Such treatment conditions range from 110 to 200° C. for about 10 seconds to about 10 minutes.

The optimal temperature of coating compositions is 25 to 35° C. When the temperature exceeds 35° C., the pot life of the coating composition degrades, while when the temperature is less than 25° C., adhesion strength as well as film forming strength occasionally degrades.

In the present invention, a subbing layer may be electrically conductive. Preferably listed are particles comprised of metal oxides such as oxygen insufficient oxides, metal surplus oxides, metal insufficient oxides, and oxygen surplus oxides which tend to form non-stoichiometric compounds. Of these, metal oxides which are most suitable for the present invention are metal oxide particles which make it possible to employ various systems such as production methods. Commonly employed as metal oxides are crystalline metal oxides which include ZnO, TiO₂, SnO₂, Al₂O₃, In₂O₃, SiO₂, MgO, B₂O, and MoO₃, and composite oxides thereof. Of these, ZnO, TiO₂, and SnO₂ are preferred. Preferred as composite oxides are ZnO comprising Al and In, TiO₂ comprising Nb and Ta, and SnO₂ comprising Sb, Nb, and halogens, in which the proportion of foreign elements is preferably 0.01 to 30% by mole, and is more preferably 0.1 to 10% by mole.

The volume resistivity of these metal oxide particles is preferably at most 10⁷ Ω·cm, and is more preferably 10⁵ Ω·cm. Those which have oxygen defects in their crystals and which comprise a small amount of foreign atoms, which function as so-called donors for the aforesaid metal oxide, are preferably incorporated due to an increase in conductivity. Production methods of such metal oxide particles are detailed, for example, in Japanese Patent O.P.I. Publication No. 56-143430.

Such metal oxide particles increase electrical conductivity. On the other hand, it is necessary to take into account the particle diameter as well as the ratio of particles/binders for light scattering. Further, haze is enhanced and it is difficult to prepare the dispersion. As a result, it is more preferable to use inorganic colloids which exist as colloids in water. Inorganic colloids, as described herein, refer to those defined in “Kagaku Daijiten (ENCYCLOPEDIA CHIMICA)”, published by Kyoritsu Shuppan and those which comprise 10⁵-10⁹ atoms per particle.

Depending on elements, metal colloids, oxide colloids or hydroxide colloids are prepared. Gold, palladium, platinum, silver and sulfur are preferably employed to prepare the metal colloids. Oxide colloids, hydroxide colloids, carbonate colloids, and sulfate colloids of zinc, magnesium, silicon, calcium, aluminum, strontium, barium, zirconium, titanium, manganese, iron, cobalt, nickel, tin, indium, molybdenum, and vanadium are preferably employed in the present invention. Specifically, ZnO, TiO₂, and SnO₂ are preferred. Of these, SnO₂ is most preferred. Further, listed as examples of foreign atoms employed for doping are Al and In for ZnO, Nb and Ta for TiO₂, and Sb, Nb, and halogen atoms for SnO₂. The average diameter of inorganic colloid particles is preferably 0.001-1 μm in view of dispersion stability.

The metal oxide colloids, especially colloidal SnO₂ sol comprised of stannic oxide are prepared employing either a method in which ultra-fine SnO₂ particles are dispersed in suitable solvents, or a method in which solvent-soluble Sn compounds undergo dispersion reaction in solvents.

In regard to the production method of ultra-minute SnO₂ particles, temperature conditions are particularly critical. A method which accompanies a thermal process at high temperature is not preferred due to generation of phenomena such as growth of primary particles as well as enhancement of crystallinity. Unavoidably when it necessary to carry out a thermal process, the thermal process is customarily carried out at less than or equal to 300° C., preferably at less than or equal to 200° C., and more preferably at less than 150° C. or equal to 150° C. When taking into account dispersion into binders, heating from 25 to 150° C. is an optimally selected means.

A production method utilizing a decomposition reaction of solvent-soluble Sn compounds in solvents will now be described. Solvent-soluble Sn compounds, as described herein, refer to oxo negative ion-containing compounds such as K₂SnO₃.3H₂O, water-soluble halides such as SnCl₄, and compounds having a structure such as R′₂SnR₂, R₃SnX and R₂SnX₂ (wherein R and R′ each represents an alkyl group), which may include organic metal compounds such as (CH₃)₃SnCl.(pyridine) and (C₄H₉)₂Sn(O₂CC₂H₅) and oxo salts such as Sn(SO₄)₂.2H₂O. Methods in which SnO₂ sol is produced employing such solvent-soluble Sn compounds include a physical method in which after dissolving in solvents, heat or pressure is applied to the resulting composition, a chemical method in which oxidation, reduction or hydrolysis is employed, and a method in which SnO₂ is produced via intermediates. It is possible to apply to the metal oxides of the present invention a SnO₂ sol production method described in Japanese Patent Examined Publication No. 35-6616.

It is preferable in the present invention to use an electrically conductive subbing layer. It is particularly preferable to use an electrically conductive subbing layer provided on both surfaces of a support on the front surface side and back surface side. The occurrence of abrasion resistance and curl can be largely reduced by employing the electrically conductive subbing layer provided on both surfaces of a support.

[Hard Coat Film and Anti-Reflection Film]

The support provided with the subbing layer of the present invention is applicable to the hard coat film and anti-reflection film described, for example, in Japanese Patent O.P.I. Publication No. 2005-4163, Japanese Patent O.P.I. Publication No. 2005-114751, Japanese Patent O.P.I. Publication No. 2005-107209, Japanese Patent O.P.I. Publication No. 2005-114852, Japanese Patent O.P.I. Publication No. 2005-14876.

The following describes the anti-reflection film which is preferably used in the present invention.

An example of the anti-reflection film in the present invention includes a support (hereinafter referred to as “substrate” as well), an anti-reflection film arranged on one of the main surface sides of the aforementioned substrate, and a protective film arranged on the main surface side of the aforementioned anti-reflection film.

The light transmittance of all rays of the aforementioned protective film is preferably 80% or more without exceeding 95%. If the light transmittance of all rays of the protective film is less than 80%, it is difficult to examine the coating condition of the anti-reflection film.

Further, a near-infrared ray absorbing layer is preferably arranged on the side opposite to the main surface side of the aforementioned substrate wherein the aforementioned anti-reflection film is provided. To put it more specifically, when the aforementioned near-infrared ray absorbing layer is provided, spectral transmittance is preferably 0.1-20% over the entire range of the wavelength of 850-1100 nm. Especially in the entire range of 900-1100 nm, the spectral transmittance is more preferably 0.1-10%. This arrangement prevents emission of unwanted near-infrared ray. Especially when the anti-reflection film of the present invention is attached to the front surface plate of the plasma display panel, emission of unwanted near-infrared ray is prevented, with the result that the surrounding electronic equipment is not adversely affected.

Further, an ultraviolet absorber is preferably placed somewhere between the aforementioned near-infrared ray absorbing layer and the aforementioned anti-reflection film. This arrangement prevents the near-infrared ray absorbing layer from being deteriorated by such an external ray as the sunshine. The aforementioned ultraviolet absorber is preferably contained in the aforementioned substrate from the manufacturing viewpoint.

The aforementioned anti-reflection film is preferably formed of a medium refractive index layer, high refractive index layer and low refractive index layer in that order from the side of the aforementioned substrate. This arrangement can reduce the reflection factor in the visible light wavelength range.

A further hard coat layer is preferably formed between the aforementioned substrate and anti-reflection film. This structure provides improved scratch resistance.

The anti-reflection film manufacturing method preferably includes a process of arranging the near-infrared ray absorbing layer on the side opposite to the main surface side of the aforementioned substrate wherein the aforementioned anti-reflection film is located. This will provide the anti-reflection film with a near-infrared ray absorbing function.

A process of arranging an ultraviolet absorber is preferably provided somewhere between the aforementioned near-infrared ray absorbing layer and anti-reflection film. This arrangement prevents the near-infrared ray absorbing layer from being deteriorated by such an external ray as the sunshine. The aforementioned ultraviolet absorber is preferably contained in the aforementioned substrate from the manufacturing viewpoint.

The aforementioned anti-reflection film is preferably formed of a medium refractive index layer, high refractive index layer and low refractive index layer in that order from the side of the aforementioned substrate. This arrangement can reduce the reflection factor in the visible light wavelength range.

In the manufacturing method of the present embodiment, a process of the hard coat layer is preferably provided between the aforementioned substrate and anti-reflection film. This structure provides improved scratch resistance.

The following describes the method of manufacturing the anti-reflection film used in the present invention with reference to drawings:

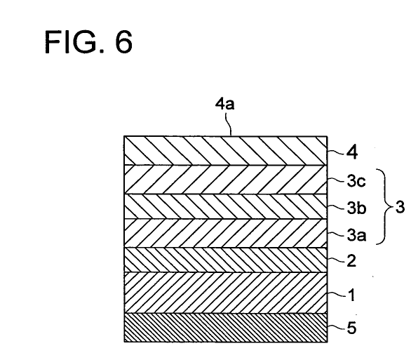

FIG. 6 is a cross-sectional view showing an example of the anti-reflection film of the present invention. The anti-reflection film of the present embodiment includes substrate 1; hard coat layer 2 formed on one of the main surfaces of substrate 1; anti-reflection film 3 made of the three layers formed on hard coat layer 2; protective film 4 arranged on anti-reflection film 3; and near-infrared ray absorbing layer 5 formed on the other main surface of substrate 1. Further, anti-reflection film 3 is formed of medium refractive index layer 3a, high refractive index layer 3b and low refractive index layer 3c in that order from substrate 1.

There is no restriction to the material of the substrate 1 if it is translucent. For example, the substrate 1 can be made of the following resins formed into a film or sheet. These resins are saturated polyester resin, polycarbonate resin, polyacryl acid ester resin, alicyclic polyolefin resin, polystyrene resin, polyvinyl chloride resin and polyvinyl acetate resin. These resins can be formed into a film or sheet by extrusion molding, calender molding, compression molding or injection molding. They can be also be formed by the method of dissolving and casting the aforementioned resins. Substrate 1 preferably has a thickness of about 10-500 μm. The aforementioned resin may be mixed with such additives as antioxidant, flame retardant, heat preventive agent, ultraviolet absorber, smoothing agent and antistatic agent.

There is no restriction to the material of the hard coat layer 2 if it is hard and translucent. For example, the hard coat layer 2 can be made of the thermosetting resin composition based on urethane, melamine or epoxy, or the radiation curable resin composition including the multifunctional or monofunctional acrylate monomer and oligomer and photo-polymerization initiator, and various type of additives. Use of the radiation curable resin composition having particularly high surface hardness is preferred. Further, addition of inorganic particles to the aforementioned resin provides higher surface hardness, and reduces the shrinkage resulting from curing of the resin. Inorganic particles can be made of silicon dioxide (silica), tin doped indium oxide, antimon doped tin oxide and zirconium oxide, for example.

There is no restriction to the method of forming hard coat layer 2 on substrate 1. Hard coat layer 2 can be formed by such a coating method as roll coating, die coating, air knife coating, blade coating, spin coating, reverse coating and gravure coating methods, or such a printing method as gravure printing, screen printing, offset printing and injection printing methods. Hard coat layer 12 preferably has a thickness of 1-10 μm. More preferable thickness ranges of 2-7 μm.

There is no restriction to the material of medium refractive index layer 3a if it has refractive index nm of 1.55-1.65, more preferably 1.57-1.63, and is translucent. For example, one of the preferably usable materials is a coating composition made of inorganic particles of high refractive index uniformed dispersed in the crosslinkable organic compound such as a thermosetting resin composition or radiation curable resin composition. The aforementioned inorganic particles are exemplified by those of titanium oxide, tin oxide, indium oxide, tin doped indium oxide (ITO), antimon doped tin oxide (ATO), zirconium oxide, zinc oxide and cerium oxide. Among them, ITO particles or ATO particles having a high degree of electrical conductivity are used with particular preference since they provides excellent antistatic performances for films.

There is no restriction to the method of forming medium refractive index layer 3a on hard coat layer 2. The aforementioned various types of coating methods and printing methods can be used to form this layer. The product nmdm (optical thickness) between the refractive index nm and the thickness dm of medium refractive index layer 3a is preferably 100-150 nm, and more preferably 110-140 nm.

There is no restriction to the material of high refractive index layer 3b if it has a refractive index nh of 1.75-1.85, more preferably 1.76-1.84. For example, one of the preferably used coating compositions is the titanium oxide particles as inorganic particles having the highest refractive index which are uniformed dispersed in the crosslinkable organic composition such as thermosetting resin composition or radiation curable resin composition. High refractive index layer 3b is formed of this coating composition solidly crosslinked as a film. Of the titanium oxide particles, those of anatase type structure have a function of photocatalysis, and have a problem in that when exposed to ultraviolet rays, they decompose the resin components constituting the coating film and such an organic substance as a substrate. To avoid this, the titanium oxide particles of rutile type structure are preferably used because they are characterized by low photocatalysis and high refractive index. The amount of titanium oxide particles is preferably 50% by weight through 65% by weight with respect to the overall weight of high refractive index layer 13b having been cured.

There is no restriction to the method of forming high refractive index layer 3b on medium refractive index layer 3a. The aforementioned various coating methods and printing methods can be used to form this layer. The product nh dh (optical thickness) between the refractive index nh and thickness dh of the high refractive index layer 13b is preferably 210-260 nm, more preferably 220-250 nm.

The organic component in aforementioned high refractive index layer 3b preferably contains the organic components having a refractive index of 1.60 through 1.80, more preferably 1.65 through 1.75. This arrangement allows the refractive index to be increased even with decrease in the amount of titanium oxide particles in high refractive index layer 3b. If the amount of titanium oxide particles is reduced, the crosslinking performance of the organic components in high refractive index layer 3b can be prevented from being deteriorated. Curing of the organic components (resin) is encouraged and the scratch resistance of the anti-reflection film is enhanced. When the refractive index of the aforementioned organic components is below 1.60, the amount of titanium oxide particles in high refractive index layer 3b will be insufficient. When the refractive index of the aforementioned organic components is over 1.80, the yellow color of the reflected light tends to be intensified. This is not preferred. The organic material of high refractive index that can be an organic component having a refractive index of 1.60-1.80 is exemplified by the organic compound containing the aromatic ring, sulfur and bromine. For example, diphenyl sulfide and derivatives thereof can be used.

There is no restriction to the material of the low refractive index layer 3c if it has a refractive index nl is 1.35-1.45, more preferably 1.35-1.43 and is translucent. For example, one of the preferably used materials is the coating composition made of the organic compound of fluorine, silicone or the like, and the inorganic particles of silica, magnesium fluoride or the like which are uniformly dispersed in the crosslinkable organic component such as a thermosetting resin composition or radiation curable resin composition. Especially when the UV curable resin composition is used out of the radiation curable resin compositions, such an inert gas as nitrogen is purged in order to avoid an adverse effect of the oxygen upon polymerization, and ultraviolet rays are preferably applied at an oxygen concentration of 1000 ppm or less.

There is no restriction to the method of forming low refractive index layer 13c on the high refractive index layer 3b. The aforementioned various coating and printing methods can be used. The product nldl (optical thickness) between the refractive index nl and thickness dl of low refractive index layer 13c is preferably 120-150 nm, more preferably 120-140 nm.

There is no restriction to the material of protective film 4 if it is translucent. For example, polyethylene terephthalate, polyethylene naphthalate, polyurethane, polycarbonate, polystyrene, polypropylene and polyethylene can be used.

There is no restriction to the method of arranging protective film 34 on low refractive index layer 3c. Normally, Protective film 4 is provided as it is bonded to the separator through the agglutinant. This separator is laminated on the aforementioned low refractive index layer 33c while being removed. The thickness of protective film 4 is preferably 5-200 μm, more preferably 10-100 μm.

There is no restriction to the material of near-infrared ray absorbing layer 5 if it is translucent to absorb the near-infrared ray. Normally, the resin containing the compound for absorbing the near-infrared ray is used, wherein this compound is dispersed therein. The preferably used compound for absorbing the near-infrared ray is the organic pigment having maximum absorption wavelength in the near-infrared range. For example, it is possible to use such organic pigments as aluminum, azo, azine, anthraquinone, indigoid, oxazine, quinophthalonine, squalium, stilbene, triphenylmethane, naphthoquinone, diimonium, phthalocyanine, cyanine and polymethine.

The acryl resin, polyurethane, polyvinyl chloride, epoxy resin, polyvinyl acetate, polystyrene, cellulose, polybutyral, polyester can be used as the aforementioned resins. A polymer blend formed of two or more of these resins can also be used.

Near-infrared ray absorbing layer 5 preferably contains the material having the maximum absorption wavelength in the wavelength range of 850-1100 nm. If near-infrared ray absorbing layer 5 contains the aforementioned compound, it is possible to reduce the transmittance of the near-infrared ray in the wavelength range of 850-1100 nm, without a substantial reduction of the transmittance of the visible light having a wavelength of 400-850 nm. One type of the aforementioned organic pigment or a combination of two and more of these organic pigments can be used as the material having the maximum absorption wavelength in the wavelength range of 850-1100 nm. This arrangement allows the anti-reflection film of the present embodiment to be used preferably as a near-infrared ray absorbing filter such as a plasma display panel.

The compound for cutting off the neon emission line (orange color) of the plasma display panel can be added to the near-infrared ray absorbing layer 5, as appropriate. This procedure ensures the red to be produced in a more bright color on the plasma display panel. The organic pigment having the maximum absorption wavelength in the wavelength range of 580 nm-620 nm can be used as the compound for cutting off the neon emission line spectrum. For example, it is possible to use such an organic pigment such as cyanine, azulenium, squalium, diphenyl methane, triphenyl methane, oxazine, azine, thiopylium, viologen, azo, azo metallic complex, azaporphyrin, bis-azo, anthraquinone and phthalocyanine.

[Infrared Ray Absorbing Film]

The infrared ray absorbing film to which the support provided with the subbing layer of the present invention can be applied is exemplified by the infrared ray absorbing film used in the front filter for plasma display described in WO97/38855, Japanese Patent O.P.I. Publication No. 09-145919, Japanese Patent O.P.I. Publication No. 10-78509, Japanese Patent O.P.I. Publication No. 10-105076, Japanese Patent O.P.I. Publication No. 10-153964, Japanese Patent O.P.I. Publication No. 10-211668, Japanese Patent O.P.I. Publication No. 11-326629, Japanese Patent O.P.I. Publication No. 11-65463, Japanese Patent O.P.I. Publication No. 2000-227515, Japanese Patent O.P.I. Publication No. 2001-19898, Japanese Patent O.P.I. Publication No. 2001-194522, Japanese Patent O.P.I. Publication No. 2002-328219, Japanese Patent O.P.I. Publication No. 2002-189422. The infrared ray absorbing dye can be kneaded into the support per se. Alternatively, the support is designed in a multiple layer structure and the infrared ray absorbing dye is contained in the upper or lower layer, whereby the support is manufactured by coextrusion. It is preferably manufactured by using the coating layer containing the infrared ray dye formed on the support provided with the subbing layer of the present invention.

The typical example of the dye capable of absorbing the infrared ray is provided by an organic dye. The infrared ray absorbing dye of the present invention is an organic dye capable of absorbing in the infrared range (800-1100 nm), preferably the organic dye wherein major absorption is carried out in the infrared range, throughout both the visible and infrared range. Any dye can be used if absorption is carried out in the infrared range (800-1100 nm), practically without absorption in the visible area. Among others, it is preferred to use the thiopylium squalium dye, thiopylium croconium dye, pyrylium squalium dye or pyrylium croconium dye wherein any absorption hardly is performed in the visible area without yellowing caused by decompositions.

The compound having a squalium nucleus is one containing 1-cyclobutene-2-hydroxy-4-one in the molecular structure. The compound containing a croconium nucleus is one containing 1-cyclopentene-2-hydroxy-4,5-dione in the molecular structure. Here the hydroxy group can be dissociated.

Among the foregoing thiopyrylium squarylium dye, thiopyrylium croconium dye, pyrylium squarylium dye and pyrylium croconium dye, a compound expressed by Formula (1) and a compound expressed by Formula (2) described in Japanese Patent O.P.I. Publication No. 2001-194522 are particularly provided. The compounds described in paragraphs [0046]-[0048] and [0054]-[0056] of Japanese Patent O.P.I. Publication No. 2001-194522 are specifically provided.

An optical film of the present invention having a thickness of 50-300 μm is preferably employed as usage.

Though the amount of consuming an infrared absorption dye depending on types of compounds and use conditions can not be completely limited, it is preferred that an optical film per m² is 0.01-2 g.

Further in the present invention, it is preferred that a plasticizer is added into portions containing infrared absorption dyes to improve infrared absorption dye stability, together with improved adhesion.

Phosphoric acid ester or carboxylic acid ester is preferably employed as a plasticizer. Examples of the phosphoric acid ester include triphenyl phosphate (TPP), tricresyl phosphate (TCP), biphenyl-diphenyl phosphate and dimethylethyl phosphate. Typical examples of the carboxylic acid ester include phthalic acid ester and citrate ester. Examples of the phthalic acid ester include dimethyl phthalate (DMP), diethyl phthalate (DEP), dibutyl phthalate (DBP), dioctyl phthalate. (DOP), diethylhexyl phthalate (DEHP) and ethylphthalylethyl glycolate. Acetyltriethyl citrate (OACTE) or acetyltributyl citrate (OACTB) is usable as the citrate ester. Examples of the other carboxylic acid ester include butyl oleate, methylacetyl ricinoleate, dibutyl sebacate and various trimellitate esters. Phthalic acid ester based plasticizers (DMP, DEP, DBP, DOP and DEHP) are preferably usable, but these are not limited thereto.

An addition amount of the plasticizer with 1-20% by weight is added into a film, and preferably with 2-15% by weight.

Further, a plasticizer having a freezing point of at most 25° C. gives plasticity to the film, assisting solubility of infrared absorption dyes.

A optical film exhibiting improved durability can be obtained by containing a UV absorbent in the optical film of the present invention. In other word, more stable absorption effects can be maintained for a long duration by containing a UV absorbent in a layer containing an infrared absorption dye. In the case of a film having a double layer structure, one layer may contain an infrared absorption dye, and the other may contain a UV absorbent. In the case of a film having a structure of at least 3 layers, an infrared absorption dye, or an infrared absorption dye and a UV absorbent is/are contained in a film, but it is preferable to contain a UV absorbent in at least one superficial layer. It is more preferable to contain a UV absorbent in the superficial layers of both surfaces.

Examples of useful UV absorbents usable in the present invention include salicylic acid derivative (UV-1), benzophenone derivative (UV-2), benzotriazole derivative (UV-3), acrylonitrile derivative (UV-4), benzoic acid derivative (UV-5) and organic metal complex salt (UV-6). As (UV-1), phenyl salicylate and 4-t-chill phenyl salicylic acid are provided. As (DV-2), 2-dihydroxybenzophenone and 2-hydroxy-4-methoxybenzophenone are provided. As (UV-3), 2-(2′-hydroxy-5′-methylphenyl)- Benzotriazole and 2-(2′-hydroxy 3′-5′-di-butylphenyl)-5-chlorobenzotriazole are provided. As (UV-4), 2-ethylhexyl-2-cyano-3,3′-diphenylacrylate and methyl-α-cyano-β-(p-methoxyphenyl) acrylate are provided. As (UV-5), resorcinol-monobenzoate and 2′,4′-di-t-butylphenyl-3, 5-t-butyl-4-hydroxybenzoate are provided. As (UV-6), nickelbis-octylphenyl sulphamide and nickel salt of ethyl-3, 5-di-t-butyl-4-hydroxybenzyl phosphoric acid are provided.

A benzotriazole based UV absorbent and a benzophenone based UV absorbent which are highly transparent, and avoid degradation in quality of polarizing plates, liquid crystal elements, and plasma displays are preferable, but the benzotriazole based UV absorbent is particularly preferable in view of less undesired coloring.

Matting agent particles can be added into an optical film of the present invention to provide a slip property of the surface. The following inorganic and/or organic particles can be employed singly or in combination.

Examples of the inorganic particles include silicon oxide, titanium oxide, aluminium oxide, aluminium hydroxide, tin oxide, zinc oxide, calcium carbonate, barium sulfate, talc, kaolin and calcium sulfate, and examples of the organic particles include organic particles, acryl resin, organic silicone resin, Polystyrene, urea resin, formaldehyde condensation product, poly methacrylic acid methyl acrylate resin, acrylic styrene resin, polymethyl methacrylate resin, silicone based resin, polystyrene based resin, polycarbonate resin, benzoguanamine based resin, melamine based resin, polyolefin based resin, polyester based resin, polyamide based resin, polyimide based resin and polyfluoroethylene based resin, but these are not limited thereto.

In the present invention, Silicon dioxide particle available on the market include, for example, AEROSIL R972, R972V, R974, R812, 200, 300, R202, OX50 and TT600, produced by Nippon Aerosil Co. Ltd.

In the present invention, zirconium oxide particles available on the market include, for example, AEROSIL R976 and R811 produced by Nippon Aerosil Co. Ltd.

As an organic compound, a polymer made of a silicone resin, a fluorine-contained resin or an acryl resin is preferable of these, a silicone resin is particularly preferable.

Regarding the above-described silicone resin, particularly three dimensionally networked silicone resin is preferably used. Examples of the silicone resins available on the market include TOSPERL 103, 105, 108, 120, 145, 3120 and 240, produced by Toshiba Silicone Co., Ltd.

This particle powder having a volume average particle diameter of 0.01-0.5 μm is preferably usable. It is desired that the addition ratio is made so as to result in a solid content of 0.01-0.5% by weight.

[Electromagnetic Shielding Film]

The electromagnetic shielding film to which the support provided with the subbing layer of the present-invention can be applied is exemplified by the electromagnetic shielding film for plasma display described in Japanese Patent O.P.I. Publication No. 11-340682, Japanese Patent O.P.I. Publication No. 2001-053488, Japanese Patent O.P.I. Publication No. 2003-046293, Japanese Patent O.P.I. Publication No. 2004-221564, Japanese Patent O.P.I. Publication No. 2004-221565, and Japanese Patent O.P.I. Publication No. 2005-101554. The following describes the details of the electromagnetic shielding film used in the present invention:

[Layer Containing Silver Salt]

In the present invention, the layer containing a silver salt (silver salt-containing layer) as an optical sensor is formed on the support. In addition to the silver salt, a binder, solvent and others can be contained in the silver salt-containing layer.

<Silver Salt>

The silver salt used in the present invention is exemplified by the inorganic silver salt such as silver halide, and organic silver salt such as silver acetate. The silver halide characterized by excellent features as an optical sensor is preferably utilized.

The following describes the silver halide preferably used in the present invention:

Silver halide is used in the present invention to ensure execution of the functions as an optical sensor. The technology on silver halide used in the field of the silver salt photographic film, photographic paper, printing and prepress film and emulsion mask for photo mask can be used directly in the present invention.

Any one of chlorine, bromine and fluorine can be used as the halogen element contained in the silver halide. Alternatively, a combination thereof can also be used. For example, silver halide mainly made up of AgCl, AgBr and AgI is preferably used. The silver halide mainly formed of AgBr is preferably used as well.

The “silver halide mainly made up of AgBr (silver bromide)” in the sense in which it is used here refers to the silver halide wherein the molar fraction of the bromide ion contained in the silver halide composition is 50% or more. The silver halide particle mainly formed of AgBr may contain iodide ion and chloride ion in addition to the bromide ion,

Silver halide is a solid particle. From the viewpoint of image quality of the pattern-like metallic silver layer formed subsequent to exposure and development process, the average particle size of the silver halide is preferably 0.1-1000 nm (1 μm) in terms of spherical diameter, more preferably 0.1-100 nm, still more preferably 1-50 nm. The spherical diameter of the silver halide particle refers to the diameter of a particle having the same volume as that of the spherical particle.

There is no restriction to the shape of the silver halide particle. For example, the silver halide particle may be formed as a sphere, cube, flat plate (e.g. hexagonal, triangular and rectangular flat plates), octahedron or tetrakaidekahedron,

The silver halide used in the present invention can contain still other elements. For example, it is also advantageous to dope the metal ion used to get the high-contract emulsion in the photographic emulsion. Especially, such a transition metal ion as a rhodium ion and iridium ion is characterized by a marked difference between the exposed portion and the unexposed portion at the time of generating the metallic silver image, and therefore is preferably used. The transition metal ion represented by a rhodium ion and iridium ion can be a compound containing various types of ligand. Such a ligand is exemplified by cyanide ion, halogen ion, thiocyanate ion, nitrosyl ion, water and hydroxide ion. To put it more specifically, the compound is exemplified by K₃Rh₂Br₉ and K₂IrCl₆.

In the present invention, the percentage of the rhodium compound and/or iridium compound contained in the silver halide is preferably 10⁻¹⁰−-10⁻² mol/mol Ag with respect to the number of moles of the silver of the silver halide, preferably 10⁻⁹-10⁻³ mol/mol Ag.

In the present invention, to improve the sensitivity as the optical sensor, chemical sensitization performed for photographic emulsion can be provided. For example, precious metal sensitization such as gold sensitization, chalcogen sensitization such as sulfur sensitization, reduction sensitization or the like can be used as chemical sensitization.

For example, emulsion for color negative film described in Japanese Patent O.P.I. Publication No. 11-305396, Japanese Patent O.P.I. Publication No. 2000-321698, Japanese Patent O.P.I. Publication No. 13-281815 and Japanese Patent O.P.I. Publication No. 2002-72429, emulsion for color reversal film described in Japanese Patent O.P.I. Publication No. 2002-214731, and emulsion for color photographic paper described in Japanese Patent O.P.I. Publication No. 2002-107865 can be used preferably as the emulsion that can be used in the present invention.

<Binder>

In the silver salt-containing layer of the present invention, the binder can be used to assist uniform dispersion of the silver salt particle and close adhesion between the silver salt-containing layer and the support. In the present invention, any of the non-water soluble polymer and water soluble polymer can be used as a binder. Use of the water soluble polymer is preferred.

The binder is exemplified by polysaccharides such as gelatine, polyvinyl alcohol (PVA), polyvinyl pyrrolidone (PVP), starch, cellulose and derivatives thereof, polyethylene oxide, polyvinyl amine, chitosan, polylysine, polyacrylic acid, polyalginic acid, polyhyaluronic acid and carboxy cellulose. They assume the properties of neutral, negative or positive ion, depending on the ion performance of the functional group.

There is no restriction to the amount of the binder contained in the silver salt-containing layer of the present invention. The amount of the binder can be determined as appropriate, without deteriorating the dispersibility and adhesion. The amount of the binder contained in the silver salt-containing layer is preferably ¼-100 in terms of the volume ratio of Ag/binder, more preferably ⅓-10, still more preferably ½-2, most preferably 1/1-2. If the amount of the binder contained in the silver salt-containing layer is ¼ or more in terms of the volume ratio of Ag/binder, easy contact between metal particles will be ensured in the physical development and/or plating process, and a high degree of conductivity will be provided. This arrangement is preferred.

<Solvent>

There is no restriction to the solvent used in the silver salt-containing layer of the present invention. The solution is exemplified by water, organic solvent (e.g. alcohol such as methanol, ketone such as acetone, amide such as formamide, sulfoxide such as dimethylsulfoxide, ester such as ethyl acetate, and ether), ionic solution and mixture solvent thereof.

The amount of solvent used in the silver salt-containing layer of the present invention is preferably within the range of 30-90% by weight with respect to the total weight of the silver salt, binder and others contained in the aforementioned silver-containing layer, more preferably within the range of 50-80% by weight.

[Exposure]

In the present invention, the silver salt-containing layer formed on the support is subjected to exposure. Electromagnetic wave can be used for exposure. The electromagnetic wave is exemplified by light such as visible light and ultraviolet light, and radiation ray such as X-ray. Further, a light source provided with wavelength distribution can be used for exposure. A light source having a specific wavelength can also be used.

Scanning exposure using the cathode ray tube (CRT) and various types of laser beam can be used as the aforementioned light source. To provide pattern-like exposure of the silver salt-containing layer, the method of surface exposure based on photo mask can be used. Alternatively, the method of scanning exposure by laser beam can be used. In this case, refractive exposure using a lens or reflection exposure using a reflecting mirror can be utilized. Further, contact exposure, proximity exposure, reduced projection exposure, or reflected projection exposure can be employed.

[Development Process]

In the present invention, after the silver salt-containing layer has been exposed, development process is further carried out. Development process is performed based on the conventional development technology used for silver salt photographic film, photographic paper, printing and prepress film, and emulsion mask for photo mask. There is no restriction to the type of developer to be used. The PQ developer, MQ developer and MAA developer can be used. For example, it is possible to employ the CN-16, CR-56, CP45X, FD-3 and Papitol by Fuji Photo Film Co., Ltd., and a developer such as C-41, E-6, RA-4, D-19 and D-72 by KODAK, or a developer contained in the kit thereof can also be used. Further, the lithdeveloper such as D-85 can be utilized.

In the present invention, the aforementioned exposure and development process allows the metallic silver portion, preferably the pattern-like metallic silver portion to be formed. At the same time, the transparent section to be described later is formed.

The development process in the present invention can include the process of fixing which is carried out to remove the silver salt for the unexposed portion and to ensure stabilization. The process of fixing in the present invention can be performed based on the fixing technology used for the silver salt photographic film, photographic paper, printing and prepress film, and emulsion mask for photo mask.

[Physical Development and Plating]

In the present invention, in order to provide conductivity to the metallic silver portion formed by the aforementioned exposure and development, physical development and/or plating process is performed in such a way that the aforementioned metallic silver portion carries conductive metal particles. In the present invention, only the physical development or plating process ensures that the conductive metal particles are carried by the metallic portion. A combination of physical development and plating process ensures that conductive metal particles are carried by the metallic silver portion.

The “physical development” in the present invention signifies that the metal ion such as silver ion is deposited on the nucleus of the metal and metallic compound through reduction by the reducing agent. This physical phenomenon is utilized for instant B & W film, instant slide film, and printing and prepressing. This technology can be used in the present invention.

Physical development can be performed simultaneously with development subsequent to exposure, or separately subsequent to development.

In the present invention, the process of plating can be performed according to the electroless plating method (chemical reduction plating and substitution plating), the electrolytic plating method, or a combination of both methods. The commonly known electroless plating technology can be used to perform electroless plating in the present invention. For example, it is possible to use the electroless plating technology practiced in the field of a printed circuit board. The electroless copper plating method is preferably used as electroless plating.

The chemical species contained in the electroless copper plating solution is exemplified by copper sulfide and copper chloride, the reducing agent by formalin and glyoxyl acid, and the copper ligand by EDTA and triethanol amine. Further, the additive for improving the stabilization of the bath and the smoothness of the plating membrane is exemplified by polyethylene glycol, yellow prussiate of potash and bipyridine. The electrolytic copper plating bath is exemplified by copper sulfate bath and copper pyrophosphate bath.

The process of plating in the present invention can be performed at a slow rate. It is also possible to make the process of plating at high rate of 5 μm/hour or over. In the process of plating, various types of additives such as a ligand exemplified by EDTA can be used to increase the stabilization of the plating solution.

[Oxidation Treatment]

In the present invention, the metallic silver portion subsequent to development, and the conductive metallic section formed subsequent to physical development and/or plating are preferably subjected to oxidation treatment. Oxidation treatment removes this metal, for example, when a slight amount of metal is deposited on the optically transparent section, with the result that the transmittance of the optically transparent section is kept almost 100%.

Oxidation treatment is provided by the commonly known method using various types of oxidizing agents as in the Fe (III) ion treatment. Oxidation treatment can be performed subsequent to exposure and development of the silver salt-containing layer, or subsequent to physical development or plating. Alternatively, it can be performed subsequent to development and physical development or plating.

In the present invention, the metallic silver portion subsequent to exposure and development can be processed by the solution containing Pd. The Pd can be either divalent palladium ion or metal palladium ion. This processing improves the electroless plating or physical development rate.

[Conductive Metallic Section]

The following describes the conductive metallic section of the present invention.

In the conductive metallic section of the present invention, the metallic silver portion formed by the aforementioned exposure and development is treated by physical development or plating. This arrangement allows the aforementioned metallic silver portion to carry the conductive metal particle

The metallic silver is formed on the exposed portion or on the unexposed portion. In the silver salt diffusion transfer (DTR) method based on the physical development nucleus, the metallic silver is formed on the unexposed portion.

In the present invention, to increase transparency, metallic silver is preferably formed on the exposed portion.

In addition to the aforementioned silver, the conductive metal particle to be carried by the aforementioned metallic portion is exemplified by metals such as copper, aluminum, nickel, iron, gold, cobalt, tin, stainless steel, tungsten, chromium, titanium, palladium, platinum, manganese, zinc and rhodium, as well as the alloys formed of the combination thereof. From the viewpoint of conductivity and price, the conductive metal particles are preferably copper, aluminum or nickel particles. Further, when the magnetic field shielding property is to be provided, paramagnetic metal particles are preferably used as conductive metal particles.

In the aforementioned conductive metallic section, to increase the contrast and to prevent the conductive metallic section from being oxidized and discolored with the process of time, the conductive metal particles contained in the conductive metallic section are preferably copper particles. It is further preferred that at least the surface thereof is subjected to black treatment. The black treatment can be performed according to the method used in the field of printed circuit board. For example, black treatment is provided when treated in the aqueous solution of sodium chlorite (31 g/l), sodium hydroxide (15 g/l), trisodium phosphate (12 g/l) at 95° C. for two minutes.

The aforementioned conductive metallic section preferably contains silver of 50% by weight or more with respect to the entire weight of the metal included in the conductive metallic section, more preferably 60% by weight or more. If the percentage of the silver is 50% by weight or more, time taken to perform physical development and/or plating will be cut down, and improved productivity and reduced costs will be ensured.

Further, when copper and palladium are used as the conductive metal particles forming the conductive metallic section, the total weight of silver, copper and palladium is preferably 80% by weight or more with respect to the entire weight of the metal included in the conductive metallic section, more preferably 90% by weight or more.

The conductive metallic section of the present invention carries the conductive metal particle, and

therefore, produces excellent conductivity. Such being the case, the surface resistance of the translucent electromagnetic shielding film (conductive metallic section) of the present invention is preferably 10³ Ω/sq. or less, more preferably 2.5 Ω/sq. or less, still more preferably 1.5 Ω/sq., most preferably 0.1 Ω/sq.

When the conductive metallic section of the present invention is used as a translucent electromagnetic wave shielding material, the conductive metallic section is preferably designed in a geographical graphic made up of a combination of a triangle such as a regular triangle, isosceles triangle and right-angled triangle; a square such as a regular square, rectangle, rhombus, parallelogram and trapezoid; a (regular) n-angled shape such as a (regular) hexagon and (regular) octagon; a circle, a ellipse, and a star shape. The conductive metallic section is further preferably shaped like a mesh made up of the aforementioned geometric configurations. From the viewpoint of EMI shielding properties, a triangular form is most effective. From the viewpoint of the transmittance of the visible light, the aperture and transmittance of the visible light are increased with the “n” of n-angled shape, if the line width is the same (regular form). Thus, the “n” of n-angled shape is preferably greater.

There is no restriction to the shape of the aforementioned conductive metallic section when used for the conductive wiring material. A desired shape can be determined as appropriate in conformity to the intended use.

In the application of the translucent electromagnetic wave shielding material, the line width of the aforementioned conductive metallic section is preferably 20 μm or less, and the line interval is preferably 50 μm or more. The conductive metallic section may has a portion having a line width greater than 20 μm, depending on the purpose of ground connection and others. From the viewpoint of keeping the image less conspicuous, the line width of the conductive metallic section is preferably less than 18 μm, more preferably less than 15 μm, still more preferably less than 14 μm, further more preferably less than 10 μm, most preferably less than 7 μm.

From the viewpoint of the transmittance of visible light, the aperture of the conductive metallic section of the present invention is preferably 85% or more, preferably 90% or more, most preferably 95% or more. The aperture is defined as the percentage of the portion without thin lines forming a mesh relative to the entire area. For example, the aperture of the lattice-shaped mesh of a regular square having a line width of 10 μm and a pitch of 200 μm is 90%.

[Transparent Section]

The “transparent section” of the present invention can be specified as the transparent portion of the translucent electromagnetic shielding film except for the conductive metallic section. As described above, the light transmittance in the transparent section is characterized as follows: The transmittance represented in terms of the minimum value of transmittance in the area having a wavelength of 380-780 nm other than the contribution of the light absorption and reflection of the support is 90% or more, preferably 95% or more, more preferably 97% or more, still more preferably 98% or more, most preferably 99% or more.

From the viewpoint of improving the transmittance, it is preferred that the transparent section of the present invention should have virtually no physical development nucleus. Differently from the conventional silver complex salt diffusion transfer method, the present invention does not require the process of diffusion after dissolve the unexposed silver halide has been diffused and the soluble silver complex compound has been transformed. Thus, it is preferred that transparent section should have practically no physical development nucleus.

The expression “have virtually no physical development nucleus” indicates that the percentage of the presence of physical development nucleus in the transparent section is in the range of 0-5%.

The transparent section of the present invention is formed together with the metallic silver portion by exposure and development of the aforementioned silver salt-containing layer. From the viewpoint of improving the transmittance, it is preferred that the transparent section should be subjected to oxidation treatment subsequent to the aforementioned development, and further subsequent to the physical development or plating.

[Layer Structure of the Translucent Electromagnetic Shielding Film]

The thickness of the support of the translucent electromagnetic shielding film of the present invention is preferably 5 μm -200 μm, still more preferably 30 μm-150 μm. If the thickness is 5-200 μm, a desired transmittance of visible light can be obtained, and handling will be easy.

The thickness of the metallic silver portion arranged on the support prior to physical development and/or plating can be determined as appropriate in conformity to the coating thickness of the silver salt-containing layer coating medium applied to the support. The thickness of the metallic silver portion is preferably 30 μm or less, more preferably 20 μm or less, still more preferably 0.01-9 μm, most preferably 0.05-5 μm. The metallic silver portion is preferably formed like a pattern. The metallic silver portion may have either one layer or two or more layers in a multi-layer structure. When the metallic silver portion is formed like as pattern in a multi-layer structure having two or more layers, different color sensitivity can be provided to ensure photo sensitiveness to the different wavelengths. This arrangement allows a different pattern to be formed in each layer when exposure is applied at different exposure wavelengths. The translucent electromagnetic shielding film containing the pattern-like metallic silver portion of the multi-layer structure formed in this manner can be used as a high-density printed circuit board.

When used as an electromagnetic shielding material of a display, the viewing angle of the display is preferably increased as the thickness of the conductive metallic section is reduced. Further, the conductive wiring material is required to be thinner in order to meet the requirements of higher density. Viewed in this manner, the thickness of the layer made up of the conductive metal carried by the conductive metallic section is preferably less than 9 μm, more preferably at least 0.1 μm and less than 5 μm, still more preferably at least 0.1 μm and less than 3 μm.

[Other Optical Films]

Specific examples of other optical films to which the support provided with the subbing layer of the present invention are the anti-glare films described in Japanese Patent O.P.I. Publication No. 2004-306328, Japanese Patent O.P.I. Publication No. 2004-333976, Japanese Patent O.P.I. Publication No. 2005-47283, Japanese Patent O.P.I. Publication No. 2005-84113, and the films for cathode ray tube disclosed in Japanese Patent O.P.I. Publication No. 10-119215.

[Light Diffusion Film]

The specific examples of the light diffusion film using the support arranged on the subbing layer of the present invention are the light diffusion films used for the backlight unit for liquid crystal display disclosed Japanese Patent O.P.I. Publication No. 2005-17920, Japanese Patent O.P.I. Publication No. 2005-77448, Japanese Patent O.P.I. Publication No. 2005-31379, Japanese Patent O.P.I. Publication No. 2005-107108, Japanese Patent O.P.I. Publication No. 2005-148328, Japanese Patent O.P.I. Publication No. 2005-189583, Japanese Patent O.P.I. Publication No. 2005-241919, WO2003/032074, Utility Model Publication Laid-Open NO. 1994-008561, Utility Model Gazette 2599445, Utility Model Gazette 2579215, Utility Model Gazette 2570776, Utility Model Gazette 2539495, Utility Model Gazette 2539492, Utility Model Gazette 2539491, Utility Model Gazette 2529651 and Utility Model Gazette 2529650.

The following describes the light diffusion film (hereinafter also referred to as “light diffusion sheet”) of the present invention.

In the present invention, a sticking prevention layer is laminated on the rear side of the support (hereinafter referred to as “substrate layer”). This sticking prevention layer has beads in the binder. This binder is preferably formed of the polymer composition containing the substrate polymer, minute inorganic filler and antistatic agent. This arrangement provides the antistatic function on the rear side of the light diffusion sheet as well. This results in a substantial reduction of the aforementioned problems caused by static electricity.

A cation based antistatic agent is preferably used as the aforementioned antistatic agent. A high degree of antistatic function is provided by dispersion of this cation based antistatic agent in the binder of the light diffusion layer. This arrangement improves and maintains the stabilization of the dispersion of the minute inorganic filler in the binder. Thus, use of the cation based antistatic agent enhances the stability of the dispersion of the minute inorganic filler, and hence ensures further improvement of the heat resistance of the light diffusion sheet and discourages the aforementioned flexure due to heat.

The amount of the aforementioned antistatic agent to be blended relative to 100 parts of the substrate polymer is preferably three parts or more without exceeding 45 parts in terms of solids. When the blending ratio of the antistatic agent is kept within the aforementioned range, the aforementioned antistatic function will be carried out effectively, and the minute inorganic filler will exhibit excellent dispersion and stability. This will solve the problem involving the reduction of light transmittance of all rays or the strength resulting from blending of the antistatic agent.

The minute inorganic filler to the surface of which the organic polymer is fixed is preferably used as the aforementioned minute inorganic filler. The aforementioned “fix” does not signify mere adhesion or sticking. It means a chemical bondage having occurred between the organic polymer and minute inorganic filler. Thus, organic polymer is not detected in the washing solution used to wash the minute inorganic filler with a given solvent. As described above, use of the minute inorganic filler with the organic polymer fixed to the surface thereof provides excellent affinity to the substrate polymer constituting the binder. This makes it possible to form a light diffusion layer characterized by excellent film properties such as surface hardness, heat resistance, wear resistance, weathering resistance and resistance to contamination.

Acryl polyol or polyester polyol is preferably used as the aforementioned substrate polymer. As described above, if acryl polyol or polyester polyol is preferably used as the substrate polymer of the light diffusion layer binder, a high degree of transparency and excellent weathering resistance and processability are provided. In addition, easy dispersion and inclusion of the minute inorganic filler in the binder is ensured. Thus, this method increases the light transmittance of this light diffusion sheet and reduces the possibility of yellowing and deterioration due to ultraviolet rays.

Further, the polyol containing a cycloalkyl group is preferably used as the aforementioned substrate polymer. Use of the polyol containing a cycloalkyl group enhances the hydrophobicity (water repellency and water resistance) of the binder. When used under the conditions of high temperature and high humidity, flexure resistance and dimensional stability of this light diffusion sheet are improved. This will also improve the basic performances of the coating film such as hardness of the light diffusion layer, weathering resistance, needed thickness and solvent resistance. The affinity with the minute inorganic filler to the surface of which the organic polymer is fixed will be further improved. Further, uniform dispersibillity of the minute inorganic filler will be enhanced.

Such being the case, if this light diffusion sheet is arranged in the backlight unit for the liquid crystal display that disperses the a beam of light coming from the lamp and leads it to the surface side, as described above, flexure caused by the heat of the light diffusion sheet can be reduced, and uneven brightness of the liquid crystal display or reduction in brightness can be avoided. Further, since this arrangement prevents electrostatic charge, adsorption of the dust and other sheets is avoided and easy handling in manufacturing is ensured.

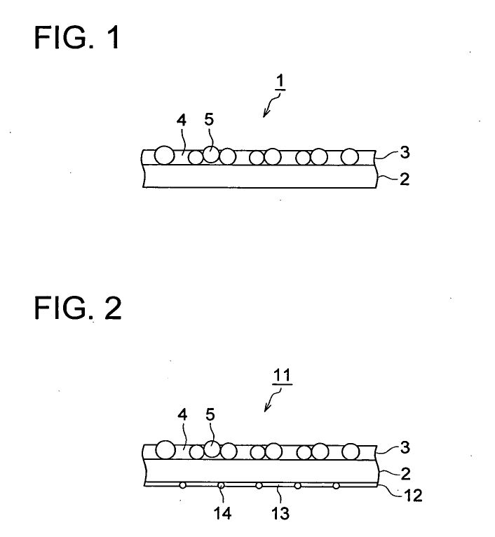

The following describes the embodiments of the light diffusion sheet of the present invention with reference to the drawings wherever required. FIG. 1 is a schematic cross-sectional view showing the light diffusion sheet as an embodiment of the present invention. FIG. 2 is a schematic cross-sectional view showing the light diffusion sheet different from that of FIG. 1.

The light diffusion sheet 1 of FIG. 1 is made up of substrate layer 2 and light diffusion layer 3 laminated on the surface of substrate layer 2.

Substrate layer 2 is required to allow passage of light, and is therefore formed of a transparent—particularly, colorless transparent—synthetic resin. There is no restriction to the synthetic resin used for such substrate layer 2. For example, polyethylene terephthalate, polyethylene naphthalate, acryl resin, polycarbonate, polystyrene, polyolefin, cellulose acetate, and weatherable polyvinyl chloride can be used. Among them, polyethylene terephthalate characterized by excellent transparency and strength is preferably used. Use of the polyethylene terephthalate characterized by improved flexure performance is particularly preferred.

No restriction is imposed on the thickness (average thickness) of the substrate layer 2. For example, the thickness is at least 10 μm and at most 500 μm, preferably at least 35 μm and at most 250 μm, more preferably at least 50 μm and at most 188 μm. If the thickness of substrate layer 2 is below the aforementioned range, curl tends to occur and handling difficulties arise when the resin composition for forming light diffusion layer 3 is coated. Conversely, if the thickness of substrate layer 2 has exceeded the aforementioned range, the brightness of the liquid crystal display is reduced. Further, the thickness of the backlight unit is increased. This runs counter to the requirement for a thinner liquid crystal display.

Light diffusion layer 3 is provided with binder 4 and light diffusion agent 5 contained in binder 4. In this manner, inclusion of light diffusion agent 5 in light diffusion layer 3 ensures uniform diffusion of a beam of light passing light diffusion layer 3 from the back side to the front side. Approximately uniform formation of the microscopically roughened structures on the surface of light diffusion layer 3 is provided by light diffusion agent 5. More effective diffusion of light is ensured by the refraction of the lens of the microscopically roughened structures formed on the surface of light diffusion sheet 1. There is no restriction to the average thickness of light diffusion layer 3. For example, the preferably average thickness is roughly at least 1 μm and at most 20 μm.

Light diffusion agent 5 is made up of the particles capable of diffusing beams of light, and is broadly classified into an inorganic filler and an organic filler. The inorganic filler that can be used is specifically exemplified by silica, aluminum hydroxide, aluminum oxide, zinc oxide, barium sulfide, magnesium silicate, and a mixture thereof. The organic filler that can be used is specifically exemplified by acryl resin, acrylonitrile resin, polyurethane, polyvinyl chloride, polystyrene, polyacrylonitrile and polyamide. Among them, the acryl resin characterized by a high degree of transparency is preferably used, and polymethyl methacrylate (PMMA) is used with particular preference.

No particular restriction is imposed on the shape of light diffusion agent 5. For example, light diffusion agent 5 can be spherical, cubic, needle-shaped, rod-shaped, spindle-shaped, plate-shaped, scaly or fibrous. Particularly, a spherical bead characterized by excellent light diffusibility is preferably used.

The lower limit of the average particle diameter of light diffusion agent 5 is preferably 1 μm, more preferably 2 μm, still more preferably 5 μm. The upper limit of the average particle diameter of light diffusion agent 5 is preferably 50 μm, more preferably 20 μm, still more preferably 15 μm. If the average particle diameter of light diffusion agent 5 is below the aforementioned range, the roughened structure on the surface of the light diffusion layer 3 formed by light diffusion agent 5 will be reduced and the light diffusibility required of the light diffusion sheet may not be satisfied. Conversely, if the average particle diameter of light diffusion agent 5 exceeds the aforementioned range, the thickness of light diffusion sheet 1 will be increased and uniform diffusion cannot be achieved.

The lower limit of the amount of light diffusion agent 5 to be blended (the amount in terms of solids, relative to 100 parts of the substrate polymer in the polymer composition as a constituent material of binder 4) is 10 parts, preferably 20 parts, more preferably 50 parts. The upper limit of the amount of the light diffusion agent 5 to be blended is 500 parts, preferably 300 parts, more preferably 200 parts. If the amount of light diffusion agent 5 to be blended is below the aforementioned range, the light diffusibility will be insufficient. Conversely, if the amount of light diffusion agent 5 to be blended is above the aforementioned range, the effect of fixing light diffusion agent 5 in position will deteriorate. In the case of the so-called light diffusion sheet provided on the surface side of the prism sheet, a high degree of light diffusibility is not required, and therefore, the amount of light diffusion agent 5 to be blended is preferably at least 10 parts and at most 40 parts, more preferably at least 10 parts and at most 30 parts.

Binder 4 is made of the polymer composition including the substrate polymer, minute inorganic filler and antistatic agent. It is formed by crosslinking and curing of this polymer composition. This polymer composition can be further blended with the curing agent, plasticizer, dispersant, various leveling agents, ultraviolet absorber, anti-oxidizing agent, viscosity modifying agent, lubricant, light stabilizer, and others. In binder 4, light diffusion agent 5 is arranged and fixed at an approximate isodensity on the entire surface of the substrate layer 2 through the substrate polymer as a major constituent.

There is no restriction to the aforementioned substrate polymer. For example, acryl based resin, polyurethane, polyester, fluorine resin, silicone resin, polyamideimide, epoxy resin and UV curable resin can be used. One or two types of these polymers can be blended. The polyol, characterized by processability, capable of easily forming light diffusion layer 3 using a coating device or the like is preferably used as the aforementioned substrate polymer. The substrate polymer used in binder 4 is required to allow passage of a beam of light and is therefore transparent. A colorless transparent polymer is preferably used.

Polyol prepared by polymerizing a monomer component containing a hydroxyl group-containing unsaturated monomer, a monomer component and polyester polyol obtained in the hydroxyl group excess condition, for example, can be provided as the above polyol. These may be used singly or used by mixing at least two kinds.

As this hydroxyl group-containing unsaturated monomer, provided are (a) hydroxyl group-containing unsaturated monomer such as acrylic acid 2-hydroxyethyl, acrylic acid 2-hydroxypropyl, methacrylic acid 2-hydroxyethyl, methacrylic acid 2-hydroxypropyl, allyl alcohol, homoallyl alcohol, cinnamyl alcohol or crotonyl alcohol; and (b) hydroxyl group-containing unsaturated monomer prepared via reaction of a divalent alcohol or an epoxy compound [ethylene glycol, ethylene oxide, propylene glycol, propylene oxide, butylene glycol, butylene oxide, 1,4-bis (hydroxymethyl) cyclohexane, phenyl glycidyl ether, glycidyl decanoate and PLACCEL FM-1 produced by Daicel Chemical Industries, Ltd.] with an unsaturated carboxylic acid (acrylic acid, methacrylic acid, maleic acid, fumaric acid, crotonic acid, and itaconic acid). Polyol can be manufactured by polymerizing one kind or at least two kinds selected from these hydroxyl group-containing unsaturated monomers.

Polyol can also be manufactured by polymerizing one kind or at least two kinds of ethylenic unsaturated monomers selected from ethyl acrylate, acrylic acid n-propyl, acrylic acid isopropyl, n-butyl acrylate, acrylic acid tert-butyl, acrylic acid ethylhexyl, ethyl methacrylate, methacrylic acid n-propyl, methacrylic acid isopropyl, methacrylic acid n-butyl, methacrylic acid tert-butyl, methacrylic acid ethylhexyl, glycidyl methacrylate, cyclohexyl methacrylate, Styrene, vinyltoluene, 1-methylstyrene, acrylic acid, methacrylic acid, acrylonirile, vinyl acetate, vinyl propionate, vinyl stearate, acetic acid allyl, adipic acid diallyl, itaconic acid diallyl, diethyl maleate, vinyl chloride, vinylidene chloride, acrylamide, N-methylolacrylamide, N-butoxymethyl acrylamide, diacetone acrylamide, ethylene, propylene and isoprene; and hydroxyl group-containing unsaturated monomers selected from the foregoing (a) and (b).

The number average molecular weight of polyol prepared by polymerizing the monomer component containing the hydroxyl group-containing unsaturated monomer is 1000-500000, and preferably 5000-100000. Further, the hydroxyl value is 5-300, preferably 10-200, and more preferably 20-150.

Polyester polyol prepared in the hydroxyl group excess condition can be manufactured via reaction under the condition that the hydroxyl group number in polyhydric alcohol is larger than the carboxyl group number of polybasic acid. Examples of the foregoing polyhydric alcohol include ethylene glycol, diethylene glycol, propylene glycol, dipropylene glycol, 1,3-butanediol, 1,4-butanediol, 1,5-pentanediol, neopentylglycol, hexamethylene glycol, decamethylene glycol, 2,2,4-trimethyl-1,3-pentane diol, trimethylol propane, hexane triol, glycerin, pentaerythritol, cyclohexane diol, hydrogenated bisphenol A, bis (hydroxymethyl) cyclohexane, hydroquinonebis(hydroxyethyl ether), tris(hydroxyethyl)isocynurate, xylylene glycol, polyhydric alcohol, maleic acid, fumaric acid, succinic acid, adipic acid, sebacic acid, azelaic acid, and trimellitic acid, terephthalic acid, phthalic acid, isophthalic acid, polybasic acid, propanediol, hexane diol, polyethylene glycol and trimethylol propane.

The number average molecular weight of polyester polyol prepared in the hydroxyl excess condition is 500-300000, and preferably 2000-100000. Further, the hydroxyl value is 5-300, preferably 10-200, and more preferably 20-150.

The polyol used as the substrate polymer of the polymer composition is obtained by polymerization of the aforementioned polyester polyol and monomer components containing the aforementioned unsaturated monomer further containing the hydroxyl group. The acryl polyol containing the (meth)acryl unit or the like is preferably used. The binder 4 using the aforementioned polyester polyol or acryl polyol as a substrate polymer is characterized by excellent weathering resistance, and prevents the light diffusion layer 3 from becoming yellow. This polyester polyol and/or acryl polyol may be used.

There is no restriction to the number of the hydroxyl groups in the aforementioned polyester polyol and acryl polyol if it is two or more for each molecule. If the hydroxyl group value in the solid is 10 or less, the number of the crosslinking points will be reduced, and membrane properties such as solvent resistance, water resistance, heat resistance and surface hardness will be impaired.

When the polyol is used as the substrate polymer as described above, one of hexamethylene diisocyanate, isochlorofluorocarbon diisocyanate and xylene diisocyanate, or a mixture of two or more of them is preferably used as the curing agent mixed in the polymer composition. Use of these curing agents increases the rate of polymer composition curing reaction. Accordingly, even if the cation based agent contributing to the stabilization of the minute inorganic filler dispersion is used as an antistatic agent, reduction of curing reaction rate due to the cation based antistatic agent can be offset sufficiently. Improvement of the curing reaction rate contributes to uniform dispersibillity of the minute inorganic filler in the binder. This arrangement allows the light diffusion sheet to be subjected to a drastic reduction in the flexure and yellowing due to heat and ultraviolet rays.

No restriction is imposed on the inorganic substance constituting the minute inorganic filler. An inorganic oxide is preferably used. This inorganic oxide can be defined as various types of oxygen-containing metallic compound wherein metallic elements constitute a 3D network through combination mainly with the oxygen atom. The elements selected from the Groups 2 through 6 in the periodic table of elements are preferably used as the metallic elements constituting the inorganic oxide. The elements selected from the Groups 3 through 5 are used more preferably. Among them, the element selected from Si, Al, Ti and Zr is preferred in particular. The colloidal silica as a metallic element Si is most preferred as the minute inorganic filler. The shape of the minute inorganic filler can be spherical, needle-shaped, plate-shaped, scaly or crushed. No restriction is imposed on the choice of the shape.

The lower limit of the average particle diameter of the minute inorganic filler is preferably 5 nm, and 10 nm is particularly preferred. In the meantime, the upper limit of the average particle diameter of the minute inorganic filler is preferably 50 nm, and 25 nm is particularly preferred. If the average particle diameter of the minute inorganic filler is below the aforementioned range, the surface energy of the minute inorganic filler will increase and coagulation tends to occur. Conversely, if the average particle diameter exceeds the aforementioned range, the minute inorganic filler becomes milky-white under the influence of short wavelength, the result is that the minute inorganic filler cannot fully maintain the transparency of light diffusion sheet 1.

The lower limit of the amount of the minute inorganic filler to be blended (the amount of only the inorganic components) relative to 100 parts of the substrate polymer is preferably 10 parts in terms of solids, more preferably 50 parts. In the meantime, the upper limit of the aforementioned amount of the minute inorganic filler is preferably 500 parts in terms of solids, more preferably 200 parts. If the mount of the minute inorganic filler to be blended is below the aforementioned range, the heat resistance of light diffusion sheet 1 may not be utilized sufficiently. Conversely, if the mount of the minute inorganic filler to be blended has exceeded the aforementioned range, blending into the polymer composition will be discouraged and the light transmittance of the light diffusion layer 3 can be impaired.

The minute inorganic filler to be used is preferably the one on the surface of which the organic polymer is fixed. Use of the aforementioned minute inorganic filler with the organic polymer fixed thereon improves the dispersibillity in the binder 4 and affinity with binder 4. No restriction is imposed on the molecular weight, shape, composition and functional group of this organic polymer. A desired organic polymer can be used. Further, the organic polymer of any shape can be utilized; it can be straight chained, branched or crosslinked.

The specific resin constituting the aforementioned organic polymer is exemplified by polyolefin such as (meth)acryl resin, polystyrene, polyvinyl acetate, polyethylene and polypropylene; polyester such as polyvinyl chloride, polyvinylidene chloride and polyethylene terephthalate; the copolymer thereof; and the resin wherein the functional group such as amino group, epoxy group, hydroxyl group and carboxyl group is partly modified. Among them, the resin wherein the organic polymer containing a (meth)acryl unit such as (meth)acryl based resin, (meth)acryl-styrene based resin and (meth)acryl-polyester based resin is an essential component is provided with coating capability, and is preferably utilized. In the meantime, the resin miscible with the substrate polymer of the aforementioned polymer composition is preferably used. Accordingly, the most preferable resin has the same composition as that of the substrate polymer contained in the polymer composition.

The minute inorganic filler may contain an organic polymer in the particles. This arrangement gives adequate softness and touchiness to the inorganic substance as a core of the minute inorganic filler.

The aforementioned organic polymer containing the alkoxy group is preferably utilized. The preferable amount of the alkoxy group contained is at least 0.01 mmol and at most 50 mmol per gram of the minute inorganic filler with the organic polymer fixed thereon. The aforementioned alkoxy group improves the affinity with the matrix resin constituting binder 4 and dispersibillity in the binder 4.

The alkoxy group in the sense in which it is used here refers to the RO group connected to the metallic elements constituting the particle skeleton. The “R” is an alkyl group that can be replaced. RO groups in the particle may be the same or different. The “R” is specifically exemplified by methyl, ethyl, n-propyl, isopropyl and n-butyl. The same metal alkoxy group as that of the metal constituting the minute inorganic filler is preferably used. When the minute inorganic filler is colloidal silica, it is preferred to use the alkoxy group wherein silicon is a metal.

No restriction is imposed on the percentage of the organic polymer in the minute inorganic filler with the organic polymer fixed thereto. The percentage of the organic polymer is preferably at least 0.5% by weight and at most 50% by weight with reference to the minute inorganic filler.

The organic polymer fixed to the minute inorganic filler described above is preferably the one containing a hydroxyl group. It preferably contains at least one of the compound selected from among the multi-function isocyanate compound containing two or more functional groups that reacts with the hydroxyl group in the polymer composition constituting the binder 4, melamine compound and aminoplast resin. This arrangement allows the minute inorganic filler and matrix resin of the binder 4 to be crosslinked, with the result that the storage stability, contamination resistance, flexibility and weathering resistance are improved. Further, the film having been obtained is provided with gloss.

The aforementioned multi-functional isocyanate compound is exemplified by aliphatics, alicyclics, aromatics, other multi-functional isocyanate compounds and the modified compound thereof. The multi-functional isocyanate compound is specifically exemplified by:

a trimer such as the biuret or isocyanurate member of tolylene diisocyanate, xylylene diisocyanate, diphenylmethane diisocyanate, hexamethylene diisocyanate, isophorone diisocyanate, lysine diisocyanate, 2,2,4-trimethylhexylmethane diisocyanate, methylcyclohexane diisocyanate, 1,6-hexamethylene diisocyanate;

the compounds containing two or more remaining isocyanate groups generated by the reaction between these multi-functional isocyanates and polyvalent alcohol such as propane diol, hexanediol, polyethylene glycol and trimethylol propane; and

the blocked multi-functional isocyanate compound wherein these multi-functional isocyanate compounds are blocked by such blocking agents as alcohols such as ethanol and hexanol, the compound containing phenolic hydroxyl group such as phenol and cresol, oximes such as acetone oxime and methyl ethyl ketoxime, and lactams such as ε-caprolactam and γ-caprolactam. One of the aforementioned multi-functional isocyanate compounds or a mixture of two or more of them can be used. Among them, the yellowing-resistant multi-functional isocyanate compound without isocyanate group directly linked with the aromatic ring is preferably used in order to prevent the film from becoming yellow.

The aforementioned melamine compound is exemplified by dimethylol melamine, trimethylol melamine, tetramethylol melamine, pentamethylol melamine, hexamethylol melamine, isobutylether type melamine, n-butylether type melamine and butylated benzoguanamine.

Alkyl etherified melamine resin, urea resin, and benzoguanamine resin can be mentioned as the aforementioned aminoplast resin. One of these aminoplast resins, a mixture of two or more or the co-condensate thereof can be used. The alkyl etherified melamine resin is produced by converting aminotriazine into methylol and applying alkyl etherification thereto using the cyclohexanol or alkanol with a carbon number of 1 through 6. It is typically exemplified by butylether etherified melamine resin, methyletherified melamine resin, and methylbutyl mixed melamine resin. It is possible to use the sulfonic acid based catalyst for promoting the process of curing such as paratoluenesulfonic acid and other amine salt.

The polyol containing cycloalkyl group is preferably used as the aforementioned substrate polymer. When the cycloalkyl group is introduced into the substrate polymer (polyol) constituting binder 4 as described above, the hydrophobicity of binder 4 such as water repellency and water resistance is improved. The flexure resistance and dimensional stability of light diffusion sheet 1 under the conditions of high temperature and high humidity are also improved. This arrangement further improves the basic performances of the coating film such as the hardness of light diffusion layer 3, weathering resistance, needed thickness, and solvent resistance. Besides, the affinity with the minute inorganic filler to the surface of which the organic polymer is fixed is improved. Further, uniform dispersibillity of the minute inorganic filler will be enhanced.

There is no restriction to the aforementioned cycloalkyl group. For example, it is possible to use the cyclobutyl group, cyclopentyl group, cyclohexyl group, cycloheptyl group, cyclooctyl group, cyclononyl group, cyclodesyl group, cycloundesyl group, cyclododesyl group, cyclotridesyl group, cyclotetradesyl group, cyclopentadesyl group, cyclohexadesyl group, cycloheptadesyl group and cyclooctadesyl group.

The polyol having the aforementioned cycloalkyl group can be obtained by copolymerization of the polymerizable unsaturated monomer containing a cycloalkyl group. The polymerizable unsaturated monomer containing the cycloalkyl group is a polymerizable unsaturated monomer that contains at least one cycloalkyl group inside the molecule. No restriction is imposed on this polymerizable unsaturated monomer. For example, cyclohexyl(meth)acrylate, methylcyclohexyl(meth)acrylate, tert-butylcyclohexyl(meth)acrylate and cyclododesyl(meth)acrylate can be mentioned.

No restriction is imposed on the aforementioned antistatic agent, which is exemplified by:

an anionic antistatic agent such as alkyl sulfate and alkyl phosphate;

a cationic antistatic agent such as quaternary ammonium salt and imidazoline compound;

a nonionic antistatic agent such as polyethylene glycol, polyoxyehylene sorbitan monostearic acid ester and ethanol amide; and

a high molecular antistatic agent such as polyacryl acid. Among them, the cationic antistatic agent characterized by greater antistatic effect without impairing the stability of the minute inorganic filler dispersion is preferably utilized. Of the cationic antistatic agents, the ammonium salt characterized by excellent antistatic effect and the function of encouraging the stability of the minute inorganic filler dispersion is most preferably used.

The lower limit of the amount of the aforementioned antistatic agent relative to 100 parts of the substrate polymer (in terms of solids) is preferably 3 parts, is more preferably 5 parts, is most preferably 10 parts. The upper limit of the amount of the aforementioned antistatic agent is preferably 45 parts, is more preferably 40 parts, is most preferably 35 parts. If the amount of the antistatic agent to be blended is below the aforementioned lower limit, the aforementioned antistatic function may not be effectively utilized. Conversely, if the amount of the antistatic agent to be blended exceeds the aforementioned upper limit, this may raise the problem involving the reduction of light transmittance of all rays or the strength resulting from blending of the antistatic agent.

The following describes the method of manufacturing light diffusion sheet 1. Light diffusion sheet 1 can be manufactured by (a) the process of mixing light diffusion agent 5 with the polymer composition constituting binder 4, thereby manufacturing the coating solution for light diffusion layer; and (b) the process of laminating light diffusion layer 3 by applying the coating solution for light diffusion layer on the surface of substrate layer 2.

The heat resistance of light diffusion sheet 1 is improved by the minute inorganic filler almost uniformly dispersed and contained in binder 4, whereby flexure by heat is reduced. Further, the electrostatic charge of light diffusion sheet 1 is reduced, and the problem caused by adsorption of dust is mitigated by the antistatic agent almost uniformly dispersed and contained in binder 4. Further, use of the cationic antistatic agent ensures a high degree of the antistatic effect, and improves and maintains the stability of the dispersion of the minute inorganic filler in binder 4. As a result, the heat resistance of light diffusion sheet 1 is further improved, and reduction of the flexure caused by heat described above is encouraged.

Light diffusion sheet 11 of FIG. 2 is made up of substrate layer 2, light diffusion layer 3 laminated on the surface of substrate layer 2, sticking prevention layer 12 laminated on the back face of the substrate layer 2. Since substrate layer 2 and light diffusion layer 3 are the same as those of the embodiment shown in FIG. 1, they will be assigned with the same numerals, and the description will be omitted. Accordingly, light diffusion sheet 11 improves the heat resistance and antistatic effect, similarly to aforementioned light diffusion sheet 1.

Sticking prevention layer 12 is made up of binder 13 and bead 14 dispersed in binder 13. Binder 13 is also formed by crosslinking and curing the polymer composition similar to that of binder 4 of the aforementioned-light diffusion layer 3 (i.e. polymer composition including the substrate polymer, minute inorganic filler and antistatic agent). Further, the material for bead 14 used is the same as that used in light diffusion agent 5 of light diffusion layer 3. There is no restriction to the thickness of sticking prevention layer 12 (the thickness of 13 parts of binder 13 other than bead 14). For example, the thickness is roughly at least 1 μm and at most 10 μm.

A small number of beads 14 are blended. Beads 14 are separated from one another and are dispersed in binder 13. The lower ends of many of beads 14 are protruded from binder 13 by a small amount. Thus, when light diffusion sheet 11 is laminated on the light guide plate, the protruding lower ends of beads 14 are held in engagement with the front surface of the light guide plate. The entire surface of the back face of light diffusion sheet 11 is not engaged with the light guide plate. This eliminates the possibility of sticking between light diffusion sheet 11 and light guide plate, and mitigates uneven brightness on the screen of the liquid crystal display.

In light diffusion sheet 11, the polymer composition constituting binder 13 of sticking prevention layer 12 also includes the minute inorganic filler. This arrangement further improves the coating properties of light diffusion sheet 11 such as heat resistance, wear resistance, weathering resistance and contamination resistance, and reduces the flexure drastically. Since the polymer composition constituting aforementioned binder 13 also contains the antistatic agent, a further reduction of static electricity can be achieved.

The following describes the methods of manufacturing light diffusion sheet 11: Light diffusion sheet 11 is manufactured by:

(a) mixing light diffusion agent 5 to the polymer composition constituting binder 4, whereby the coating solution for light diffusion layer is produced;

(b) applying the coating solution for light diffusion layer to the surface of substrate layer 2, whereby light diffusion layer 3 is laminated;

(c) mixing beads 14 to the polymer composition constituting binder 13, whereby the coating solution for sticking prevention layer is produced; and

(d) applying the coating solution for sticking prevention layer to the back face of substrate layer 2, whereby sticking prevention layer 12 is laminated.

In a liquid crystal display backlight unit containing a lamp, light guide plate, light diffusion sheet, prism sheet and others wherein the aforementioned backlight unit disperses the light emitted from the lamp and leads it to the front surface, when aforementioned light diffusion sheets 1 and 11 are used, flexure or yellowing does not occur easily even if exposed to the lamp heat or ultraviolet rays from the outside, because light diffusion sheets 1 and 11 have a high degree of coating properties such as heat resistance and weathering resistance. This arrangement mitigates uneven brightness or reduced brightness on the screen of the liquid crystal display. Further, since light diffusion sheets 1 and 11 have a high degree of antistatic function, adsorption of dust to light diffusion sheets 1 and 11 is reduced, and the lamination of light diffusion sheets 1 and 11 and prism sheet is facilitated in the backlight unit manufacturing process, with the result that productivity and handling are improved.

The following describes the details of another preferable light diffusion sheet with reference to drawings:

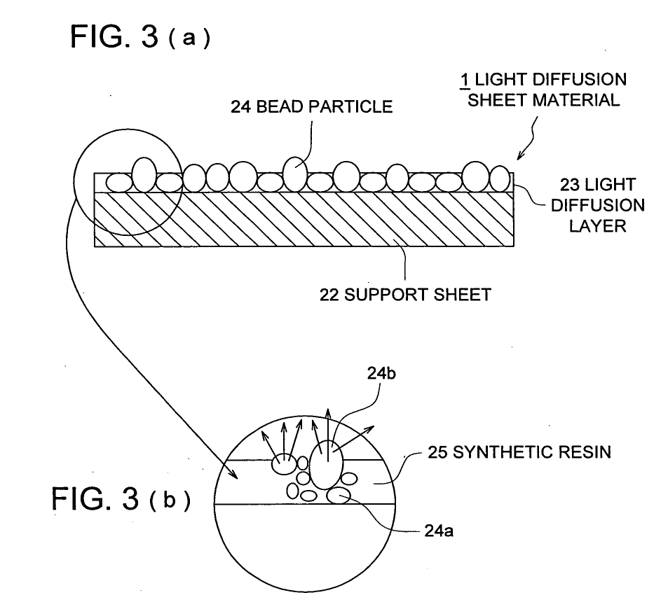

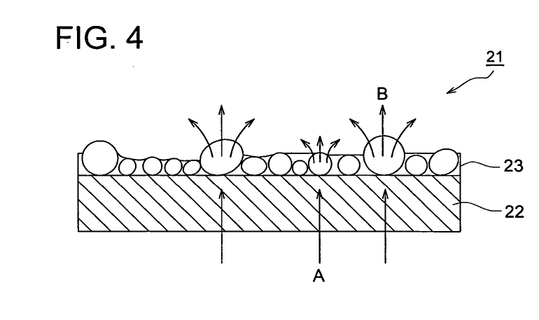

FIG. 3(a) is an enlarged cross-sectional view of the first example of a light diffusion sheet material of the present invention. FIG. 3(b) is a partially enlarged cross-sectional view of FIG. 3(a). In FIG. 4, numeral 21 denotes the light diffusion sheet material of the present invention. Basically, light diffusion sheet material 21 is composed of transparent substrate sheet 22 and light diffusion layer 23 coated thereon.

In this case, a transparent glass substrate and synthetic resin film such as polyethylene terephthalate (PET), polycarbonate (PC) and transparent acryl resin are preferably used as aforementioned substrate sheet 22. The thickness thereof is preferably about 20 μm-300 μm. In addition, any transparent material can be used as a substrate sheet if it is characterized by various properties such as elasticity and durability in conformity to the intended usage and it does not impair the passage of light. A subbing layer is provided on the substrate sheet.

Aforementioned light diffusion layer 23 is formed of synthetic resin 25 of the substrate mixed with bead particle 24 made up of an acryl resin.

When due consideration is given to the light diffusion effect, the amount of bead particle 24 is preferably 30-90% by weight, with reference to the synthetic resin of the substrate. If the amount of this bead particle is below 30% by weight, the light diffusion effect cannot be expected. If it is over 90% by weight, the substrate of bead particle 24 is unsuccessfully fixed on the synthetic resin 25, with the result that bead particles may drop easily.

In this case, the particle size of bead particle 24 is preferably about 1-50 μm from the viewpoint of light diffusion effect. Further, coexistence of two or more beads having different particle sizes is preferred. In addition, the acryl resin of the main agent mixed with bead particles and the two-part curing type resin using the isocyanate based synthetic resin as a curing agent are preferably used as synthetic resin 25 of the substrate, although this depends on the type of the bead particle. The preferred thickness is about 15-20 μm (thickness without including bead particles), from the viewpoint of workability, strength and light diffusion effect. However, material other than the aforementioned materials can be used as the type of the bead particle and the synthetic resin of the substrate, if they are so combined as to provide the expected light diffusion effect. No restriction is imposed on the material. When light diffusion layer 23 mixed with this bead particle is coated on the top surface of substrate sheet 22, a well-known MB (comma) roll coat method or other appropriate method should be selected.

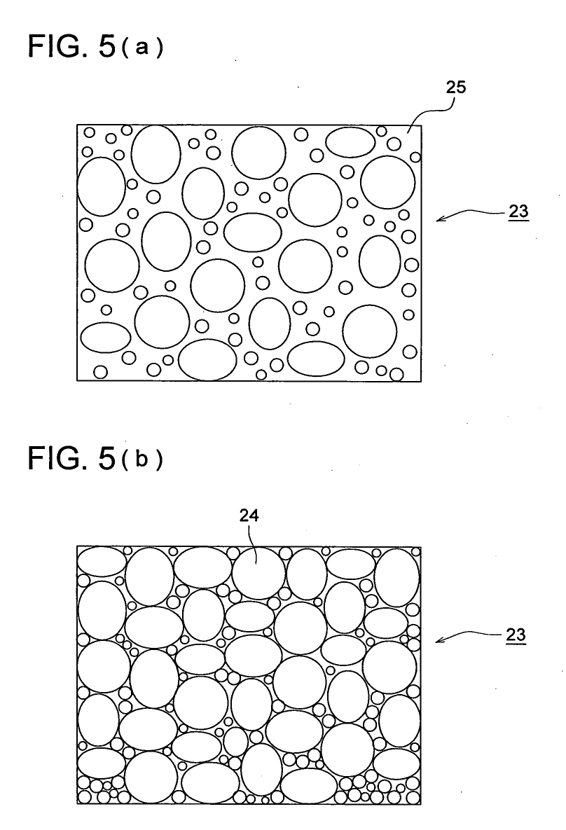

As shown in FIG. 3(b), in aforementioned light diffusion layer 23, particles 24a completely embedded in resin layer 25 inside synthetic resin 25 of the substrate are present together with bead particles 24b partly embedded in resin layer 25 and at least partly protruded from aforementioned resin layer 25. The presence of both of them is essential to ensure uniform dispersion by the presence of these particles when the light having passed through substrate sheet 22 passes through light diffusion layer 23. The percentage of the coexistent particles can be adjusted in response to the percentage of light diffusion, without any restriction imposed thereon. Further, bead particles 24 exhibits two distribution patterns. In one distribution pattern, bead particles 24 are dispersed on the surface of substrate sheet 22, as shown in FIG. 5(a). In another distribution pattern, bead particles 24 are dispersed so as to cover almost the entire surface of substrate sheet 22, as shown in FIG. 5(b). The latter pattern ensures more uniform diffusion of the passing light.

In the light diffusion sheet material formed in the aforementioned manner, light A coming from below substrate sheet 22 of light diffusion sheet material 21 passes through substrate sheet 22, as shown in FIG. 4. Then light passes through the layer wherein particles 24a completely embedded in resin layer 25 inside synthetic resin 25 of the substrate of light diffusion layer 23 are present together with bead particles 24b partly embedded in resin layer 25 and at least partly protruded from aforementioned resin layer 25. The uniform diffusion of the light is ensured by the presence of these particles (see arrow mark B).

### EXAMPLE A

Next, the present invention will now be described in detail referring to examples, however, the present invention is not limited thereto.

<<Preparation of Water-Soluble Polyester Solutions A-1-A-4>>

As described below, aqueous polyester dispersions (refer to Table 1-a regarding types and addition amounts) were prepared (a solid content of 15%).

(Preparation of Water-Soluble Polyester Solution A-1)

A mixture consisting of 35.4 parts by weight of dimethyl terephthalate, 33.63 parts by weight of dimethyl isophthalate, 17.92 parts by weight of dimethyl 5-sufoisophthalate sodium salt, 62 parts by weight of ethylene glycol, 0.065 part by weight of calcium acetate monohydrate, and 0.022 part by weight of manganese acetate underwent transesterification at 170-220° C. under nitrogen gas flow, while distilling methanol away. Thereafter, 0.04 parts by weight of trimethyl phosphate, 0.04 part by weight of antimony trioxide, as a polymerization condensation catalyst, and 6.8 parts by weight of 4-cyclohexanedicarboxylic acid were added and the resulting mixture underwent esterification at a reaction temperature of 220 to 235° C., while the theoretical amount of water was distilled away.

Thereafter, the pressure of the reaction system was reduced over one hour and the temperature was raised. Subsequently, polymerization condensation was conducted at 280° C. and 133 Pa for one hour to prepare water-soluble polyester A-1. The resulting water-soluble polyester A-1 exhibited an intrinsic viscosity of 0.33 (100 ml/g) and Mw of 80,000-100,000.

Subsequently, charged into a 2-liter three-necked flask fitted with a stirring blade, a reflux condenser, and a thermometer was 850 ml of pure water. Subsequently, 150 g of water-soluble polyester A-1 was gradually added, under constant stirring. After stirring without modification at room temperature for 30 minutes, the internal temperature was raised to 98° C. over one and a half hours and eater-soluble polyester A-1 was dissolved over 3 hours while maintaining a temperature at 98° C. After completion of heating, the reaction mixture was cooled to room temperature over one hour and was allowed to stand overnight, whereby a 15% by weight of water-soluble polyester A-1 solution was prepared. A-2 through A-4 were prepared in the same manner as A-1, except that the monomer compositions were changed.

<<Preparation of Water-Soluble Polyester Solution A-5>>

As described below, aqueous polyester dispersions (refer to Table 1-a regarding types and addition amounts) were prepared (a solid content of 15%6).

Charged into a transesterification vessel were a mixture consisting of 70o by mole of dimethyl 2,6-naphthalenedicarrboxylate, 27% by mole of dimethyl isophthalate, 3% by mole of trimellitic anhydride, 95% by mole of ethylene glycol, and 5% by mole of an ethylene oxide addition product (having the chemical structure as shown below and m+n=4 in average value, also described as Surfactant (A)) and further 0.05 part of tetrabutoxy titanium was added. The resulting mixture underwent transesterification reaction under a flow of nitrogen at 230° C. while distilling away methanol.

Subsequently, after adding 0.6 part by weight of Ilganox 1010 (manufactured by CIBA Specialty Chemicals Co., Ltd.) to this reaction system, the resulting mixture was gradually heated to 255° C., and then underwent polymerization condensation under a reduced pressure of 133 kPa, whereby a polyester resin having an intrinsic viscosity of 0.32 was prepared.

Dissolved in 180 parts by weight of tetrahydrofuran was 20 parts by weight of the resulting polyester resin. Subsequently, 180 parts by weight of a 0.4% by weight aqueous triethylamine solution was dripped into the resulting mixture at a high speed stirring of 10,000 rpm, whereby a bluish milky dispersion was obtained. The resulting dispersion was then distilled under a reduced pressure of 2,660 kPa to remove tetrahydrofuran. Thus an aqueous polyester dispersion, having a solid content of 156 by weight, was obtained. 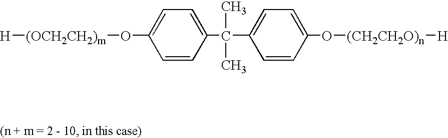
<<Preparation of Water-Soluble Polyester Solution A-6>>

Pesresin A-515GB (modified water-soluble polyester having a Tg of 60° C., manufactured by Takamatsu Yushi Co.) was dissolved in water to obtain a solid content of 15% by weight.

Employed polyster compositions (in % by mole)

TABLE 1-a

| | | | | | | | | | | | Tg |
|---|---|---|---|---|---|---|---|---|---|---|---|
| Component | TA | IA | IPS | CHDA | QA | TMA | EG | DEG | CHDM | BPA | (° C.) |
| A-1 | 40 | 38 | 14 | 8 | | | 100 | | | | 51 |
| A-2 | 40 | 30 | 10 | 20 | | | 70 | | 30 | | 56 |
| A-3 | 50 | 42 | 8 | | | | | 80 | 20 | | 80 |
| A-4 | 40 | 40 | 20 | | | | | 40 | 60 | | 73 |
| A-5 | | 27 | | | 70 | 3 | 95 | | | 5 | 55 |

| | |
|---|---|
| A-6 | Pesresin A-515GB (modified water-soluble |
| | polyester having a Tg of 60° C., manufactured by |
| | Takamatsu Yusi Co.) was adjusted to obtain a |
| | solid content of 15% by weight by adding water. |

TA: dimethyl terephthalate
IA: dimethyl isophthalate
IPS: sodium dimethyl 5-sulfoisophthalate
CHDA: 4-cylcohexanedicarboxyluc acid
QA: 2,6-naphthalenedicarboxylic acid
TMA: trimellitic anhydride
EG: ethylene glycol
DEG: diethylene glycol
CHDM: cyclohexanedimethanol
BPA: bisphenol A ethylene oxide additive product

<<Preparation of Modified Water-Soluble Polyester Solutions B-1-B-7>>
(Preparation of Modified Water-Soluble Polyester Solution B-1)

Charged into a 3-liter four-necked flask fitted with stirring blades, a reflux condenser, a thermometer and a dripping funnel was 1,900 ml of 15% by weight water-soluble polyester solution A-1, and the resulting mixture was heated to 80° C. while stirring. Added to the above mixture was 6.52 ml of 24% aqueous ammonium peroxide, and then over 30 minutes dripped into the resulting mixture was a monomer mixed composition (composed of 28.5 g of glycidyl methacrylate, 21.4 g of ethyl acrylate, and 21.4 g of methyl methacrylate). The resulting mixture underwent reaction for an additional 3 hours. Thereafter, the resulting mixture was cooled to less than or equal to 30° C. and filtered, whereby modified water-soluble polyester solution B-1 having a solid content of 18% by weight was prepared (a vinyl based component modification ratio of 20% by weight).

(Preparation of Modified Water-Soluble Polyester Solution B-2)

Charged into a 3-liter four-necked flask fitted with stirring blades, a reflux condenser, a thermometer and a dripping funnel was 1,900 ml of 15% by weight water-soluble polyester solution A-1, and the resulting mixture was heated to 80° C. while stirring. Added to the above mixture was 6.52 ml of 24% aqueous ammonium peroxide, and then over 30 minutes dripped into the resulting mixture was a monomer mixed composition (composed of 10.7 g of styrene, 28.5 g of glycidyl methacrylate, 21.4 g of ethyl acrylate, and 10.7 g of methyl methacrylate). The resulting mixture underwent reaction for an additional 3 hours. Thereafter, the resulting mixture was cooled to less than or equal to 30 OC and filtered, whereby modified water-soluble polyester solution B-2 having a solid content of 18% by weight was prepared (a vinyl based component modification ratio of 20% by weight).

(Preparation of Modified Water-Soluble Polyester Solution B-3)

Charged into a 3-liter four-necked flask fitted with stirring blades, a reflux condenser, a thermometer and a dripping funnel was 1,900 ml of a 15% by weight water-soluble polyester solution A-2, and the resulting mixture was heated to 80° C. while stirring. Added to the above mixture was 6.52 ml of 24% aqueous ammonium peroxide, and then over 30 minutes dripped into the resulting mixture was a monomer mixed composition (consisting of 28.5 g of styrene, 28.5 g of glycidyl methacrylate, and 14.4 g of acrylamide). The resulting mixture underwent reaction for an additional 3 hours. Thereafter, the resulting mixture was cooled to less than or equal to 30° C. and filtered, whereby modified water-soluble polyester solution B-3 having a solid content of 18% by weight was prepared (a vinyl based component modification ratio of 20% by weight).

(Preparation of Modified Water-Soluble Polyester Solution B-4)

Modified water-soluble polyester solution B-4 was prepared similarly to preparation of modified water-soluble polyester solution B-1, except that the vinyl based component modification ratio was replaced by 8% by weight.

(Preparation of Modified Water-Soluble Polyester Solution B-5)

Modified water-soluble polyester solution B-4 was prepared similarly to preparation of modified water-soluble polyester solutions B-1, except that the vinyl based component modification ratio was replaced by 12% by weight.

(Preparation of Modified Water-Soluble Polyester Solution B-6)

Modified water-soluble polyester solution B-6 was prepared similarly to preparation of modified water-soluble polyester solutions B-1, except that the water-soluble polyester solution was replaced by A-3.

(Preparation of Modified Water-Soluble Polyester Solution B-7)

Modified water-soluble polyester solution B-7 was prepared similarly to preparation of modified water-soluble polyester solutions B-1, except that the water-soluble polyester solution was replaced by A-4.

<<Preparation of Acrylic Polymer latexes C-1-C-4>>

Acrylic polymer latexes C-1-C-4, having the monomer compositions described below, were synthesized employing emulsion polymerization. All the solid contents were adjusted to 30% by weight.

TABLE 2-a

| | | Tg (° C.) |
|---|---|---|
| C-1 | styrene:glycidyl methacrylate:n-butyl | 20 |
| | acrylate = 20:40:40 | |
| C-2 | styrene:n-butyl acrylate:t-butyl acrylate:hydroxyethyl | 55 |
| | methacrylate = 27:10:35:28 | |
| C-3 | styrene:glycidyl methacrylate:acetoacetoxyethyl | 50 |
| | methacrylate = 40:40:20 | |
| C-4 | ethyl acrylate:methyl methacrylate = 50:50 | — |

<<Polyvinyl Alcohol Unit Containing Water-Soluble Polymers>>
D-1: PVA-110 aqueous dispersion (a solid content of 5%) manufactured by Kuraray -Co.: a saponification degree of 98.5
D-2: PVA-617 aqueous dispersion (a solid content of 5%) manufactured by Kuraray Co.: a saponification degree of 95
D-3: PVA-205 aqueous dispersion (a solid content of 5%) manufactured by Kuraray Co.: a saponification degree of 88
D-4: RS-4105 aqueous dispersion (a solid content of 5%) manufactured by Kuraray Co.: a saponification degree of 98
D-5: RS-2117 aqueous dispersion (a solid content of 5%) manufactured by Kuraray Co.: a saponification degree of 98
   <<Styrene-Diolefin Based Copolymer>>
E-1: Styrene butadiene latex (Nipol LX432A produced by Zeon Corp.; a solid content of 40%)
E-2: Styrene-butadiene copolymer latex (weight ratio of Styrene/butadiene=68/32; a solid content of 40%)
   <<Preparation of G-1 (SnO₂ Sol)>>

SnO₂ sol which was synthesized according the method described in Example 1 of Japanese Patent Examined Publication No. 35-6616 was concentrated to obtain a solid content of 10% by weight. Thereafter, the pH was adjusted to 10 and then employed.

### EXAMPLE 1

(Preparation of PET Support)

PET having an intrinsic viscosity IV of 0.66 (determined in phenol/tetrachloroethane=6/4 in terms of weight ratio at 25° C.) was prepared employing phthalic acid and ethylene glycol while using a conventional method. The resulting PET was pelletized and dried at 140° C. for 4 hours. The resulting pellets were melted at 300° C., and then quickly cooled while being extruded from a T type die, whereby a non-stretched film was prepared so as to obtain a layer thickness of 175 μm after thermal fixing. The resulting film was subjected to longitudinal stretching by a factor of 3.3, employing rollers having different peripheral rates and was then subjected to lateral stretching by a factor of 4.5 employing a tenter. During the aforesaid operations, temperatures were 110° C. and 130° C., respectively. Thereafter, thermal fixing was performed at 240° C. for 20 seconds and 4 percent lateral relaxation was performed at the same temperature. Thereafter, the chuck portion of the tenter was removed through slitting and both sides were subjected to a knurl treatment. The resulting film was wound under 4 kg/cm², whereby a roll of 100 μm thick film to be employed as a support was obtained.

(Preparation of a Subbed Support for an Optical Film)

Both surfaces of a 100 μm thick biaxially oriented thermally fixed polyethylene terephthalate film, employed as a photographic support, were subjected to a corona discharge treatment of 8 W/cm·minute on both sides. The resulting film was subjected to a subbing treatment. Namely, subbing coating composition a-1 was applied onto one side of this support for an optical film so as to obtain a dry thickness of 0.2 μm and subsequently dried at 123° C. to form a subbing layer on the front surface side. The resulting subbing layer was designated as subbing layer A-1.

Further, following subbing layer coating composition b-1 was applied onto the surface on the opposite side to form a backing layer subbing layer to obtain a dry thickness of 0.12 μm, and subsequently dried at 123° C., whereby a conductive subbing layer having an antistatic function was formed on the backing layer side. The resulting subbing layer was designated as subbing layer B-1.

Both surfaces of subbing layers A-1 and B-1 were subjected to a corona discharge of 8 W/m²·minute. Subsequently, following subbing layer coating composition a-2 was applied onto subbing layer A-1 to obtain a dry thickness of 0.1 μm, and subsequently dried at 123° C. The resulting subbing layer was designated as upper subbing layer A-2.

Further, following subbing coating composition b-2 was applied onto subbing layer B-1 to obtain a dry thickness of 0.2 μm and subsequently dried at 123° C. The resulting coating was designated as upper subbing layer B-2. Furthermore, the support was subjected to a thermal treatment at 123° C. for two minutes, whereby subbed Sample 101 was prepared.

Subbed Samples 102-114 were prepared similarly to preparation of subbed Sample 101, except that binders constituting upper subbing layer A-2 were changed as shown in Table 3-a.

Further, Subbed Samples 115 and 119-128 were prepared in such a manner that upper subbing layer A-2 was directly applied onto the corona discharged surface as shown in Table 3-a, without coating the lower subbing layer.

Further, Subbed Samples 116-118 were prepared in such a manner that the coating temperature of upper subbing layer A-2 was changed as shown in Table 3-a.

(Subbing layer coating composition b-1 on backing layer side)

| | |
|---|---|
| Acrylic polymer latex C-1 (a solid content of 30%) | 30.0 g |
| Acrylic polymer latex C-2 (a solid content of 30%) | 7.6 g |
| SnO₂ sol (G-1) | 180 g |
| Surfactant (A) | 0.5 g |
| 5% aqueous PVA-613 (PVA, produced by | 0.4 g |
| Kuraray Co.) solution | |

Distilled water was added into the above components and the total volume was adjusted to one liter, whereby a coating composition was prepared.

(Upper subbing layer coating composition b-2 on the backing
layer side)

| | |
|---|---|
| Modified water-soluble polyester B-1 (18% by weight) | 215 g |
| Spherical silica matting agent Sea Hoster KE-P50, | 0.3 g |
| produced by Nihon Shokubai Co.) | |
| Surfactant (A) | 0.4 g |

Distilled water was added into the above components for a total volume of one liter, whereby a coating composition was prepared.

(Lower subbing layer coating composition a-1 on the front
surface side)

| | |
|---|---|
| Acrylic polymer latex C-3 (a solid content of 30%) | 70.0 g |
| Acrylic polymer latex C-1 (a solid content of 30%) | 3.7 g |
| Aqueous dispersion of ethoxylated alcohol and ethylene | 5.0 g |
| homopolymer (a solid content of 10%) | 5.0 g |
| Surfactant (A) | 0.1 g |

Distilled water was added into the above components for a total volume of one liter, whereby a coating composition was prepared.

(Upper subbing layer coating composition a-2 on the front
surface side)

| | |
|---|---|
| Modified water-soluble polyester B-1 (18% by weight) | 130 g |
| Surfactant (A) | 0.4 g |
| Spherical silica matting agent (Sea Hoster KE-P50, | 0.3 g |
| produced by Nihon Shokubai Co.) | |

Distilled water was added into the above components for a total volume of one liter, whereby a coating composition was prepared.

<<Preparation of Anti-Reflection Film Samples 101-126>>

### EXAMPLE 1

Supports 101-126 provided with the subbing layer were prepared as substrate. Then 100 parts by weight of acrylate based UV curable hard coat material (Desolite Z7501 produced by JSR) containing the silica ultrafine particle and 35 parts by weight of the cyclohexanone were mixed and stirred to prepare a coating solution. This coating solution was coated on one surface of the aforementioned PET film using a micro gravure coater (Yasui Seiki Co., Ltd.) and then was dried. After that, ultraviolet rays were applied thereto at an intensity of 300 mJ/cm² to cure the solution. Thus, a hard coat layer having a thickness of 4 μm was formed on the other surface of the aforementioned PET film.

Then 100 parts by weight of acrylate based UV curable type coating material (Opster TU4005 produced by JSR) containing inorganic ultrafine particles, 5 parts by weight of multi-functional acrylate (DPHA produced by Nihon Kayaku Co., Ltd.), and 200 parts by weight of cyclohexanone were mixed and stirred to prepare a coating solution. This coating solution was coated on the aforementioned hard coat layer using the aforementioned micro gravure coater and then was dried. After that, ultraviolet rays were applied thereto at an intensity of 300 mJ/cm² to cure the solution. Thus, a medium refractive index layer (having a refractive index of 1.60) having a thickness of 72 nm was formed on the surface of the aforementioned hard coat layer.

A sand grinding mill was used to disperse the composition containing the mixture of 30 parts by weight of titanium oxide ultrafine particles (TTO55(A) produced by Ishihara Techno Co., Ltd.), 1 parts by weight of dimethylaminoethylmethacrylate (Light Ester DM produced by Kyoeisha Kagaku Co., Ltd.), 4 parts by weight of meta-crylate containing phosphate group (KAYAMER PM-21 produced by Nihon Kayaku Co., Ltd.), and 65 parts by weight of cyclohexanone, whereby a dispersion of titanium oxide ultrafine particles was prepared. Then 15 parts by weight of the acrylate based UV curable type hard coat material (Sunrad H-601R produced by Sanyo Kasei Kogyo Co., Ltd.) and 600 parts by weight of methylisobutyl ketone were blended thereto and dispersed to prepare a coating solution. This coating solution was coated on the aforementioned medium refractive index layer using the aforementioned micro gravure coater and the dried. Then ultraviolet rays were applied thereto at an intensity of 500 mJ/cm² to cure the solution. Thus, a high refractive index layer (percentage of titanium oxide particles in solids: 60% by weight, refractive index: 1.80) having a thickness of 130 nm was formed on the surface of the aforementioned medium refractive index layer. Further, 100 parts by weight of thermosetting type low refractive index antireflection material (Opster TT1006 produced by JSR) containing the fluorine based polymer and 20 parts by weight of methylisobutyl ketone were mixed and stirred to prepare a coating solution. This coating solution was coated on the aforementioned high refractive index layer using the aforementioned micro gravure coater and then dried. After that, heat treatment was provided at 120° C. for six minutes. Thus, a low refractive index layer (refractive index: 1.41) having a thickness of 92 nm was formed on the surface of the aforementioned high refractive index layer.

A polyethylene terephthalate (PET) film (Hitalex L-8010 produced by Hitachi Chemical Co., Ltd.) having a thickness of 25 μm was laminated on the aforementioned low refractive index layer as a protective film. This PET film was provided in the form bonded on to the separator through an agglutinant. It was laminated on the aforementioned low refractive index layer by removing this separator.

Then 100 parts by weight of polyester resin (Eritel UE 3690 produced by Junichika Co., Ltd.), 9.5 parts by weight of near-infrared ray absorbing pigment (Kayasobu IRG-022 produced by Nihon Kayaku Co., Ltd.), 3.2 parts by weight of near-infrared ray absorbing pigment (E. X. Color IR-12 produced by Nihon Shokubai Co., Ltd.), 2.2 parts by weight of neon light cut pigment (Art Cruz TY-100 produced by Asahi Denka Kogyo Co., Ltd.), 370 parts by weight of cyclohexanone, 185 parts by weight of toluene and 62 parts by weight of methyl ethyl ketone were mixed and stirred to prepare a coating solution. This coating solution was coated on the other surface of the aforementioned substrate using the aforementioned micro gravure coater and using then dried. Thus, a near-infrared ray absorbing layer having a thickness of 3 μm. was formed on the surface of the aforementioned substrate to prepare anti-reflection films 101-128 of Example 1.

[Evaluation of Properties]

The following describes the evaluation method:

<Adhesion on Anti-Reflection Film Surface Side>>

A razor's edge was used to put a cut into a sample at an angle of 45 degrees with respect to the sample surface. The cut was sandwiched to apply pressure to the cellophane self-adhesive tape. It was abruptly separated horizontally in the direction opposite 45 degrees, and the peeled area of the surface layer was obtained. The following criteria were used for evaluation:

1. The adhesive strength is very low and the anti-reflection layer is peeled completely. 2. The peeled area is at least 50% and less than 100%. 3. The peeld area is at least 20% and less than 50%. 4. The adhesive strength is high, and the peeled area is at least 5% and less than 20%. 5. The adhesive strength is very high, and the peeled area is less than 5%.

<<Evaluation of Abrasion Resistance>>

The film was subjected to five back-and-forth motions on the table to check the occurrence of abrasion in five ranks:

5: No abrasion

4: Occurrence of slight pin holes

3: Occurrence of considerable pin holes

2: Streak-shaped abrasion observed

1: Abrasion damage observed over the entire surface

<<Evaluation of Storage Ability at High-Temperature and Humidity>

To evaluate the storage ability under the conditions of high temperature and high humidity, a 10 cm square sample was cut out from each anti-reflection film, and was put to the test at 60° C. and 90% RH for 1000 hours. The external appearance of each sample was observed to check the presence or absence of a curl and the degree thereof. A sample was assigned with “5” if it was hardly curled, and there was no optical problem. It was assigned with “1” if it was curled, and there was an optical problem. According to such a scoring method, the storage ability was evaluated in five ranks. However, the evaluation was made in increments of 0.5.

<<Evaluation of Heat Resistance>>

To evaluate the heat resistance, each anti-reflection film was installed in the backlight unit and was put into a thermo-hygrostat of constant temperature and constant humidity at 60° C. and 90% RH. A lamp was turned on. After the lapse of 1, 2, 4, 8, 12 and 24 hours, the presence or absence of the flexure of the anti-reflection film and the degree thereof were checked according to the degree of luminance unevenness in the backlight unit, and evaluation was made according to the following criteria:

(1) 5: Neither luminance unevenness nor flexure

(2) 4: Almost no luminance unevenness and only very small flexure

(3) 3: Slight luminance unevenness observed with slight flexure

(4) 2: Luminance unevenness observed with small flexure

(5) 1: Luminance unevenness clearly observed with flexure

Evaluation was made in increments of 0.5.

TABLE 3-a

| | | Subbing layer on the front surface | | | | | | | | | | |
|---|---|---|---|---|---|---|---|---|---|---|---|---|
| | | Lower | | | | | Coating | | | | | |
| | Subbed | layer | Upper subbing layer | | | | solution | | | | | |
| | sample | Provided/ | Binder 1 | Ratio | Binder 2 | Ratio | temperature | | | | Heat | |
| *1 | No. | Not provided | Polyester | vol % | Type | vol % | (° C.) | Adhesion | *2 | *3 | resistance | Remarks |
| 101 | 101 | Provided | A-1 | 100 | — | — | 20 | 4.0 | 4.5 | 4.0 | 4.0 | Inv. |
| 102 | 102 | Provided | A-2 | 100 | — | — | 20 | 4.0 | 4.5 | 4.0 | 4.0 | Inv. |
| 103 | 103 | Provided | A-3 | 100 | — | — | 20 | 4.0 | 4.5 | 4.0 | 4.0 | Inv. |
| 104 | 104 | Provided | A-4 | 100 | — | — | 20 | 4.0 | 4.5 | 4.0 | 4.0 | Inv. |
| 105 | 105 | Provided | A-5 | 100 | — | — | 20 | 4.0 | 4.5 | 4.0 | 4.5 | Inv. |
| 106 | 106 | Provided | A-6 | 100 | — | — | 20 | 4.0 | 4.5 | 4.0 | 4.0 | Inv. |
| 107 | 107 | Provided | A-1 | 90 | C-2 | 10 | 20 | 4.5 | 4.5 | 4.0 | 4.0 | Inv. |
| 108 | 108 | Provided | A-2 | 90 | C-2 | 10 | 20 | 4.5 | 4.5 | 4.0 | 4.0 | Inv. |
| 109 | 109 | Provided | A-3 | 90 | C-2 | 10 | 20 | 4.5 | 4.5 | 4.0 | 4.0 | Inv. |
| 110 | 110 | Provided | A-1 | 50 | C-4 | 50 | 20 | 4.5 | 4.5 | 4.0 | 4.0 | Inv. |
| 111 | 111 | Provided | A-1 | 10 | C-2 | 90 | 20 | 4.0 | 4.5 | 4.0 | 4.0 | Inv. |
| 112 | 112 | Provided | — | — | C-2 | 100 | 20 | 2.0 | 2.5 | 2.5 | 2.5 | Comp. |
| 113 | 113 | Provided | A-1 | 100 | — | — | 20 | 4.0 | 4.5 | 4.0 | 4.0 | Inv. |
| 114 | 114 | Provided | A-1 | 97.5 | — | — | 20 | 4.0 | 4.5 | 4.0 | 4.0 | Inv. |
| 115 | 115 | Not | A-1 | 100 | — | — | 20 | 1.5 | 2.0 | 2.0 | 2.0 | Comp. |
| | | provided | | | | | | | | | | |
| 116 | 116 | Provided | A-1 | 100 | — | — | 25 | 4.0 | 4.5 | 4.0 | 4.0 | Inv. |
| 117 | 117 | Provided | A-1 | 100 | — | — | 30 | 4.5 | 4.5 | 4.0 | 4.0 | Inv. |
| 118 | 118 | Provided | A-1 | 100 | — | — | 35 | 4.0 | 4.5 | 4.0 | 4.0 | Inv. |
| 119 | 119 | Not | A-6 | 100 | — | — | 20 | 1.5 | 2.0 | 2.0 | 2.0 | Comp. |
| | | provided | | | | | | | | | | |
| 120 | 120 | Not | A-4 | 100 | — | — | 20 | 1.5 | 2.0 | 2.0 | 2.0 | Comp. |
| | | provided | | | | | | | | | | |
| 121 | 121 | Not | A-1 | 90 | C-3 | 10 | 20 | 4.0 | 4.0 | 3.5 | 3.5 | Inv. |
| | | provided | | | | | | | | | | |
| 122 | 122 | Not | A-6 | 90 | C-3 | 10 | 20 | 4.0 | 4.0 | 3.5 | 3.5 | Inv. |
| | | provided | | | | | | | | | | |
| 123 | 123 | Not | A-4 | 90 | C-3 | 10 | 20 | 4.0 | 4.0 | 3.5 | 3.5 | Inv. |
| | | provided | | | | | | | | | | |
| 124 | 124 | Not | A-1 | 50 | C-3 | 50 | 20 | 4.0 | 4.0 | 3.5 | 3.5 | Inv. |
| | | provided | | | | | | | | | | |
| 125 | 125 | Not | A-1 | 10 | C-3 | 90 | 20 | 4.0 | 4.0 | 3.5 | 3.5 | Inv. |
| | | provided | | | | | | | | | | |
| 126 | 126 | Not | — | — | C-3 | 100 | 20 | 1.5 | 2.0 | 2.0 | 2.0 | Comp. |
| | | provided | | | | | | | | | | |
| 127 | 127 | Not | A-1 | 70 | E-1 | 30 | 20 | 3.5 | 3.5 | 3.5 | 3.5 | Inv. |
| | | provided | | | | | | | | | | |
| 128 | 128 | Not | A-1 | 90 | E-2 | 10 | 20 | 3.5 | 3.5 | 3.5 | 3.5 | Inv. |
| | | provided | | | | | | | | | | |

*1: Anti-reflection film sample No.,
*2: Abrasion resistance
*3: Storage property at high-temperature and humidity
Inv.: Present invention,
Comp.: Comparative example

As is clear from Table 3-a, it is to be understood that the anti-reflection film employing a subbed sample of the present invention exhibits improved properties in adhesion, abrasion resistance, storage at high-temperature and humidity and heat resistance in comparison to comparative examples.

### EXAMPLE 2

Subbed samples 201-205 were prepared similarly to preparation of subbed sample 101, except that the binder constituting upper subbing layer A-2 on the front surface side was changed as shown in Table 4-a.

Further, subbed samples 206-211 were prepared in such a manner that upper subbing layer A-2 was applied onto the surface which was subjected to direct corona discharge treatment, without coating a lower subbing layer, as shown in Table 4-a.

In Table 4-a, the dry thickness of all samples coated with the lower subbing layer was 0.2 μm and the polyester ratio of C-2/C-1 was 95/5 (t by weight).

<<Preparation of Anti-Reflection Films 201-211>>

Anti-reflection films 201-211 were prepared similarly to Example 1, except that the supports prepared in Example 1 were replaced by subbed samples 201-211.

[Evaluation of Properties]

Properties are evaluated similarly to Example 1, and results are shown in Table 4-a.

TABLE 4-a

| | | Subbing layer on the front surface | | | | | | Storage | | |
|---|---|---|---|---|---|---|---|---|---|---|
| | | | Upper subbing layer | | | | | property at | | |
| | | Lower | | Vinyl | | | | high- | | |
| | Subbed | layer | | modification | Dry | | | temperature | | |
| | sample | Provided/ | Binder | ratio % by | thickness | | | and | Heat | |
| *1 | No. | Not provided | Polyester | weight | μm | Adhesion | *2 | humidity | resistance | Remarks |
| 201 | 201 | Provided | B-1 | 20 | 0.2 | 5.0 | 5.0 | 5.0 | 5.0 | Inv. |
| 202 | 202 | Provided | B-2 | 20 | 0.2 | 5.0 | 5.0 | 5.0 | 5.0 | Inv. |
| 203 | 203 | Provided | B-3 | 20 | 0.2 | 5.0 | 5.0 | 5.0 | 5.0 | Inv. |
| 204 | 204 | Provided | B-4 | 20 | 0.2 | 5.0 | 5.0 | 5.0 | 5.0 | Inv. |
| 205 | 205 | Provided | B-5 | 20 | 0.2 | 5.0 | 5.0 | 5.0 | 5.0 | Inv. |
| 206 | 206 | Not | B-1 | 20 | 0.2 | 4.5 | 5.0 | 4.5 | 4.5 | Inv. |
| | | provided | | | | | | | | |
| 207 | 207 | Not | B-6 | 20 | 0.2 | 4.5 | 5.0 | 4.5 | 4.5 | Inv. |
| | | provided | | | | | | | | |
| 208 | 208 | Not | B-7 | 20 | 0.2 | 4.5 | 5.0 | 4.5 | 4.5 | Inv. |
| | | Provided | | | | | | | | |
| 209 | 209 | Not | A-1 | 0 | 0.2 | 1.5 | 2.0 | 2.0 | 2.0 | Comp. |
| | | Provided | | | | | | | | |
| 210 | 210 | Not | A-3 | 0 | 0.2 | 1.5 | 2.0 | 1.5 | 2.0 | Comp. |
| | | provided | | | | | | | | |
| 211 | 211 | Not | A-4 | 0 | 0.2 | 1.5 | 2.0 | 2.0 | 2.0 | Comp. |
| | | provided | | | | | | | | |

*1: Anti-reflection film sample No.,
*2: Abrasion resistance
Inv.: Present invention,
Comp.: Comparative example

As is clear from Table 4-a, it is to be understood that the anti-reflection film employing a subbed sample of the present invention exhibits improved properties in adhesion, abrasion resistance, storage at high-temperature and humidity and heat resistance in comparison to comparative examples.

### EXAMPLE 3

Subbed samples 301-305 were prepared similarly to preparation of subbed sample 101, except that the binder constituting upper subbing layer A-2 on the front surface side was changed as shown in Table 5-a.

Further, subbed samples 306-308 were prepared in such a manner that upper subbing layer A-2 was applied onto the surface which was subjected to direct corona discharge treatment, without coating a lower subbing layer, as shown in Table 5-a.

<<Preparation of Anti-Reflection Films 301-308>>

Anti-reflection films 301-308 in Example 3 were prepared similarly to Example 1, except that the supports prepared in Example 1 were replaced by subbed samples 301-308.

[Evaluation of Properties]

Properties are evaluated similarly to Example 1, and results are shown in Table 5-a.

TABLE 5-a

| | | Subbing layer on the front surface | | | | | | | | | | |
|---|---|---|---|---|---|---|---|---|---|---|---|---|
| | | Lower | | | | | | | | | | |
| | Subbed | layer | Upper subbing layer | | | | Dry | | | | | |
| | sample | Provided/ | Binder 1 | Ratio | Binder 2 | Ratio | thickness | | | | Heat | |
| *1 | No. | Not provided | Polyester | vol % | Type | vol % | μm | Adhesion | *2 | *3 | resistance | Remarks |
| 301 | 301 | Provided | A-1 | 70 | D-1 | 30 | 0.2 | 4.0 | 4.5 | 4.0 | 4.0 | Inv. |
| 302 | 302 | Provided | A-1 | 70 | D-2 | 30 | 0.2 | 4.0 | 4.5 | 4.0 | 4.0 | Inv. |
| 303 | 303 | Provided | A-1 | 70 | D-3 | 30 | 0.2 | 4.0 | 4.5 | 4.0 | 4.0 | Inv. |
| 304 | 304 | Provided | A-1 | 90 | D-5 | 10 | 0.2 | 4.0 | 4.5 | 4.0 | 4.0 | Inv. |
| 305 | 305 | Provided | A-1 | 10 | D-5 | 90 | 0.2 | 3.5 | 4.5 | 4.0 | 4.0 | Inv. |
| 306 | 306 | Not | A-4 | 70 | D-4 | 30 | 0.2 | 4.0 | 4.0 | 3.5 | 3.5 | Inv. |
| | | provided | | | | | | | | | | |
| 307 | 307 | Not | A-2 | 70 | D-5 | 30 | 0.2 | 4.0 | 4.0 | 3.5 | 3.5 | Inv. |
| | | provided | | | | | | | | | | |
| 308 | 308 | Not | A-4 | 100 | — | — | 0.2 | 1.5 | 2.0 | 2.0 | 2.0 | Comp. |
| | | provided | | | | | | | | | | |

*1: Anti-reflection film sample No.,
*2: Abrasion resistance
*3: Storage property at high-temperature and humidity
Inv.: Present invention,
Comp.: Comparative example

As is clear from Table 5-a, it is to be understood that the anti-reflection film employing a subbed sample of the present invention exhibits improved properties in adhesion, abrasion resistance, storage at high-temperature and humidity and heat resistance in comparison to comparative example 308.

### EXAMPLE 4

A support having a subbing layer manufactured in Example 1 was prepared as a substrate (thickness of the support was changed from 100 μm to 40 μm).

(Infrared Ray Absorbing Layer)

(Preparation of Infrared Dye-1 Solid Particle Dispersion)

6.0 kg of the following infrared dye −1, 3.0 kg of p-dodesylbenzene sodium sulfonate, 0.6 kg of surface active agent Demol SNB produced by Kao Corp., and 0.15 kg of antifoaming agent (Tradename: Surfino 104E produced by Nisshin Kagaku Co., Ltd.) were mixed with distilled water to get a total liquid quantity of 60 kg. The mixture was dispersed by zirconia beads having a diameter of 0.5 mm using a horizontal sand mill (UVM-2 produced by Aimex Co., Ltd.). The dispersion having been obtained was diluted by distilled water so as to get 6% by weight in terms of the concentration of the infrared dye. Then the mixture was infiltrated by a filter (average pore diameter: 1 μm) to remove dust, and was put to practical use.

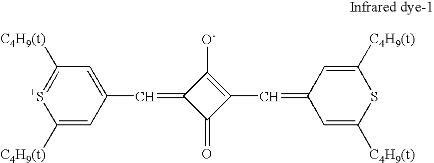

(Preparation of Infrared Ray Absorbing Layer Coating Solution)

A container was kept at a temperature of 40° C., and was supplied with 32.2 g of gelatine (containing amino group and carboxyl group) and 35 mg of benzoisothiazolinone and 840 ml of water to dissolve gelatine. This was mixed with 5.8 ml of 1 mol/l sodium sodium hydrate solution, 2.6 grams of infrared dye-1 solid dispersion liquid, 0.3 gram of C₁₈H₃₇CONHCH₂CH₂NHCOC₁₈H₃₇, 1.5 grams of fluid paraffin emulsion as a fluid paraffin, 10 ml of aqueous solution containing 5% by weight of di(2-ethylhexyl)sodium salt sulfosuccinic acid, 20 ml of aqueous solution containing 3% by weight of polystyrene sodium sulfonate, and 72.6 g of latex solution containing 19% by weight of methylmethacrylate/styrene/butylacrylate/hydroxyethylmethacrylate/acryl acid copolymer (copolymer weight ratio: 57/8/28/5/2), whereby a infrared ray absorbing layer coating solution was obtained.

This coating solution was coated on the support having a subbing layer by an extrusion coater at a coating rate of 50 m/min., so that the dry thickness is 3.5 μm. Drying was carried out by dry air for five minutes at a temperature of 100° C. with a dew point temperature of 10° C., whereby an infared ray absorbing films 401-428 were formed.

[Evaluation of Properties]

Properties are evaluated similarly to Example 1, and results are shown in Table 6-a.

TABLE 6-a

| | | Subbing layer on the front surface | | | | | | | | | | |
|---|---|---|---|---|---|---|---|---|---|---|---|---|
| | | Lower | | | | | Coating | | | | | |
| | Subbed | layer | Upper subbing layer | | | | solution | | | | | |
| | sample | Provided/ | Binder 1 | Ratio | Binder 2 | Ratio | temperature | | | | Heat | |
| *1 | No. | Not provided | Polyester | vol % | Type | vol % | (° C.) | Adhesion | *2 | *3 | resistance | Remarks |
| 401 | 401 | Provided | A-1 | 100 | — | — | 20 | 4.0 | 4.5 | 4.0 | 4.5 | Inv. |
| 402 | 402 | Provided | A-2 | 100 | — | — | 20 | 4.0 | 4.5 | 4.0 | 4.5 | Inv. |
| 403 | 403 | Provided | A-3 | 100 | — | — | 20 | 4.0 | 4.5 | 4.0 | 4.5 | Inv. |
| 404 | 404 | Provided | A-4 | 100 | — | — | 20 | 4.0 | 4.5 | 4.0 | 4.5 | Inv. |
| 405 | 405 | Provided | A-5 | 100 | — | — | 20 | 4.0 | 4.5 | 4.0 | 4.5 | Inv. |
| 406 | 406 | Provided | A-6 | 100 | — | — | 20 | 4.0 | 4.5 | 4.0 | 4.5 | Inv. |
| 407 | 407 | Provided | A-1 | 90 | C-2 | 10 | 20 | 4.5 | 4.5 | 4.0 | 4.5 | Inv. |
| 408 | 408 | Provided | A-2 | 90 | C-2 | 10 | 20 | 4.5 | 4.5 | 4.0 | 4.5 | Inv. |
| 409 | 409 | Provided | A-3 | 90 | C-2 | 10 | 20 | 4.5 | 4.5 | 4.0 | 4.5 | Inv. |
| 410 | 410 | Provided | A-1 | 50 | C-4 | 50 | 20 | 4.5 | 4.5 | 4.0 | 4.5 | Inv. |
| 411 | 411 | Provided | A-1 | 10 | C-2 | 90 | 20 | 4.0 | 4.5 | 4.0 | 4.5 | Inv. |
| 412 | 412 | Provided | — | — | C-2 | 100 | 20 | 2.0 | 2.0 | 1.5 | 2.5 | Comp. |
| 413 | 413 | Provided | A-1 | 100 | — | — | 20 | 4.0 | 4.5 | 4.0 | 4.5 | Inv. |
| 414 | 414 | Provided | A-1 | 97.5 | — | — | 20 | 4.0 | 4.5 | 4.0 | 4.5 | Inv. |
| 415 | 415 | Not | A-1 | 100 | — | — | 20 | 2.0 | 2.0 | 1.5 | 2.0 | Comp. |
| | | provided | | | | | | | | | | |
| 416 | 416 | Provided | A-1 | 100 | — | — | 25 | 4.0 | 4.5 | 4.0 | 4.5 | Inv. |
| 417 | 417 | Provided | A-1 | 100 | — | — | 30 | 4.5 | 4.5 | 4.0 | 4.5 | Inv. |
| 418 | 418 | Provided | A-1 | 100 | — | — | 35 | 4.0 | 4.5 | 4.0 | 4.5 | Inv. |
| 419 | 419 | Not | A-6 | 100 | — | — | 20 | 2.0 | 2.0 | 1.5 | 2.0 | Comp. |
| | | provided | | | | | | | | | | |
| 420 | 420 | Not | A-4 | 100 | — | — | 20 | 2.0 | 2.0 | 1.5 | 2.0 | Comp. |
| | | provided | | | | | | | | | | |
| 421 | 421 | Not | A-1 | 90 | C-3 | 10 | 20 | 4.0 | 4.0 | 3.5 | 3.5 | Inv. |
| | | provided | | | | | | | | | | |
| 422 | 422 | Not | A-6 | 90 | C-3 | 10 | 20 | 4.0 | 4.0 | 3.5 | 3.5 | Inv. |
| | | provided | | | | | | | | | | |
| 423 | 423 | Not | A-4 | 90 | C-3 | 10 | 20 | 4.0 | 4.0 | 3.5 | 3.5 | Inv. |
| | | provided | | | | | | | | | | |
| 424 | 424 | Not | A-1 | 50 | C-3 | 50 | 20 | 4.0 | 4.0 | 3.5 | 3.5 | Inv. |
| | | provided | | | | | | | | | | |
| 425 | 425 | Not | A-1 | 10 | C-3 | 90 | 20 | 4.0 | 4.0 | 3.5 | 3.5 | Inv. |
| | | provided | | | | | | | | | | |
| 426 | 426 | Not | — | — | C-3 | 100 | 20 | 2.0 | 2.0 | 1.5 | 2.0 | Comp. |
| | | provided | | | | | | | | | | |
| 427 | 427 | Not | A-1 | 70 | E-1 | 30 | 20 | 3.5 | 3.5 | 3.5 | 3.5 | Inv. |
| | | provided | | | | | | | | | | |
| 428 | 428 | Not | A-1 | 90 | E-2 | 10 | 20 | 3.5 | 3.5 | 3.5 | 3.5 | Inv. |
| | | provided | | | | | | | | | | |

*1: Infrared ray absorbing film sample No.,
*2: Abrasion resistance
*3: storage property at high-temperature and humidity
Inv.: Present invention,
Comp.: Comparative example

As is clear from Table 6-a, it is to be understood that the infrared ray absorbing film employing a subbed sample of the present invention exhibits improved properties in adhesion, abrasion resistance, storage at high-temperature and humidity and heat resistance in comparison to comparative examples.

### EXAMPLE 5

Infrared ray absorbing films 501-511 in Example 5 were prepared similarly to Example 4, except that the support prepared in Example 1 was replaced by the support prepared in Example 2 (100 μm in support thickness was changed to 40 μm, in this case).

[Evaluation of Properties]

Properties are evaluated similarly to Example 4, and results are shown in Table 7-a.

TABLE 7-a

| | | Subbing layer on the front surface | | | | | | Storage | | |
|---|---|---|---|---|---|---|---|---|---|---|
| | | | Upper subbing layer | | | | | property at | | |
| | | Lower | | Vinyl | | | | high- | | |
| | Subbed | layer | | modification | Dry | | | temperature | | |
| | sample | Provided/ | Binder | ratio % by | thickness | | | and | Heat | |
| *1 | No. | not Provided | Polyester | weight | μm | Adhesion | *2 | humidity | resistance | Remarks |
| 501 | 501 | Provided | B-1 | 20 | 0.2 | 5.0 | 5.0 | 5.0 | 5.0 | Inv. |
| 502 | 502 | Provided | B-2 | 20 | 0.2 | 5.0 | 5.0 | 5.0 | 5.0 | Inv. |
| 503 | 503 | Provided | B-3 | 20 | 0.2 | 5.0 | 5.0 | 5.0 | 5.0 | Inv. |
| 504 | 504 | Provided | B-4 | 20 | 0.2 | 5.0 | 5.0 | 5.0 | 5.0 | Inv. |
| 505 | 505 | Provided | B-5 | 20 | 0.2 | 5.0 | 5.0 | 5.0 | 5.0 | Inv. |
| 506 | 506 | Not | B-1 | 20 | 0.2 | 4.5 | 4.5 | 4.5 | 4.5 | Inv. |
| | | provided | | | | | | | | |
| 507 | 507 | Not | B-6 | 20 | 0.2 | 4.5 | 4.5 | 4.5 | 4.5 | Inv. |
| | | provided | | | | | | | | |
| 508 | 508 | Not | B-7 | 20 | 0.2 | 4.5 | 4.5 | 4.5 | 4.5 | Inv. |
| | | provided | | | | | | | | |
| 509 | 509 | Not | A-1 | 0 | 0.2 | 2.5 | 2.5 | 2.5 | 2.5 | Comp. |
| | | provided | | | | | | | | |
| 510 | 510 | Not | A-3 | 0 | 0.2 | 2.5 | 2.5 | 2.0 | 2.5 | Comp. |
| | | provided | | | | | | | | |
| 511 | 511 | Not | A-4 | 0 | 0.2 | 2.5 | 2.5 | 2.5 | 2.5 | Comp. |
| | | provided | | | | | | | | |

*1: Infrared ray absorbing film sample No.,
*2: Abrasion resistance
Inv.: Present invention,
Comp.: Comparative example

As is clear from Table 7-a, it is to be understood that the infrared ray absorbing film employing a subbed sample of the present invention exhibits improved properties in adhesion, abrasion resistance, storage at high-temperature and humidity and heat resistance in comparison to comparative examples.

### EXAMPLE 6

Infrared ray absorbing films 601-608 in Example 6 were prepared similarly to Example 4, except that the support prepared in Example 1 was replaced by the support prepared in Example 3 (100 μm in support thickness was changed to 40 μm, in this case).

[Evaluation of Properties]

Properties are evaluated similarly to Example 4, and results are shown in Table 8-a.

TABLE 8-a

| | | Subbing layer on the front surface | | | | | | | | | | |
|---|---|---|---|---|---|---|---|---|---|---|---|---|
| | | Lower | | | | | | | | | | |
| | Subbed | layer | Upper subbing layer | | | | Dry | | | | | |
| | sample | Provided/ | Binder 1 | Ratio | Binder 2 | Ratio | thickness | | | | Heat | |
| *1 | No. | Not provided | Polyester | vol % | Type | vol % | μm | Adhesion | *2 | *3 | resistance | Remarks |
| 601 | 601 | Provided | A-1 | 70 | D-1 | 30 | 0.2 | 4.5 | 4.5 | 4.5 | 4.0 | Inv. |
| 602 | 602 | Provided | A-1 | 70 | D-2 | 30 | 0.2 | 4.5 | 4.5 | 4.5 | 4.0 | Inv. |
| 603 | 603 | Provided | A-1 | 70 | D-3 | 30 | 0.2 | 4.5 | 4.5 | 4.5 | 4.0 | Inv. |
| 604 | 604 | Provided | A-1 | 90 | D-5 | 10 | 0.2 | 4.5 | 4.5 | 4.5 | 4.0 | Inv. |
| 605 | 605 | Provided | A-1 | 10 | D-5 | 90 | 0.2 | 4.0 | 4.5 | 4.5 | 4.0 | Inv. |
| 606 | 606 | Not | A-4 | 70 | D-4 | 30 | 0.2 | 4.5 | 4.0 | 4.0 | 3.5 | Inv. |
| | | provided | | | | | | | | | | |
| 607 | 607 | Not | A-2 | 70 | D-5 | 30 | 0.2 | 4.5 | 4.0 | 4.0 | 3.5 | Inv. |
| | | provided | | | | | | | | | | |
| 608 | 608 | Not | A-4 | 100 | — | — | 0.2 | 2.0 | 2.0 | 2.5 | 2.0 | Comp. |
| | | provided | | | | | | | | | | |

*1: Infrared ray absorbing film sample No.,
*2: Abrasion resistance
*3: storage property at high-temperature and humidity
Inv.: Present invention,
Comp.: Comparative example

As is clear from Table 8-a, it is to be understood that the infrared ray absorbing film employing a subbed sample of the present invention exhibits improved properties in adhesion, abrasion resistance, storage at high-temperature and humidity and heat resistance in comparison to comparative examples.

### EXAMPLE 7

A support equipped with subbing layer manufactured in Example 1 was prepared as a substrate (the thickness of the support was changed from 100 μm to 175 μm).

The emulsion containing a silver iodobromide particle (I=2 mol %) having an average sphere-equivalent diameter of 0.05 μm including 7.5 grams of gelatine with respect to 60 grams of Ag in water medium was prepared. In this case, the volume ratio of Ag/gelatine was assumed as 1/1, and gelatine of low molecular weight having an average molecular weight of 20,000 was used as gelatine species.

K₃Rh₂Br₉ and K₂IrCl₆ were added to this emulsion so that the concentration is 10⁻⁷ (mol/mol silver), and the silver bromide particle was doped with Rh ion and Ir ion. Na₂PdCl₄ was added to this emulsion, and gold and sulfur sensitization was carried out by chloroauric acid and gold sodium thiosulfate. After that, together with the gelatine hardener, it was coated on the polyethylene terephthalate (PET) provided with the subbing layer so that the amount of the silver to be coated is 1 g/m². Exposure was carried out using an ultraviolet lamp through the lattice-shaped photo mask (photo mask wherein the space is lattice-shaped and the line/space is 195 μm/5 μm (pitch: 200 μm) capable of providing the dried coating film with a development silver image of line/space=5 μm/195 μm. Development was carried out at 25° C. for 45 seconds using a the following developer. Further, a fixing solution (Super-Fujifix produced by Fuji Photo Film Co., Ltd.) was used to perform the process of development. After that, pure water was utilized for rinsing.

[Composition of Developer]

The following compounds were contained in one liter of the developer:

Hydroquinone: 0.037 mol/L

N-methylaminophenol: 0.016 mol/L

Sodium metaborate: 0.140 mol/L

Sodium hydroxide: 0.360 mol/L

Sodium bromide: 0.031 mol/L

Potassium metabisulfite: 0.187 mol/L

Further, electroless copper plating was carried out at 45° C. using the plating solution (electroless copper plating solution having a pH value of 12.5 containing 0.06 mol/L of copper sulfate, 0.22 mol/L of formalin, 0.12 mol/L of triethanol amine, 100 ppm of polyethylene glycol, 50 ppm of yellow prussiate of potash and 20 ppm of α,α′-bipyridine). After that, oxidation treatment was performed using aqueous solution containing 10 ppm of Fe (III) ion, whereby the electromagnetic shielding films 701-728 of the present invention were produced.

[Evaluation of Properties]

Properties are evaluated similarly to Example 1, and results are shown in Table 9-a.

TABLE 9-a

| | | Subbing layer on the front surface | | | | | | | | | | |
|---|---|---|---|---|---|---|---|---|---|---|---|---|
| | | Lower | | | | | Coating | | | | | |
| | Subbed | layer | Upper subbing layer | | | | solution | | | | | |
| | sample | Provided/ | Binder 1 | Ratio | Binder 2 | Ratio | temperature | | | | Heat | |
| *1 | No. | Not provided | Polyester | vol % | Type | vol % | (° C.) | Adhesion | *2 | *3 | resistance | Remarks |
| 701 | 701 | Provided | A-1 | 100 | — | — | 20 | 4.0 | 4.0 | 4.0 | 4.0 | Inv. |
| 702 | 702 | Provided | A-2 | 100 | — | — | 20 | 4.0 | 4.0 | 4.0 | 4.0 | Inv. |
| 703 | 703 | Provided | A-3 | 100 | — | — | 20 | 4.0 | 4.0 | 4.0 | 4.0 | Inv. |
| 704 | 704 | Provided | A-4 | 100 | — | — | 20 | 4.0 | 4.0 | 4.0 | 4.0 | Inv. |
| 705 | 705 | Provided | A-5 | 100 | — | — | 20 | 4.0 | 4.0 | 4.0 | 4.0 | Inv. |
| 706 | 706 | Provided | A-6 | 100 | — | — | 20 | 4.0 | 4.0 | 4.0 | 4.0 | Inv. |
| 707 | 707 | Provided | A-1 | 90 | C-2 | 10 | 20 | 4.5 | 4.0 | 4.0 | 4.0 | Inv. |
| 708 | 708 | Provided | A-2 | 90 | C-2 | 10 | 20 | 4.5 | 4.0 | 4.0 | 4.0 | Inv. |
| 709 | 709 | Provided | A-3 | 90 | C-2 | 10 | 20 | 4.5 | 4.0 | 4.0 | 4.0 | Inv. |
| 710 | 710 | Provided | A-1 | 50 | C-4 | 50 | 20 | 4.5 | 4.0 | 4.0 | 4.0 | Inv. |
| 711 | 711 | Provided | A-1 | 10 | C-2 | 90 | 20 | 4.0 | 4.0 | 4.0 | 4.0 | Inv. |
| 712 | 712 | Provided | — | — | C-2 | 100 | 20 | 1.5 | 1.5 | 1.5 | 2.0 | Comp. |
| 713 | 713 | Provided | A-1 | 100 | — | — | 20 | 4.5 | 4.5 | 4.5 | 4.5 | Inv. |
| 714 | 714 | Provided | A-1 | 97.5 | — | — | 20 | 4.5 | 4.5 | 4.5 | 4.5 | Inv. |
| 715 | 715 | Not | A-1 | 100 | — | — | 20 | 1.5 | 1.5 | 1.5 | 1.5 | Comp. |
| | | provided | | | | | | | | | | |
| 716 | 716 | Provided | A-1 | 100 | — | — | 25 | 4.0 | 4.0 | 4.0 | 4.0 | Inv. |
| 717 | 717 | Provided | A-1 | 100 | — | — | 30 | 4.5 | 4.0 | 4.0 | 4.0 | Inv. |
| 718 | 718 | Provided | A-1 | 100 | — | — | 35 | 4.0 | 4.0 | 4.0 | 4.0 | Inv. |
| 719 | 719 | Not | A-6 | 100 | — | — | 20 | 2.0 | 1.5 | 1.5 | 1.5 | Comp. |
| | | provided | | | | | | | | | | |
| 720 | 720 | Not | A-4 | 100 | — | — | 20 | 2.0 | 1.5 | 1.5 | 1.5 | Comp. |
| | | provided | | | | | | | | | | |
| 721 | 721 | Not | A-1 | 90 | C-3 | 10 | 20 | 4.0 | 3.5 | 3.5 | 3.5 | Inv. |
| | | provided | | | | | | | | | | |
| 722 | 722 | Not | A-6 | 90 | C-3 | 10 | 20 | 4.0 | 3.5 | 3.5 | 3.5 | Inv. |
| | | provided | | | | | | | | | | |
| 723 | 723 | Not | A-4 | 90 | C-3 | 10 | 20 | 4.0 | 3.5 | 3.5 | 3.5 | Inv. |
| | | provided | | | | | | | | | | |
| 724 | 724 | Not | A-1 | 50 | C-3 | 50 | 20 | 4.0 | 3.5 | 3.5 | 3.5 | Inv. |
| | | provided | | | | | | | | | | |
| 725 | 725 | Not | A-1 | 10 | C-3 | 90 | 20 | 4.0 | 3.5 | 3.5 | 3.5 | Inv. |
| | | provided | | | | | | | | | | |
| 726 | 726 | Not | — | — | C-3 | 100 | 20 | 2.0 | 1.5 | 1.5 | 1.5 | Comp. |
| | | provided | | | | | | | | | | |
| 727 | 727 | Not | A-1 | 70 | E-1 | 30 | 20 | 3.5 | 3.5 | 3.5 | 3.5 | Inv. |
| | | provided | | | | | | | | | | |
| 728 | 728 | Not | A-1 | 90 | E-2 | 10 | 20 | 3.5 | 3.5 | 3.5 | 3.5 | Inv. |
| | | provided | | | | | | | | | | |

*1: Electromagnetic shielding film sample No.,
*2: Abrasion resistance
*3: Storage property at high-temperature and humidity
Inv.: Present invention,
Comp.: Comparative example

As is clear from Table 9-a, it is to be understood that the electromagnetic shielding film employing a subbed sample of the present invention exhibits improved properties in adhesion, abrasion resistance, storage at high-temperature and humidity and heat resistance in comparision to comparative examples.

### EXAMPLE 8

Electromagnetic shielding films 801-811 in Example 8 were prepared similarly to Example 7, except that the support prepared in Example 2 was replaced by the support prepared in Example 3 (175 μm in support thickness, in this case).

[Evaluation of Properties]

Properties are evaluated similarly to Example 7, and results are shown in Table 10-a.

TABLE 10-a

| | | Subbing layer on the front surface | | | | | | Storage | | |
|---|---|---|---|---|---|---|---|---|---|---|
| | | | Upper subbing layer | | | | | property at | | |
| | | Lower | | Vinyl | | | | high- | | |
| | Subbed | layer | | modification | Dry | | | temperature | | |
| | sample | Provided/ | Binder | ratio % by | thickness | | | and | Heat | |
| *1 | No. | Not provided | Polyester | weight | μm | Adhesion | *2 | humidity | resistance | Remarks |
| 801 | 801 | Provided | B-1 | 20 | 0.2 | 5.0 | 5.0 | 5.0 | 5.0 | Inv. |
| 802 | 802 | Provided | B-2 | 20 | 0.2 | 5.0 | 5.0 | 5.0 | 5.0 | Inv. |
| 803 | 803 | Provided | B-3 | 20 | 0.2 | 5.0 | 5.0 | 5.0 | 5.0 | Inv. |
| 804 | 804 | Provided | B-4 | 20 | 0.2 | 5.0 | 5.0 | 5.0 | 5.0 | Inv. |
| 805 | 805 | Provided | B-5 | 20 | 0.2 | 5.0 | 5.0 | 5.0 | 5.0 | Inv. |
| 806 | 806 | Not | B-1 | 20 | 0.2 | 4.5 | 4.0 | 4.5 | 4.5 | Inv. |
| | | provided | | | | | | | | |
| 807 | 807 | Not | B-6 | 20 | 0.2 | 4.5 | 4.0 | 4.5 | 4.5 | Inv. |
| | | provided | | | | | | | | |
| 808 | 808 | Not | B-7 | 20 | 0.2 | 4.5 | 4.0 | 4.5 | 4.5 | Inv. |
| | | provided | | | | | | | | |
| 809 | 809 | Not | A-1 | 0 | 0.2 | 2.0 | 2.0 | 2.5 | 2.0 | Comp. |
| | | provided | | | | | | | | |
| 810 | 810 | Not | A-3 | 0 | 0.2 | 2.0 | 2.0 | 2.5 | 2.5 | Comp. |
| | | provided | | | | | | | | |
| 811 | 811 | Not | A-4 | 0 | 0.2 | 2.0 | 2.0 | 2.5 | 2.0 | Comp. |
| | | provided | | | | | | | | |

*1: Electromagnetic shielding film sample No.,
*2: Abrasion resistance
Inv.: Present invention,
Comp.: Comparative example

As is clear from Table 10-a, it is to be understood that the electromagnetic shielding film employing a subbed sample of the present invention exhibits improved properties in adhesion, abrasion resistance, storage at high-temperature and humidity and heat resistance in comparison to comparative examples.

### EXAMPLE 9

Electromagnetic shielding films 901-908 in Example 9 were prepared similarly to Example 7, except that the support prepared in Example 1 was replaced by the support prepared in Example 2 (175 μm in support thickness, in this case).

[Evaluation of Properties]

Properties are evaluated similarly to Example 7, and results are shown in Table 11-a.

TABLE 11-a

| | | Subbing layer on the front surface | | | | | | | | | | |
|---|---|---|---|---|---|---|---|---|---|---|---|---|
| | | Lower | | | | | | | | | | |
| | Subbed | layer | Upper subbing layer | | | | Dry | | | | | |
| | sample | Provided/ | Binder 1 | Ratio | Binder 2 | Ratio | thickness | | | | Heat | |
| *1 | No. | Not provided | Polyester | vol % | Type | vol % | μm | Adhesion | *2 | *3 | resistance | Remarks |
| 901 | 901 | Provided | A-1 | 70 | D-1 | 30 | 0.2 | 4.5 | 4.5 | 4.5 | 4.0 | Inv. |
| 902 | 902 | Provided | A-1 | 70 | D-2 | 30 | 0.2 | 4.5 | 4.5 | 4.5 | 4.0 | Inv. |
| 903 | 903 | Provided | A-1 | 70 | D-3 | 30 | 0.2 | 4.5 | 4.5 | 4.5 | 4.0 | Inv. |
| 904 | 904 | Provided | A-1 | 90 | D-5 | 10 | 0.2 | 4.5 | 4.5 | 4.5 | 4.0 | Inv. |
| 905 | 905 | Provided | A-1 | 10 | D-5 | 90 | 0.2 | 4.0 | 4.5 | 4.5 | 4.0 | Inv. |
| 906 | 906 | Not | A-4 | 70 | D-4 | 30 | 0.2 | 4.5 | 4.0 | 4.0 | 3.5 | Inv. |
| | | provided | | | | | | | | | | |
| 907 | 907 | Not | A-2 | 70 | D-5 | 30 | 0.2 | 4.5 | 4.0 | 4.0 | 3.5 | Inv. |
| | | provided | | | | | | | | | | |
| 908 | 908 | Not | A-4 | 100 | — | — | 0.2 | 2.5 | 2.5 | 2.5 | 2.5 | Comp. |
| | | provided | | | | | | | | | | |

*1: Electromagnetic shielding film sample No.,
*2: Abrasion resistance
*3: Storage property at high-temperature and humidity
Inv.: Present invention,
Comp.: Comparative example

As is clear from Table 11-a, it is to be understood that the electromagnetic shielding film employing a subbed sample of the present invention exhibits improved properties in adhesion, abrasion resistance, storage at high-temperature and humidity and heat resistance in comparison to comparative examples.

### EXAMPLE B

Next, the present invention will now be described in detail referring to examples, however, the present invention is not limited thereto.

<<Preparation of Water-Soluble Polyester Solutions A-1-A-4>>

As described below, aqueous polyester dispersions (refer to Table 1-b regarding types and addition amounts) were prepared (a solid content of 15%).

(Preparation of Water-Soluble Polyester Solution A-1)

A mixture consisting of 35.4 parts by weight of dimethyl terephthalate, 33.63 parts by weight of dimethyl isophthalate, 17.92 parts by weight of dimethyl 5-sufoisophthalate sodium salt, 62 parts by weight of ethylene glycol, 0.065 part by weight of calcium acetate monohydrate, and 0.022 part by weight of manganese acetate underwent transesterification at 170-220° C. under nitrogen gas flow, while distilling methanol away. Thereafter, 0.04 parts by weight of trimethyl phosphate, 0.04 part by weight of antimony trioxide, as a polymerization condensation catalyst, and 6.8 parts by weight of 4-cyclohexanedicarboxylic acid were added and the resulting mixture underwent esterification at a reaction temperature of 220 to 235° C., while the theoretical amount of water was distilled away.

Thereafter, the pressure of the reaction system was reduced over one hour and the temperature was raised. Subsequently, polymerization condensation was conducted at 280° C. and 133 Pa for one hour to prepare water-soluble polyester A-1. The resulting water-soluble polyester A-1 exhibited an intrinsic viscosity of 0.33 (100 ml/g) and Mw of 80,000-100,000.

Subsequently, charged into a 2-liter three-necked flask fitted with a stirring blade, a reflux condenser, and a thermometer was 850 ml of pure water. Subsequently, 150 g of water-soluble polyester A-1 was gradually added, under constant stirring. After stirring without modification at room temperature for 30 minutes, the internal temperature was raised to 98° C. over one and a half hours and eater-soluble polyester A-1 was dissolved over 3 hours while maintaining a temperature at 98° C. After completion of heating, the reaction mixture was cooled to room temperature over one hour and was allowed to stand overnight, whereby a 15% by weight of water-soluble polyester A-1 solution was prepared. A-2 through A-4 were prepared in the same manner as A-1, except that the monomer compositions were changed.

<<Preparation of Water-Soluble Polyester Solution A-5>>

As described below, aqueous polyester dispersions (refer to Table 1-b regarding types and addition amounts) were prepared (a solid content of 15%).

Charged into a transesterification vessel were a mixture consisting of 70% by mole of dimethyl 2,6-naphthalenedicarrboxylate, 27% by mole of dimethyl isophthalate, 3% by mole of trimellitic anhydride, 95% by mole of ethylene glycol, and 5% by mole of an ethylene oxide addition product (having the chemical structure as shown below and m+n=4 in average value, also described as Surfactant (A)) and further 0.05 part of tetrabutoxy titanium was added. The resulting mixture underwent transesterification reaction under a flow of nitrogen at 230° C. while distilling away methanol.

Subsequently, after adding 0.6 part by weight of Ilganox 1010 (manufactured by CIBA Specialty Chemicals Co., Ltd.) to this reaction system, the resulting mixture was gradually heated to 255° C., and then underwent polymerization condensation under a reduced pressure of 133 kPa, whereby a polyester resin having an intrinsic viscosity of 0.32 was prepared.

Dissolved in 180 parts by weight of tetrahydrofuran was 20 parts by weight of the resulting polyester resin. Subsequently, 180 parts by weight of a 0.4% by weight aqueous triethylamine solution was dripped into the resulting mixture at a high speed stirring of 10,000 rpm, whereby a bluish milky dispersion was obtained. The resulting dispersion was then distilled under a reduced pressure of 2,660 kPa to remove tetrahydrofuran. Thus an aqueous polyester dispersion, having a solid content of 15% by weight, was obtained. 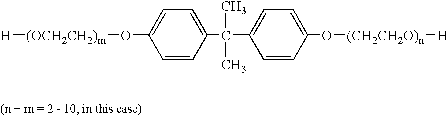
<<Preparation of Water-Soluble Polyester Solution A-6>>

Pesresin A-515GB (modified water-soluble polyester having a Tg of 60° C., manufactured by Takamatsu Yushi Co.) was dissolved in water to obtain a solid content of 15% by weight.

Employed polyester compositions (in % by mole)

TABLE 1-b

| | | | | | | | | | | | Tg |
|---|---|---|---|---|---|---|---|---|---|---|---|
| Component | TA | IA | IPS | CHDA | QA | TMA | EG | DEG | CHDM | BPA | (° C.) |
| A-1 | 40 | 38 | 14 | 8 | | | 100 | | | | 51 |
| A-2 | 40 | 30 | 10 | 20 | | | 70 | | 30 | | 56 |
| A-3 | 50 | 42 | 8 | | | | | 80 | 20 | | 80 |
| A-4 | 40 | 40 | 20 | | | | | 40 | 60 | | 73 |
| A-5 | | 27 | | | 70 | 3 | 95 | | | 5 | 55 |

| | |
|---|---|
| A-6 | Pesresin A-515GB (modified water-soluble |
| | polyester having a Tg of 60° C., manufactured by |
| | Takamatsu Yusi Co.) was adjusted to obtain a |
| | solid content of 15% by weight by adding water. |

TA: dimethyl terephthalate
IA: dimethyl isophthalate
IPS: sodium dimethyl 5-sulfoisophthalate
CHDA: 4-cylcohexanedicarboxyluc acid
QA: 2,6-naphthalenedicarboxylic acid
TMA: trimellitic anhydride
EG: ethylene glycol
DEG: diethylene glycol
CHDM: cyclohexanedimethanol
BPA: bisphenol A ethylene oxide additive product

<<Preparation of Modified Water-Soluble Polyester Solutions B-1-B-7>>
(Preparation of Modified Water-Soluble Polyester Solution B-1)

Charged into a 3-liter four-necked flask fitted with stirring blades, a reflux condenser, a thermometer and a dripping funnel was 1,900 ml of 15% by weight water-soluble polyester solution A-1, and the resulting mixture was heated to 80° C. while stirring. Added to the above mixture was 6.52 ml of 24% aqueous ammonium peroxide, and then over 30 minutes dripped into the resulting mixture was a monomer mixed composition (composed of 28.5 g of glycidyl methacrylate, 21.4 g of ethyl acrylate, and 21.4 g of methyl methacrylate). The resulting mixture underwent reaction for an additional 3 hours. Thereafter, the resulting mixture was cooled to less than or equal to 30° C. and filtered, whereby modified water-soluble polyester solution B-1 having a solid content of 18% by weight was prepared (a vinyl based component modification ratio of 20% by weight).

(Preparation of Modified Water-Soluble Polyester Solution B-2)

Charged into a 3-liter four-necked flask fitted with stirring blades, a reflux condenser, a thermometer and a dripping funnel was 1,900 ml of 15% by weight water-soluble polyester solution A-1, and the resulting mixture was heated to 80° C. while stirring. Added to the above mixture was 6.52 ml of 24% aqueous ammonium peroxide, and then over 30 minutes dripped into the resulting mixture was a monomer mixed composition (composed of 10.7 g of styrene, 28.5 g of glycidyl methacrylate, 21.4 g of ethyl acrylate, and 10.7 g of methyl methacrylate). The resulting mixture underwent reaction for an additional 3 hours. Thereafter, the resulting mixture was cooled to less than or equal to 30° C. and filtered, whereby modified water-soluble polyester solution B-2 having a solid content of 18% by weight was prepared (a vinyl based component modification ratio of 20% by weight).

(Preparation of Modified Water-Soluble Polyester Solution B-3)

Charged into a 3-liter four-necked flask fitted with stirring blades, a reflux condenser, a thermometer and a dripping funnel was 1,900 ml of a 15% by weight water-soluble polyester solution A-2, and the resulting mixture was heated to 80° C. while stirring. Added to the above mixture was 6.52 ml of 24% aqueous ammonium peroxide, and then over 30 minutes dripped into the resulting mixture was a monomer mixed composition (consisting of 28.5 g of styrene, 28.5 g of glycidyl methacrylate, and 14.4 g of acrylamide). The resulting mixture underwent reaction for an additional 3 hours. Thereafter, the resulting mixture was cooled to less than or equal to 30° C. and filtered, whereby modified water-soluble polyester solution B-3 having a solid content of 18% by weight was prepared (a vinyl based component modification ratio of 20% by weight).

(Preparation of Modified Water-Soluble Polyester Solution B-4)

Modified water-soluble polyester solution B-4 was prepared similarly to preparation of modified water-soluble polyester solution B-1, except that the vinyl based component modification ratio was replaced by 8% by weight.

(Preparation of Modified Water-Soluble Polyester Solution B-5)

Modified water-soluble polyester solution B-4 was prepared similarly to preparation of modified water-soluble polyester solutions B-1, except that the vinyl based component modification ratio was replaced by 12% by weight.

(Preparation of Modified Water-Soluble Polyester Solution B-6)

Modified water-soluble polyester solution B-6 was prepared similarly to preparation of modified water-soluble polyester solutions B-1, except that the water-soluble polyester solution was replaced by A-3.

(Preparation of Modified Water-Soluble Polyester Solution B-7)

Modified water-soluble polyester solution B-7 was prepared similarly to preparation of modified water-soluble polyester solutions B-1, except that the water-soluble polyester solution was replaced by A-4.

<<Preparation of Acrylic Polymer Latexes C-1C-4>>

Acrylic polymer latexes C-1-C-4, having the monomer compositions described below, were synthesized employing emulsion polymerization. All the solid contents were adjusted to 30% by weight.

TABLE 2-b

| | | Tg (° C.) |
|---|---|---|
| C-1 | styrene:glycidyl methacrylate:n-butyl | 20 |
| | acrylate = 20:40:40 | |
| C-2 | styrene:n-butyl acrylate:t-butyl acrylate:hydroxyethyl | 55 |
| | methacrylate = 27:10:35:28 | |
| C-3 | styrene:glycidyl methacrylate:acetoacetoxyethyl | 50 |
| | methacrylate = 40:40:20 | |
| C-4 | ethyl acrylate:methyl methacrylate = 50:50 | — |

<<Polyvinyl Alcohol Unit Containing Water-Soluble Polymers>>
D-1: PVA-110 aqueous dispersion (a solid content of 5%) manufactured by Kuraray Co.: a saponification degree of 98.5
D-2: PVA-617 aqueous dispersion (a solid content of 5%) manufactured by Kuraray Co.: a saponification degree of 95
D-3: PVA-205 aqueous dispersion (a solid content of 5%) manufactured by Kuraray Co.: a saponification degree of 88
D-4: RS-4105 aqueous-dispersion (a solid content of 5%) manufactured by Kuraray Co.: a saponification degree of 98
D-5: RS-2117 aqueous dispersion (a solid content of 5%) manufactured by Kuraray Co.: a saponification degree of 98
   <<Styrene-Diolefin Based Copolymer>>
E-1: Styrene butadiene latex (Nipol LX432A produced by Zeon Corp.; a solid content of 40%)
E-2: Styrene-butadiene copolymer latex (weight ratio of Styrene/butadiene=68/32; a solid content of 40%)
   <<Preparation of G-1 (SnO₂ Sol)>>

SnO₂ sol which was synthesized according the method described in Example 1 of Japanese Patent Examined Publication No. 35-6616 was concentrated to obtain a solid content of 10- by weight. Thereafter, the pH was adjusted to 10 and then employed.

### EXAMPLE 1

(Preparation of PET Support)

PET having an intrinsic viscosity IV of 0.66 (determined in phenol/tetrachloroethane=6/4 in terms of weight ratio at 25° C.) was prepared employing phthalic acid and ethylene glycol while using a conventional method. The resulting PET was pelletized and dried at 140° C. for 4 hours. The resulting pellets were melted at 300° C., and then quickly cooled while being extruded from a T type die, whereby a non-stretched film was prepared so as to obtain a layer thickness of 175 μm after thermal fixing. The resulting film was subjected to longitudinal stretching by a factor of 3.3, employing rollers having different peripheral rates and was then subjected to lateral stretching by a factor of 4.5 employing a tenter. During the aforesaid operations, temperatures were 110° C. and 130° C., respectively. Thereafter, thermal fixing was performed at 240° C. for 20 seconds and 4 percent lateral relaxation was performed at the same temperature. Thereafter, the chuck portion of the tenter was removed through slitting and both sides were subjected to a knurl treatment. The resulting film was wound under 4 kg/cm², whereby a roll of 175 μm thick film to be employed as a support was obtained.

(Preparation of a Subbed Support for an Optical Film)

Both surfaces of a 175 μm thick biaxially oriented thermally fixed polyethylene terephthalate film, employed as a photographic support, were subjected to a corona discharge treatment of 8 W/cm·minute on both sides. The resulting film was subjected to a subbing treatment. Namely, subbing coating composition a-1 was applied onto one side of this support for an optical film so as to obtain a dry thickness of 0.2 μm and subsequently dried at 123° C. to form a subbing layer on the front surface side. The resulting subbing layer was designated as subbing layer A-1.

Further, following subbing layer coating composition b-1 was applied onto the surface on the opposite side to form a backing layer subbing layer to obtain a dry thickness of 0.12 μm, and subsequently dried at 123° C., whereby a conductive subbing layer having an antistatic function was formed on the backing layer side. The resulting subbing layer was designated as subbing layer B-1.

Both surfaces of subbing layers A-1 and B-1 were subjected to a corona discharge of 8 W/m²·minute. Subsequently, following subbing layer coating composition a-2 was applied onto subbing layer A-1 to obtain a dry thickness of 0.1 μm, and subsequently dried at 123° C. The resulting subbing layer was designated as upper subbing layer A-2.

Further, following subbing coating composition b-2 was applied onto subbing layer B-1 to obtain a dry thickness of 0.2 μm and subsequently dried at 123° C. The resulting coating was designated as upper subbing layer B-2. Furthermore, the support was subjected to a thermal treatment at 123° C. for two minutes, whereby subbed Sample 101 was prepared.

Subbed Samples 102-114 were prepared similarly to preparation of subbed Sample 101, except that binders constituting upper subbing layer A-2 were changed as shown in Table 3-b.

Further, Subbed Samples 115, 119-126, 129 and 130 were prepared in such a manner that upper subbing layer A-2 was directly applied onto the corona discharged surface as shown in Table 3-b, without coating the lower subbing layer.

Further, Subbed Samples 116-118 were prepared in such a manner that the coating temperature of upper subbing layer A-2 was changed as shown in Table 3-b.

(Subbing layer coating composition b-1 on backing layer side)

| | |
|---|---|
| Acrylic polymer latex C-1 (a solid content of 30%) | 30.0 g |
| Acrylic polymer latex C-2 (a solid content of 30%) | 7.6 g |
| SnO₂ sol (G-1) | 180 g |
| Surfactant (A) | 0.5 g |
| 5% aqueous PVA-613 (PVA, produced by Kuraray Co.) | 0.4 g |
| solution | |

Distilled water was added into the above components and the total volume was adjusted to one liter, whereby a coating composition was prepared.

(Upper subbing layer coating composition b-2 on the backing
layer side)

| | |
|---|---|
| Modified water-soluble polyester B-1 (18% by weight) | 215 g |
| Spherical silica matting agent Sea Hoster KE-P50, | 0.3 g |
| produced by Nihon Shokubai Co.) | |
| Surfactant (A) | 0.4 g |

Distilled water was added into the above components for a total volume of one liter, whereby a coating composition was prepared.

(Lower subbing layer coating composition a-1 on the front
surface side)

| | |
|---|---|
| Acrylic polymer latex C-3 (a solid content of 30%) | 70.0 g |
| Acrylic polymer latex C-1 (a solid content of 30%) | 3.7 g |
| Aqueous dispersion of ethoxylated alcohol and ethylene | 5.0 g |
| homopolymer (a solid content of 10%) | |
| Surfactant (A) | 0.1 g |

Distilled water was added into the above components for a total volume of one liter, whereby a coating composition was prepared.

(Upper subbing layer coating composition a-2 on the front
surface side)

| | |
|---|---|
| Modified water-soluble polyester B-1 (18% by weight) | 130 g |
| Surfactant (A) | 0.4 g |
| Spherical silica matting agent (Sea Hoster KE-P50, | 0.3 g |
| produced by Nihon Shokubai Co.) | |

Distilled water was added into the above components for a total volume of one liter, whereby a coating composition was prepared.

<<Preparation of Light Diffusion Film Samples 101-126, 129 and 130>>

(Formation of Light Diffusion Layer)

50 parts of acryl based resin bead (MBX-15 produced by Sekisui Chemical Co., Ltd.) having an average particle diameter of 15 μm was mixed into the polymer composition containing 100 parts of polyester polyol, 20 parts of isocyanate based curing agent, 50 parts of colloidal silica having an average particle diameter of 20 nm and 2 parts of antistatic agent, whereby a coating solution was prepared. 15 g/m² of this coating solution (in terms of solids) was coated on the surface side of the transparent biaxial orientation polyester film having a thickness of 175 μm (foregoing subbed samples 101-126, 129 and 130) according to the roll coat method, whereby light diffusion film samples 101-126, 129 and 130 of Example 1 were prepared by curing.

<<Preparation of Light Diffusion Film Samples 127-128>>

Light diffusion films 127 and 128 were produced in the same manner as that of films 113 and 114, except that 40 parts of acryl resin bead having an average particle diameter of 15 μm, instead of 50 parts of acryl resin bead having an average particle diameter of 15 μm, and 10 parts of the acryl resin bead having an average particle diameter of 30 μm were used.

In Table 3-b:

(1) all the lower subbing layers and coated substances have a dry thickness of 0.2 μm;

lower subbing samples 101-112, 114-126 . . . C-2/C-1=95/5 (% by weight)

lower subbing sample 113 . . . C-2/C-1/G-1=92.5/5/2.5 (% by weight); and

(2) All the upper subbing layers have a dry thickness of 0.2 μm, and inorganic filler G-1 (2.5W by volume) is added to lower subbing sample 114 in addition to polyester A-1 (97.5W by volume).

[Evaluation of Properties]

Evaluation was made according to the following criteria:

<<Adhesion on the Light Diffusion Film Surface Side>>

A razor's edge was used to put a cut into a sample at an angle of 45 degrees with respect to the sample surface. The cut was sandwiched to apply pressure to the cellophane self-adhesive tape. It was abruptly peeled horizontally in the direction opposite 45 degrees, and the peeled area of the surface layer was obtained. The following criteria were used for evaluation:

1. The adhesive strength is very low and the light diffusible layer is peeled completely.

2. The peeled area is at least 50% and less than 100%.

3. The peeled area is at least 20% and less than 50%.

4. The adhesive strength is high, and the peeled area is at least 5% and less than 20%.

5. The adhesive strength is very high, and the peeled area is less 5%.

<<Evaluation of Abrasion Resistance>>

The film was subjected to five back-and-forth motions on the table to check the occurrence of abrasion in five ranks:

5: No abrasion

4: Occurrence of slight pin holes

3: Occurrence of considerable pin holes

2: Streak-shaped abrasion observed

1: Abrasion damage observed over the entire surface

<<Evaluation of Storage Ability at High-Temperature and Humidity>>

To evaluate the storage ability under the conditions of high temperature and high humidity, a 10 cm square sample was cut out from each light diffusion film, and was put to the test at 60° C. and 90% RH for 1000 hours. The external appearance of each sample was observed to make visual check of the presence or absence of a curl and the degree thereof. A sample was assigned with “5” if it was hardly curled, and there was no optical problem. It was assigned with “1” if it was curled, and there was an optical problem. According to such a scoring method, the storage ability was evaluated in five ranks. However, the evaluation was made in increments of 0.5.

<<Evaluation of Heat Resistance>>

To evaluate the heat resistance, each light diffusion film was installed in the backlight unit and was put into a thermo-hygrostat of constant temperature and constant humidity at 60° C. and 90% RH. A lamp was turned on. After the lapse of 1, 2, 4, 8, 12 and 24 hours, the presence or absence of the flexure of the light diffusion film and the degree thereof were checked according to the degree of luminance unevenness in the backlight unit, and evaluation was made according to the following criteria:

(1) 5: Neither luminance unevenness nor flexure

(2) 4: Almost no luminance unevenness and only very small flexure

(3) 3: Slight luminance unevenness observed with slight flexure

(4) 2: Luminance unevenness observed with small flexure

(5) 1: Luminance unevenness clearly observed with flexure

Evaluation was made in increments of 0.5.

TABLE 3-b

| | | Subbing layer on the front surface | | | | | Coating | | | | | |
|---|---|---|---|---|---|---|---|---|---|---|---|---|
| | Subbed | Lower | Upper subbing layer | | | | solution | | | | | |
| | sample | layer | Binder 1 | Ratio | Binder 2 | Ratio | temperature | | | | Heat | |
| *1 | No. | Provided/*4 | Polyester | vol % | Type | vol % | (° C.) | Adhesion | *2 | *3 | resistance | Remarks |
| 101 | 101 | Provided | A-1 | 100 | — | — | 20 | 4.0 | 4.0 | 4.0 | 4.0 | Inv. |
| 102 | 102 | Provided | A-2 | 100 | — | — | 20 | 4.0 | 4.0 | 4.0 | 4.0 | Inv. |
| 103 | 103 | Provided | A-3 | 100 | — | — | 20 | 4.0 | 4.0 | 4.0 | 4.0 | Inv. |
| 104 | 104 | Provided | A-4 | 100 | — | — | 20 | 4.0 | 4.0 | 4.0 | 4.0 | Inv. |
| 105 | 105 | Provided | A-5 | 100 | — | — | 20 | 4.0 | 4.5 | 4.0 | 4.5 | Inv. |
| 106 | 106 | Provided | A-6 | 100 | — | — | 20 | 4.0 | 4.0 | 4.0 | 4.0 | Inv. |
| 107 | 107 | Provided | A-1 | 90 | C-2 | 10 | 20 | 4.5 | 4.0 | 4.0 | 4.0 | Inv. |
| 108 | 108 | Provided | A-2 | 90 | C-2 | 10 | 20 | 4.5 | 4.0 | 4.0 | 4.0 | Inv. |
| 109 | 109 | Provided | A-3 | 90 | C-2 | 10 | 20 | 4.5 | 4.0 | 4.0 | 4.0 | Inv. |
| 110 | 110 | Provided | A-1 | 50 | C-4 | 50 | 20 | 4.5 | 4.0 | 4.0 | 4.0 | Inv. |
| 111 | 111 | Provided | A-1 | 10 | C-2 | 90 | 20 | 4.0 | 4.0 | 4.0 | 4.0 | Inv. |
| 112 | 112 | Provided | — | — | C-2 | 100 | 20 | 2.0 | 2.0 | 2.5 | 2.5 | Comp. |
| 113 | 113 | Provided | A-1 | 100 | — | — | 20 | 4.0 | 4.0 | 4.0 | 4.0 | Inv. |
| 114 | 114 | Provided | A-1 | 97.5 | — | — | 20 | 4.0 | 4.5 | 4.0 | 4.0 | Inv. |
| 115 | 115 | *4 | A-1 | 100 | — | — | 20 | 1.5 | 1.0 | 1.5 | 1.5 | Comp. |
| 116 | 116 | Provided | A-1 | 100 | — | — | 25 | 4.0 | 4.0 | 4.0 | 4.0 | Inv. |
| 117 | 117 | Provided | A-1 | 100 | — | — | 30 | 4.5 | 4.5 | 4.0 | 4.0 | Inv. |
| 118 | 118 | Provided | A-1 | 100 | — | — | 35 | 4.0 | 4.0 | 4.0 | 4.0 | Inv. |
| 119 | 119 | *4 | A-6 | 100 | — | — | 20 | 1.5 | 1.0 | 1.5 | 1.5 | Comp. |
| 120 | 120 | *4 | A-4 | 100 | — | — | 20 | 1.5 | 1.0 | 1.5 | 1.5 | Comp. |
| 121 | 121 | *4 | A-1 | 90 | C-3 | 10 | 20 | 4.0 | 3.5 | 3.5 | 3.5 | Inv. |
| 122 | 122 | *4 | A-6 | 90 | C-3 | 10 | 20 | 4.0 | 3.5 | 3.5 | 3.5 | Inv. |
| 123 | 123 | *4 | A-4 | 90 | C-3 | 10 | 20 | 4.0 | 3.5 | 3.5 | 3.5 | Inv. |
| 124 | 124 | *4 | A-1 | 50 | C-3 | 50 | 20 | 4.0 | 3.5 | 3.5 | 3.5 | Inv. |
| 125 | 125 | *4 | A-1 | 10 | C-3 | 90 | 20 | 4.0 | 3.5 | 3.5 | 3.5 | Inv. |
| 126 | 126 | *4 | — | — | C-3 | 100 | 20 | 1.0 | 1.0 | 1.5 | 1.5 | Comp. |
| 127 | 127 | Provided | A-1 | 100 | — | — | 20 | 4.5 | 4.5 | 4.5 | 4.5 | Inv. |
| 128 | 128 | Provided | A-1 | 97.5 | — | — | 20 | 4.5 | 4.5 | 4.5 | 4.5 | Inv. |
| 129 | 129 | *4 | A-1 | 70 | E-1 | 30 | 20 | 3.5 | 3.5 | 3.5 | 3.5 | Inv. |
| 130 | 130 | *4 | A-1 | 90 | E-2 | 10 | 20 | 3.5 | 3.5 | 3.5 | 3.5 | Inv. |

*1: Light diffusion film sample No.,
*2: Abrasion resistance
*3: Storage property at high-temperature and humidity,
*4: Not provided
Inv.: Present invention,
Comp.: Comparative example

As is clear from Table 3-b, it is to be understood that the light diffusion film employing a subbed sample of the present invention exhibits improved properties in adhesion, abrasion resistance, storage at high-temperature and humidity and heat resistance in comparison to comparative examples.

### EXAMPLE 2

Subbed samples 201-205 were prepared similarly to preparation of subbed sample 101, except that the binder constituting upper subbing layer A-2 on the front surface side was changed as shown in Table 4-b.

Further, subbed samples 206-211 were prepared in such a manner that upper subbing layer A-2 was applied onto the surface which was subjected to direct corona discharge treatment, without coating a lower subbing layer, as shown in Table 4-b.

In Table 4-b, the dry thickness of all samples coated with the lower subbing layer was 0.2 μm and the polyester ratio of C-2/C-1 was 95/5 (% by weight).

<<Preparation of Light Diffusion Film Samples 201-211>>

(Formation of Light Diffusion Layer)

A coating solution was prepared similarly to Example 1, and 15 g/m² of this coating solution (in terms of solids) was coated on the surface side of the transparent biaxial orientation polyester film having a thickness of 175 μm (foregoing subbed samples 201-211) according to the roll coat method, whereby light diffusion film samples 201-211 of Example 2 were prepared by curing.

[Evaluation of Properties]

Properties are evaluated similarly to Example 1, and results are shown in Table 4-b.

TABLE 4-b

| | | Subbing layer on the front surface | | | | | | Storage | | |
|---|---|---|---|---|---|---|---|---|---|---|
| | | Lower | Upper subbing layer | | | | | property at | | |
| | | layer | | Vinyl | | | | high- | | |
| | Subbed | Provided/ | | modification | Dry | | | temperature | | |
| | sample | Not | Binder | ratio % by | thickness | | | and | Heat | |
| *1 | No. | provided | Polyester | weight | μm | Adhesion | *2 | humidity | resistance | Remarks |
| 201 | 201 | Provided | B-1 | 20 | 0.2 | 5.0 | 5.0 | 5.0 | 5.0 | Inv. |
| 202 | 202 | Provided | B-2 | 20 | 0.2 | 5.0 | 5.0 | 5.0 | 5.0 | Inv. |
| 203 | 203 | Provided | B-3 | 20 | 0.2 | 5.0 | 5.0 | 5.0 | 5.0 | Inv. |
| 204 | 204 | Provided | B-4 | 20 | 0.2 | 5.0 | 5.0 | 5.0 | 5.0 | Inv. |
| 205 | 205 | Provided | B-5 | 20 | 0.2 | 5.0 | 5.0 | 5.0 | 5.0 | Inv. |
| 206 | 206 | Not | B-1 | 20 | 0.2 | 4.5 | 4.5 | 4.5 | 4.5 | Inv. |
| | | provided | | | | | | | | |
| 207 | 207 | Not | B-6 | 20 | 0.2 | 4.5 | 4.5 | 4.5 | 4.5 | Inv. |
| | | provided | | | | | | | | |
| 208 | 208 | Not | B-7 | 20 | 0.2 | 4.5 | 4.5 | 4.5 | 4.5 | Inv. |
| | | provided | | | | | | | | |
| 209 | 209 | Not | A-1 | 0 | 0.2 | 1.5 | 1.0 | 1.5 | 1.5 | Comp. |
| | | provided | | | | | | | | |
| 210 | 210 | Not | A-3 | 0 | 0.2 | 1.5 | 1.0 | 1.0 | 1.5 | Comp. |
| | | provided | | | | | | | | |
| 211 | 211 | Not | A-4 | 0 | 0.2 | 1.5 | 1.0 | 1.5 | 1.5 | Comp. |
| | | provided | | | | | | | | |

*1: Light diffusion film sample No.,
*2: Abrasion resistance
Inv.: Present invention,
Comp.: Comparative example

As is clear from Table 4-b, it is to be understood that the light diffusion film employing a subbed sample of the present invention exhibits improved properties in adhesion, abrasion resistance, storage at high-temperature and humidity and heat resistance in comparison to comparative examples.

### EXAMPLE 3

Subbed samples 301-305 were prepared similarly to preparation of subbed sample 101, except that the binder constituting upper subbing layer A-2 on the front surface side was changed as shown in Table 5-b.

Further, subbed samples 306-308 were prepared in such a manner that upper subbing layer A-2 was applied onto the surface which was subjected to direct corona discharge treatment, without coating a lower subbing layer, as shown in Table 5-b.

<<Preparation of Light Diffusion Samples 301-308>>

(Formation of Light Diffusion Layer)

In Table 5-b, the dry thickness of all samples coated with the lower subbing layer was 0.2 μm and the polyester ratio of C-2/C-1 was 95/5 (% by weight).

[Evaluation of Properties]

Properties are evaluated similarly to Example 1, and results are shown in Table 5-b.

TABLE 5-b

| | | Subbing layer on the front surface | | | | | | | | | | |
|---|---|---|---|---|---|---|---|---|---|---|---|---|
| | | Lower | | | | | | | | | | |
| | | layer | | | | | | | | | | |
| | Subbed | Provided/ | Upper subbing layer | | | | Dry | | | | | |
| | sample | Not | Binder 1 | Ratio | Binder 2 | Ratio | thickness | | | | Heat | |
| *1 | No. | provided | Polyester | vol % | Type | vol % | μm | Adhesion | *2 | *3 | resistance | Remarks |
| 301 | 301 | Provided | A-1 | 70 | D-1 | 30 | 0.2 | 4.0 | 4.0 | 4.0 | 4.0 | Inv. |
| 302 | 302 | Provided | A-1 | 70 | D-2 | 30 | 0.2 | 4.0 | 4.0 | 4.0 | 4.0 | Inv. |
| 303 | 303 | Provided | A-1 | 70 | D-3 | 30 | 0.2 | 4.0 | 4.0 | 4.0 | 4.0 | Inv. |
| 304 | 304 | Provided | A-1 | 90 | D-5 | 10 | 0.2 | 4.0 | 4.0 | 4.0 | 4.0 | Inv. |
| 305 | 305 | Provided | A-1 | 10 | D-5 | 90 | 0.2 | 3.5 | 4.0 | 4.0 | 4.0 | Inv. |
| 306 | 306 | Not | A-4 | 70 | D-4 | 30 | 0.2 | 4.0 | 3.2 | 3.5 | 3.5 | Inv. |
| | | provided | | | | | | | | | | |
| 307 | 307 | Not | A-2 | 70 | D-5 | 30 | 0.2 | 4.0 | 3.5 | 3.5 | 3.5 | Inv. |
| | | provided | | | | | | | | | | |
| 308 | 308 | Not | A-4 | 100 | — | — | 0.2 | 1.5 | 1.0 | 1.5 | 1.5 | Comp. |
| | | provided | | | | | | | | | | |

*1: Light diffusion film sample No.,
*2: Abrasion resistance
*3: Storage property at high-temperature and humidity
Inv.: Present invention,
Comp.: Comparative example

As is clear from Table 5-b, it is to be understood that the light diffusion film employing a subbed sample of the present invention exhibits improved properties in adhesion, abrasion resistance, storage at high-temperature and humidity and heat resistance in comparison to comparative examples.

### EFFECT OF THE INVENTION

In the present invention, provided can be an optical film, a light diffusion film and supports thereof exhibiting less film deformation in the case of the starge at high-temperature and humidity as well as excellent heat resistance, accompanied with no generation of scratches on the film surface, film peeling and curl.

What is claimed is:

1. A support employed for an optical film or a light diffusion film comprising at least one subbing layer containing a polyester component or a vinyl based polymer latex, or a polyester component or a styrene-diolefin based copolymer.

2. A support employed for an optical film or a light diffusion film comprising at least one subbing layer containing polyester modified with a vinyl based monomer.

3. The support employed for an optical film or a light diffusion film of claim 2,
wherein the polyester is modified with at least 10% by weight of the vinyl based monomer, based on polyester.

4. A support employed for an optical film or a light diffusion film comprising at least one subbing layer containing a polyester component or a water-soluble polymer containing a polyvinyl alcohol unit.

5. The optical film comprising at least one subbing layer containing the polyester component or the vinyl based polymer latex, or the polyester component or the styrene-diolefin based copolymer, provided on the support,
wherein the support of claim 1 is used for the optical film.

6. The light diffusion film comprising at least one subbing layer containing the polyester component or the vinyl based polymer latex, or the polyester component or the styrene-diolefin based copolymer, provided on the support,
wherein the support of claim 1 is used for the light diffusion film.

7. The optical film of claim 5,
wherein the optical film is a hard coat film.

8. The optical film of claim 5,
wherein the optical film is an anti-reflection film.

9. The optical film of claim 5,
wherein the optical film is an infrared ray absorbing film.

10. The optical film of claim 5,
wherein the optical film is an electromagnetic shielding film.

11. The light diffusion film of claim 6,
wherein a light diffusion agent used for a light diffusion layer is an acryl resin.

12. The light diffusion film of claim 11,
wherein binder used for the light diffusion layer is polyol or polyester polyol.
